(19) United States
(12) Patent Application Publication
(10) Pub. No.: US 2010/0153183 A1
(43) Pub. Date: Jun. 17, 2010

(54) Product design

(75) Inventor: Anthony W. Ulwick, Aspen, CO (US)

Correspondence Address: PERKINS COIE LLP, P.O. BOX 1208, SEATTLE, WA, 98111-1208, US

(73) Assignee: Strategyn, Inc., Aspen, CO (US)

(21) Appl. No.: 12/592,715

(22) Filed: Nov. 30, 2009

Related U.S. Application Data
(63) Continuation-in-part of application No. 10/235,285, filed on Sep. 5, 2002, now abandoned.
Application No. 10/235,285 is a continuation-in-part of application No. 09/652,576, filed on Aug. 31, 2000, now Pat. No. 7,340,409.
Application No. 09/652,576 is a continuation of application No. 09/385,661, filed on Aug. 27, 1999, now Pat. No. 6,115,691.
Application No. 09/385,661 is a continuation of application No. 08/716,948, filed on Sep. 20, 1996, now Pat. No. 5,963,910.

(51) Int. Cl. G06Q 10/00

(52) U.S. Cl. 705/10; 705/348

(57) ABSTRACT

A technique to obtain desirable product-specific outcomes is disclosed. An example of a method using the technique includes parameterizing a job to identify steps; defining a market as a job executor of the job; deconstructing the job to determine achievable outcomes at each step in the job; using outcome statements associated with the achievable outcomes as bases for segmentation; allocating customers into segments of customers with different unmet needs, revealing segment of opportunity; uncovering segments of customers that struggle to achieve desirable outcomes at one or more steps of the job; revealing an opportunity to help at least one customer achieve desirable outcomes related to a specific market; designing a product that helps the at least one customer achieve desirable outcomes.

### CROSS-REFERENCE TO RELATED APPLICATIONS

This application is a continuation-in-part (CIP) of U.S. patent application Ser. No. 10/235,285, filed Sep. 5, 2002, which is a CIP of U.S. patent application Ser. No. 09/652,576, filed Aug. 31, 2000, which is a continuation of U.S. Pat. No. 6,115,691, filed Aug. 27, 1999, which is a continuation of U.S. Pat. No. 5,963,910, filed Sep. 20, 1996, each of which is incorporated by reference.

### BACKGROUND

When making complex personal and business decisions, individuals attempt to find the one solution that will enable them to optimally achieve their desired outcomes. This process is often referred to as a decision making or planning. The resulting solution, or plan of action, is often referred to as a strategy. For purposes of this disclosure, strategy shall be defined as the means by which a business or individual achieves a set of desired outcomes.

A set of desired outcomes includes all the outcomes that are desired by those involved in, or affected by, a potential decision, plan or strategy. A complete set can include many unique outcomes (e.g., 150 or more). Each desired outcome is defined in a statement that includes what is desired, why it is desired and what must be done to insure the outcome is achieved. A desired outcome is a unique statement in that it is free from solutions and specifications, free from vague words, and the statement itself is valid and stable over time. Desired outcomes, however, are difficult to capture as people tend to talk about solutions. Solutions are the mechanism by which desired outcomes are achieved. A “good” solution will satisfy several desired outcomes. As an example, a product developer's desired outcomes may include reducing the time to complete the product development cycle and insuring design modifications are documented. One solution could be to invest in a CAD-CAM system, but other solutions are available.

When creating a plan or strategy there often exist many potential solutions. A goal in developing a plan or strategy is to find the solution that satisfies most of the desired outcomes. The optimal solution will also be the one that can be executed with the least amount of effort, cost, and risk. To find or create the optimal solution for a given strategic situation, an individual must have the capability to know, remember, process and apply thousands of pertinent facts.

Many individuals and businesses currently involved in decision making, planning and strategic planning activities are faced with unavoidable obstacles to successful decision making. These obstacles to success can be summarized as follows:

1. Individuals and businesses are often unaware of all the people or entities that must be considered to successfully create and execute a personal or business strategy. Important individuals, groups of individuals, or customers are sometimes overlooked, or under estimated, in the planning process. This oversight can cause the rejection or failure of a strategy;

2. Individuals and business are rarely aware of all the desired outcomes that should be considered when making strategic decisions. In most cases a fraction of the desired outcomes are known and many desired outcomes are poorly defined. It follows that in most situations, the selected strategy could, at best, satisfy only up to a fraction of the desired outcomes;

3. Areas of opportunity cannot be accurately determined without knowing which desired outcomes are most important and least satisfied. An inability to capture desired outcomes is one obstacle that makes the discovery of opportunity difficult. Without this information, individuals and businesses are unlikely to know where to focus their effort for maximum value creation. They may, therefore, apply their resources to activities that will produce little or no value;

4. Individuals and businesses are usually unaware of the impact that satisfying one desired outcome would have on the satisfaction of other desired outcomes. Implementing a solution to satisfy one desired outcome could negatively impact one or several other more important desired outcomes. Conversely, a solution that may satisfy one desired outcome could positively impact several other desired outcomes. Unless all desired outcomes and their inter-relationships are known, an individual's ability to find the optimal solution is inhibited;

5. Individuals and businesses usually evaluate only a handful of potential solutions. It is often the case that dozens or even hundreds of other potential solutions exist, but they are never evaluated. It usually takes too much time to uncover and evaluate all possible solutions. The optimal solution is often left undiscovered.

6. Individuals often try to determine, in their head, which of the proposed solutions would best satisfy all the desired outcomes. There are limitations to a human mind, and it is apparent that it would be near impossible for an individual to accurately define the optimal solution given that there are potentially hundreds of solutions and up to 150 desired outcomes for any given strategic situation. There are just too many constants and variables.

For example, to solve a simultaneous equation in algebra, such as y=3 and y=x+1, there are two variables given, x and y. Most people cannot solve this relatively simple equation in their head. In most strategic situations, however, there are often over a hundred solutions (variables) and up to 150 desired outcomes (constants) that must be considered in order to effectively solve the equation. Thus, the probability of an individual optimally solving this complex equation in their head is near zero. Despite this fact, businesses and individuals often rely on their internal decision making abilities to determine which solution will best solve a complex strategic equation;

7. Individual and business strategies are often decided on gut feel, intuition, opinion, experience, emotion, history, or some other subjective criteria. Moreover, individuals in an organization often use different criteria to evaluate the same alternative solutions. The solutions are often discussed, argued, negotiated, and eventually compromised to the point where commitment is lacking and implementation is slow. Using subjective or inappropriate criteria to evaluate alternative solutions often produces unpredictable and less than desirable results;

8. Individuals and businesses often lack the ability to quantify the value that one proposed solution has over another. Since the evaluation criteria is often undefined, not agreed to, or unprioritized, it is difficult to ascertain the amount of value that one solution has over another. This lack of information makes it difficult to reach a conclusion or gain consensus on any solution;

9. Individuals and businesses often stop short of defining the optimal solution because they are unaware of the criteria that defines the optimal solution. Without having access to that criteria, an individual is likely to focus on areas of the mission that they find easy to address or personally interesting. Using this approach often misdirects the application of scarce resources and may not produce the desired result;

10. Individuals and businesses will often prototype, develop, or implement a solution to assess its potential value. Prototyping a solution often requires spending thousands or millions of dollars in advance of knowing whether or not the solution will be successful. Implementing a solution to test its value may drive a de facto strategy that could be difficult to change. If the potential value of a solution could be determined in advance of its development, much time and money could be saved; and

11. Individuals and businesses will often focus on specific parts or elements of a mission rather than focusing on optimizing all the elements within a given mission. Thus, one specific area is improved while negatively impacting other areas. The overall effect may be undesirable.

It should also be noted that individuals and organizations often choose strategies that have worked for someone else. This approach is seldom successful as it ignores the desired outcomes that make that specific situation unique. The optimal strategy for a specific strategic situation is rarely a generic strategy as it is unlikely that the individuals involved, and their desired outcomes, are the same in any two strategic situations.

A theory of product quality enhancement utilizing matrix analysis is loosely referred to as Quality Function Deployment (QFD). However, the prior art has not refined QFD theory into a workable system for widespread use in strategic planning and evaluation. As a result, the application of QFD is limited and has not gained wide commercial acceptance as a tool for strategic evaluation.

An example of market modeling created by Anthony Ulwick and called Outcome Driven Innovation (ODI) creates an empirically valid estimator of market demand by holistically identifying the Jobs that customers and key participants in the consumption chain are trying to get done in a particular market and then collecting quantitative data on importance and satisfaction levels associated with all of these jobs and with the desired outcomes associated with a specific core job of interest. This data is then analyzed to identify needs that are underserved (representing opportunities for new products and services) and those that are over-served (representing areas that are ready for being disrupted). A proprietary index called the opportunity score is used to determine the strength of the underlying market conditions driving these findings, and this score has been shown to be a valid empirical estimator of customer demand/sentiment and hence the consequential business value of fulfilling the market needs appropriately. The practice of researching and analyzing markets in this fashion is what is referred to as the ODI methodology.

The ODI methodology possesses four critical attributes that collectively make it uniquely valuable for business analysis. First, the use of the Jobs framework facilitates the description of an interaction a customer or key influencer may have with current or yet-to-be designed products and services and the measurement of these in a meaningful unit of analysis. This is important to obtaining insights and making informed decisions on questions where the objects of interest are parts of interconnected systems like in virtually all business matters. Today's MIS, BI, and Innovation Management systems lack this unifying framework and so do little to facilitate meaningful comparisons and analyses within and across the inherently disparate information domains of the system (e.g. competitive information, customer market information, product management information, R&D, etc.). Second, the measurement system used by the methodology provides direct quantitative measurement of the fundamental driver of business outcomes—customer demand, and this measurement system is both reproducible and repeatable. Third, the actual measurements taken are internally consistent; that is they report on the same dimensions of importance and satisfaction irrespective of whether jobs or outcomes are being studied and whether the job of interest is a functional job, an emotional job, or a related job. This therefore means that the methodology enables disparate variables of successful business endeavors, such as emotional factors, functional factors, and performance factors, to be compared directly to one another for prioritization without transformation. And fourth, the numerical data collected are normalized by an indexing method to have the same market meaning regardless of the factor being studied and are scaled in a manner that directly reflects the significance of the metric in market terms. This ensures that comparisons across factors are not just qualitatively valid but also quantitatively correct and easily extrapolated to real business impacts. For these reasons the foundation of ODI presents an information platform for business analysis that is fundamentally superior to all constructs that have preceded it.

### SUMMARY

Using techniques described in this paper, individuals and businesses can evolve their decision making capabilities beyond their current capacity. For example, a user can choose from a variety of missions. A mission is a particular task, project, or decision which an individual, employee, or business is contemplating. Upon selection of a specific mission, the data, including statements that define the criteria for creating value are retrieved from a database along with other pertinent facts that are critical to objective decision making. The user is then led through a process that enables the development of solutions and strategies that deliver many times more value than could normally be achieved.

A computer program product can be designed as two modules; one for data input and the other as a fixed application shell. By loading mission-specific data into the input module, the application shell can instantly become a different software product for different users, markets, or industries. This flexibility enables new software products to be developed quickly and at minimal expense. The data that is manipulated by the software is compiled and comprises the collection, prioritization, analysis, and structuring of thousands of facts related to those individuals involved in, or affected by, the mission that is being contemplated. These “customers” may be an end user of a product, a manufacturer, a manager, or one's self when making personal decisions, to name a few. The facts are collected in advance and structured for each specific mission, loaded into the computer, or processor means, stored in predetermined memory locations, and processed by the software. The memory locations comprise a plurality of identifiable data storage array locations that are indexed by the processor and the software to pull requested or required data to assist the user in evaluating and optimizing their decisions for an unlimited number of missions. Accordingly, the applications are numerous. For example, by integrating mission specific data into the fixed application shell, the computer program product can be adapted to: (1) provide individuals with the ability to create, evaluate, and optimize many personal strategies including career, education, relocation, relationship, philosophy of life and personal growth strategies; (2) provide organizations of all sizes with the ability to evolve generic, time-to-market processes such as product development, manufacturing, and other value-added processes such as planning, distribution, training and support; and (3) provide individuals and organizations of all sizes with the ability to create, evaluate, and optimize their proprietary strategies, such as energy generation and storage technologies, innovative thinking, two-way communications, new business evaluation, ergonomics and others.

The techniques disclosed herein address one or more of the following objectives:

1. For each mission that a user may select, individuals, groups of individuals or customers that are to be considered in order to achieve that mission are identified in advance, and presented to the user. The user is given the option of weighting the importance that each individual, group, or customer plays in determining the optimal strategic solution. This feature insures that those individuals and/or groups that are involved in, or affected by, the mission, or decision, are considered when evaluating mission specific strategies.

2. Desired outcomes for each of those individuals or groups can be captured in advance using advanced market research techniques. This data is loaded and stored and presented to the user. This information describes all the outcomes that the optimal solution would achieve. In such a format the user is able to consider up to 150, or more, unique desired outcomes for each mission. Specifically, the desired outcomes are captured and documented, in advance, from the appropriate individuals using neurolinguistic programming (“NLP”) techniques. Individuals are interviewed by researchers to obtain and document desired outcomes. The desired outcomes are captured in a format for storage as computer data. Upon selection of a mission, the associated mission specific desired outcomes are retrieved and made available to the user for weighting and consideration.

3. The relative importance and satisfaction levels of each of the desired outcomes are quantified by a large group of individuals in advance using statistically valid market research methods. This data is also presented to the user. For example, while the qualitative aspects of gathering desired outcomes may involve between and 60 individuals, the quantitative aspects may involve between 180 to 270 individuals. The number of people involved in the qualitative and quantitative aspects varies depending on the subject matter. Since the data is available for many target markets and populations, the user is given the option of selecting specific target segments of interest from a menu of options that makes the data available. Upon selection, the appropriate quantified data is retrieved and made available to the user. The data can be structured such that areas of opportunity can easily be accessed by the user.

4. Advanced research establishes unique parameters that predict that the desired outcomes will be achieved. These parameters, called predictive metrics or predictive success factors, can be measured and controlled in the design of the solution. They predict with certainty that the desired outcomes will be achieved. One predictive metric exists for each desired outcome; however, each predictive metric may positively or negatively affect other desired outcomes. The effect of predictive metrics on each desired outcome is quantified by assigning values, or weights, to each and performing matrix analysis via the software. Accordingly, the relationship of each metric to each desired outcome is quantified in terms of the degree with the highest certainty to which each predictive metric predicts each desired outcome will be achieved, and the quantified data is stored as computerized data for presentation to the user. This format enables the user to focus on the relatively few metrics that predict the delivery of a disproportionate share of value. For example, it is often the case that 30% of the metrics predict the delivery of over 70% of the value by predicting the satisfaction of one or more certain significant desired outcomes. If a one hundred (100) point scale is employed, a 100 percent return value is typically desired when making a decision.

The inter-relationships of the desired outcomes and the predictive metrics are analyzed in advance, and are presented to the user. This analysis is included to insure that the user is focusing on the areas that will generate the most value while optimizing critical factors such as resources, time and cost. A computer implementation facilitates roughly eight thousand (8,000) inter-relationship decisions for each specific mission. These decisions are re-evaluated and applied automatically, based on the mission, customer weighting and target segments that the user selects from the menu. The calculations depend on assigned values and computer processing using matrix analysis.

5. The user is presented with the criteria by which they may evaluate potential solutions to achieve the desired outcomes. The criteria are in the form of the predictive metrics and are presented to the user in priority value order given the mission, customer weighting and target segment(s) that has been selected. The priority changes, automatically, as the user selects and changes the mission, customer weighting, or target segment. Since all the criteria are presented to the user, the user can evaluate the potential of alternative solutions in minimal time, e.g., less than twenty (20) minutes. The speed by which solutions can be evaluated enables the user to test more solutions and increases the users chances of finding the optimal solution.

6. The potential value of many possible solutions can be evaluated by allowing the user to simultaneously consider all the elements of the complex strategic equation. The desired outcomes are systematically and intentionally separated from solutions. This discipline, which is a critical element of a decision making, planning or strategic planning process, is enforced. At the appropriate time the user is guided to evaluate which desired outcomes would be improved by a specific solution. The magnitude of the improvement can also be recorded. This discipline allows the user to systematically solve a complex simultaneous equation, having many constants and variables, with minimal confusion and ambiguity.

7. The user is presented with objective information and computer-implemented software to process that information. Presenting the user with predetermined facts and values to make decisions eliminates decisions being made by subjective criteria, such as gut feel, intuition, or self-serving motivations, which can negatively impact the result. Decisions that were once made subjectively can now be made objectively and logically. It is for this reason that solutions derived using techniques described in this paper can deliver many more times the value to the target customer segments than those solutions derived using traditional methods.

8. The user is presented with a means by which to quantify the potential value of each alternative solution. This quantitative value is tied to statistically valid market research which is stored in one or more databases. Potential solutions are evaluated for their ability to satisfy 100% of the desired outcomes. The score may range from −100% to +100%. It is possible that a potential solution could negatively impact 100% of the desired outcomes, in which case the solution would receive a score of −100%. The solutions can be evaluated against each other or some other baseline for comparison. The baseline can be changed by the user. Hundreds of comparisons can be made. The user can use this data to reach conclusions and gain a consensus on the value that a potential solution may deliver.

9. An interactive approach is provided that presents the user with weaknesses and strengths that exist in any solution. The user is guided toward solutions that overcome specific weaknesses and allows them to integrate and combine the positive elements of that solution into an optimal solution. Using this iterative approach enables the user to create value producing solutions that may not have been previously considered. This focusing technology directs the user's attention and intellect to the specific parameters that must be improved in order to enhance the solution. The time the user may have wasted on solutions less likely to deliver value to the target customers is minimized and focus is maintained on important, objective, and measured parameters.

10. The user is provided with a process to quantify the value of each proposed solution prior to incurring any costs or taking any action and often eliminating the need to create a prototype. Since the value of a potential solution can be determined in advance of its actual development or implementation, the user saves much time, effort, and money. For example, an individual may avoid spending years pursuing an undesirable career which in the past would have been chosen using the wrong criteria and which would not have chosen if it was determined in advance that such a career choice would not achieve their desired outcomes. Likewise, a business could save millions of dollars by pursuing activities that are proven to create value in advance of their development.

11. The user is focused on the whole mission, preventing the user from improving on a specific area while negatively impacting other areas. This discipline forces the user to apply resources and intellect to the areas that will create the optimal solution.

Accordingly, the technology described herein is targeted to improve the decision making, planning and strategic planning capabilities of individuals and businesses. Advantageously, individuals can use desired outcomes, predictive metrics, matrix analysis and the power of a computer to assist them in solving complex strategic equations. The techniques can be used to enhance an individual's capacity to know, remember, process and apply thousands of pertinent facts when making complex personal and business decisions. In addition, the techniques can be used to provide individuals with objective criteria and insight to discover new solutions and the optimal strategy.

### BRIEF DESCRIPTION OF THE DRAWINGS

FIG. 1 depicts a Mission Selection screen.

FIG. 2 depicts a screen illustrating a flow-chart for the mission selected.

FIG. 3 depicts a screen for allowing the user to select and assign scaled weighing to internal and external customer sets.

FIG. 4 depicts a screen for allowing the user to set a target satisfaction value for each desired outcome.

FIG. depicts—a screen which displays desired outcomes listed in order of importance.

FIG. 6 depicts a screen which displays predictive metrics prioritized with respect to the desired outcomes.

FIG. 7 depicts a screen capable of displaying detailed information about a specific predictive metric.

FIG. 8 depicts a screen for allowing the user to define various options for evaluation.

FIG. 9 depicts a screen for defining a baseline option against which all others will be compared.

FIG. 10 depicts a screen for evaluating specific options relative to the baseline option.

FIG. 11 depicts a screen for displaying the results indicating the degree to which specific options satisfy desired outcomes.

FIG. 12 depicts a screen for allowing the user to improve various options.

FIG. 13 depicts a screen for allowing the user to set target dates for achieving desired results.

FIG. 14 is a basic system level logic diagram.

FIG. 15 is a detailed system level logic diagram.

FIG. 16 is a basic code level flowlogic diagram.

FIG. 17 is a detailed code level flow logic diagram.

FIG. 18 is a state transition diagram illustrating the menu selectable options.

FIGS. 19a and 19b represent actual data including desired outcomes and unprioritized predictive metrics in connection with an internal customer segment (management) and the process of doing business.

FIGS. 20a and 20b represent the data of FIG. 19 wherein the predictive metrics are prioritized in terms of importance and satisfaction.

FIG. 21 is a listing of the predictive metrics of FIG. prioritized and ranked in terms of normalized importance.

FIGS. 22a and 22b represent an evaluation of competing strategies using the prioritized predictive metrics of FIGS. 19 and 20.

FIGS. 23a and 23b represent the establishment of yearly goals in connection with the prioritized predictive metrics.

FIG. 24 depicts the report generator, or Report Wizard, screen, which provides access to numerous reports that represent different view of customer, competitor and market data.

FIG. 25 depicts the main Virtual Laboratory screen for testing ideas and concepts.

FIG. 26 depicts the “select target segment” screen of the Virtual Laboratory.

FIG. 27 depicts the “define the concepts to be tested” screen of the Virtual Laboratory.

FIG. 28 depicts the “evaluate the concepts” screen of the Virtual Laboratory.

FIG. 29 depicts the “review evaluation results” screen of the Virtual Laboratory.

FIG. 30 depicts the “improve and optimize the best concept” screen of the Virtual Laboratory.

FIG. 31 depicts the Features Database screen.

FIG. 32 depicts the Create Optimal Concept screen which is created from established concepts residing in the software.

FIG. 33 depicts the User Create Concept screen which permits the user to manually create the concept.

FIG. 34 depicts the Outcome-Based Benchmarking Worksheet screen.

FIG. 35 depicts the Constraints screen for capturing and communicating internal and external constraints imposed on potential solutions.

FIG. 36 depicts the Complaints screen for capturing complaints.

FIG. 37 depicts the Deployment Programs screen which illustrates programs created for the concepts chosen for deployment.

FIG. 38 depicts a flowchart of an example of a method for obtaining desirable product-specific outcomes.

### DETAILED DESCRIPTION

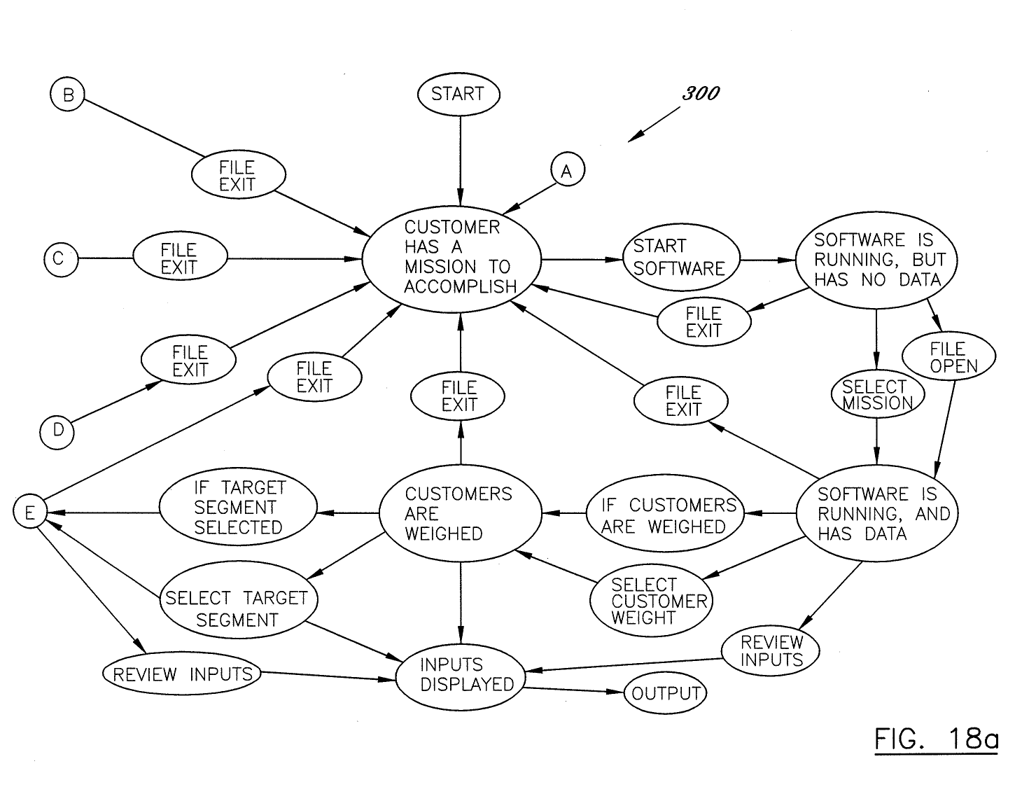

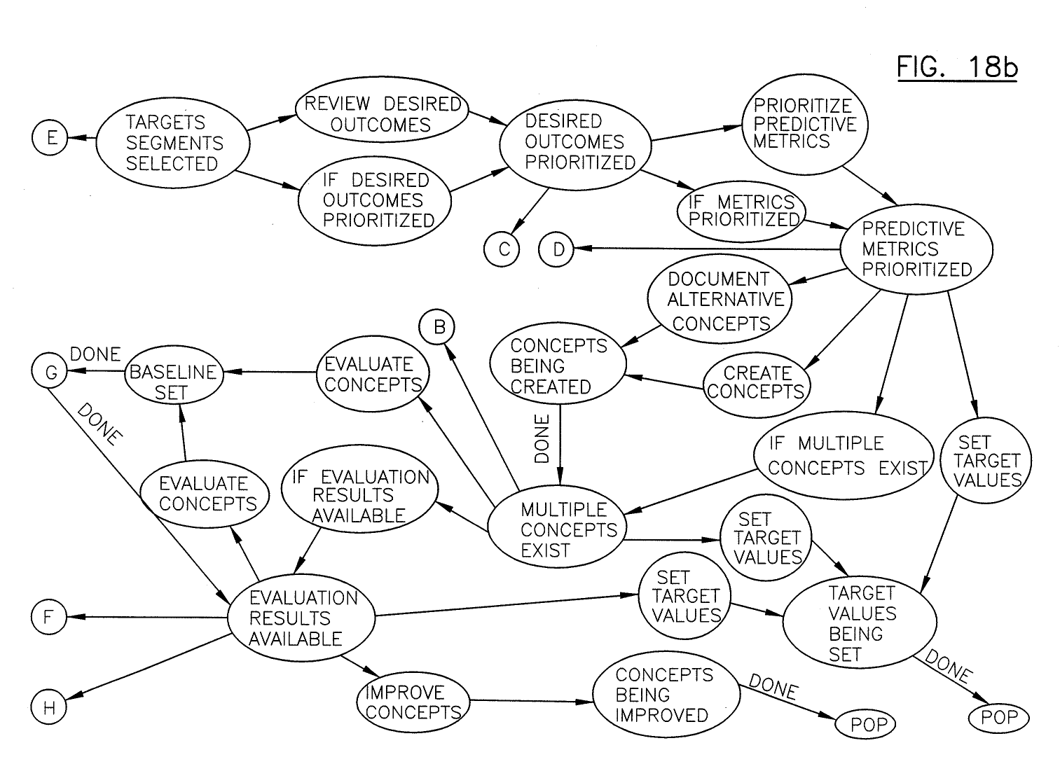

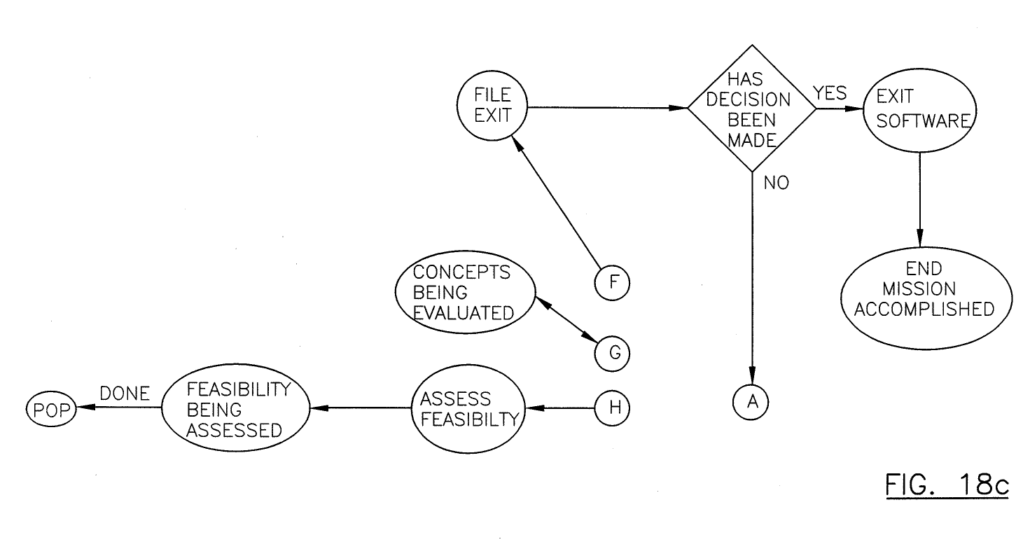

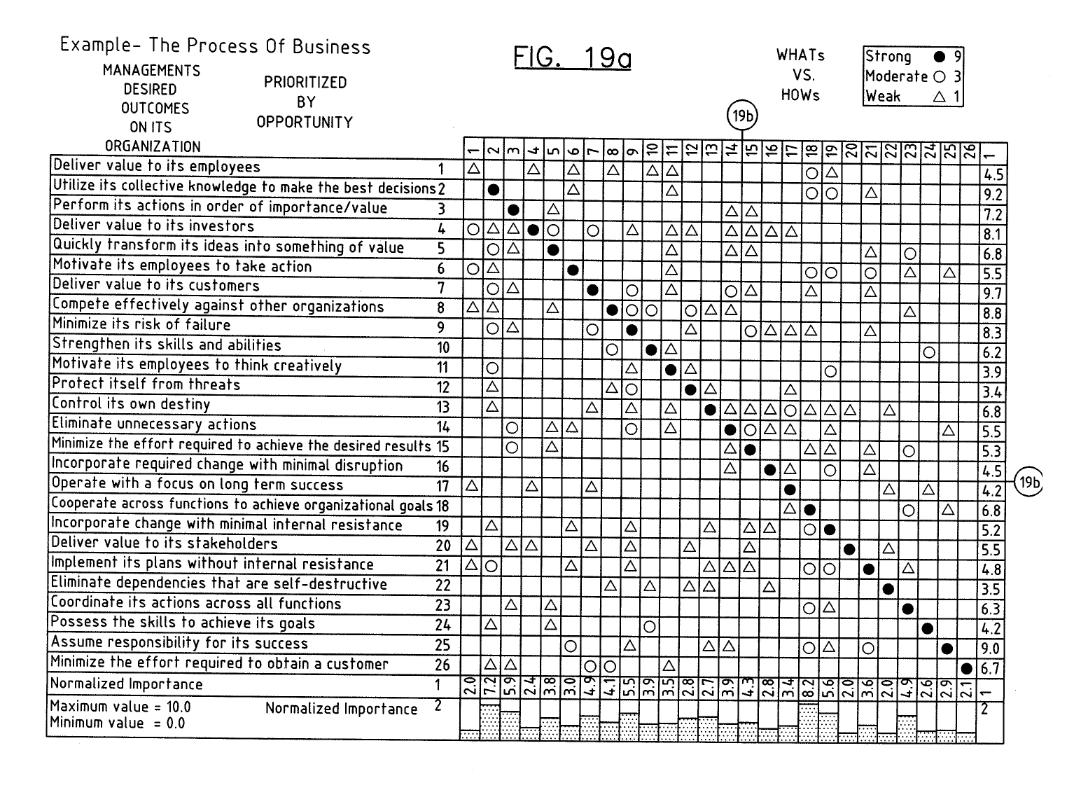

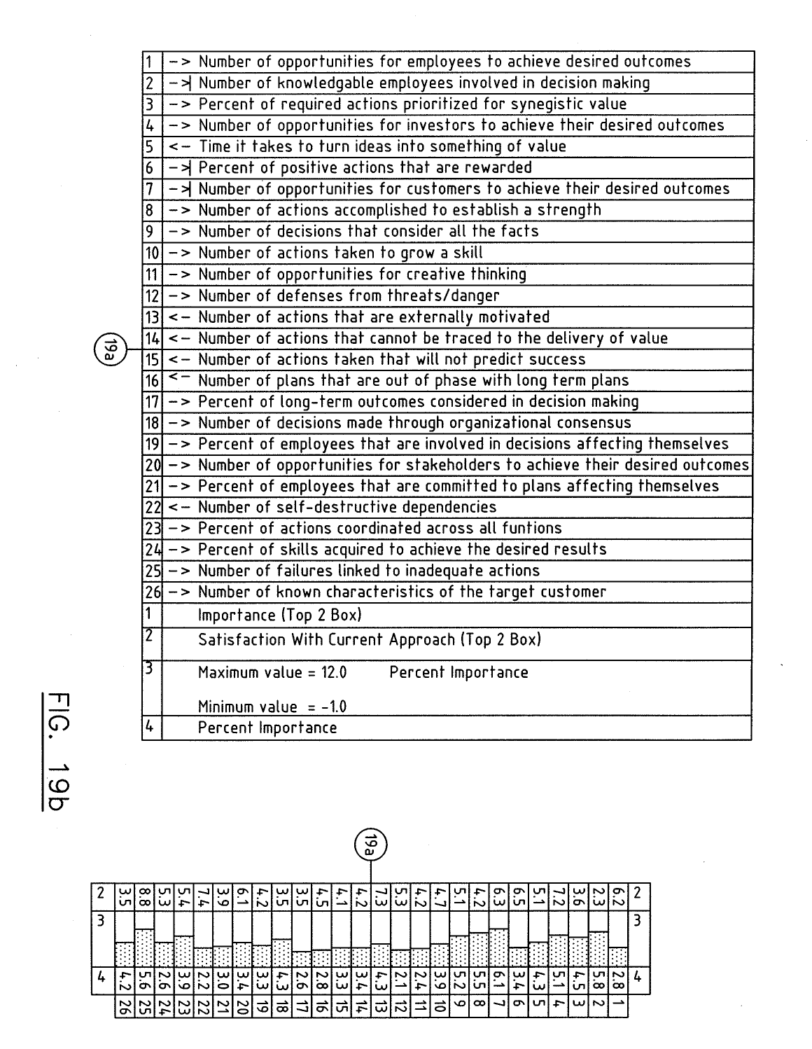

With reference to the drawings, the examples of FIGS. 1-18a-c depict a computer system 100. A computer system, as used in this paper, is intended to be construed broadly. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. As used in this paper, the term “computer-readable storage medium” is intended to include only physical media, such as memory. As used in this paper, a computer-readable medium is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The bus can also couple the processor to the non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable storage medium.” A processor is considered to be “configured to execute a program” when at least one value associated with the program is stored in a register readable by the processor. As used in this paper, an engine is a processor configured to execute a program, including the hardware and software (if any) necessary to carry out the functionality associated with the program.

The bus can also couple the processor to the interface. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device.

In one example of operation, the computer system can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. The signals take on physical form when stored in a computer readable storage medium, such as memory or non-volatile storage, and can therefore, in operation, be referred to as physical quantities. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it should be appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical quantities within the computer system's registers and memories into other data similarly represented as physical quantities within the computer system memories or registers or other such information storage, transmission or display devices.

The algorithms and displays presented herein are not necessarily inherently related to any particular computer or other apparatus. Various general purpose systems may be used with programs to configure the general purpose systems in a specific manner in accordance with the teachings herein, or it may prove convenient to construct specialized apparatus to perform the methods of some embodiments. The required structure for a variety of these systems will appear from the description below. Thus, a general purpose system can be specifically purposed by implementing appropriate programs. In addition, the techniques are not described with reference to any particular programming language, and various embodiments may thus be implemented using a variety of programming languages.

The computer system can be coupled to a network. The network can include a networked system that includes several computer systems coupled together, such as the Internet. The term “Internet” as used herein refers to a network of networks that uses certain protocols, such as the TCP/IP protocol, and possibly other protocols such as the hypertext transfer protocol (HTTP) for hypertext markup language (HTML) documents that make up the World Wide Web (the web). Content is often provided by content servers, which are referred to as being “on” the Internet. A web server, which is one type of content server, is typically at least one computer system which operates as a server computer system and is configured to operate with the protocols of the World Wide Web and is coupled to the Internet. The physical connections of the Internet and the protocols and communication procedures of the Internet and the web are well known to those of skill in the relevant art. For illustrative purposes, it is assumed the network broadly includes, as understood from relevant context, anything from a minimalist coupling of the components, or a subset of the components, illustrated in the examples of the various figures, to every component of the Internet and networks coupled to the Internet.

The computer program includes two functionally different components: (1) a database input loader allows for input and storage of data for use in evaluating specific strategies for expanding the applications database, and (2) a functional shell includes routines for accessing the data and conducting the mathematics and matrix analysis necessary for strategy evaluation. The incorporation of an input module and a functional shell is useful for the conformance of the software to any application for which suitable research data exists, or for user entry of personal preferences or desires.

The computer program can be delivered to the user having desired outcome and predictive metric data pre-loaded. An example of desired outcomes and predictive metrics may be found in the Figures. The weighted numerical values assigned to the desired outcomes and predictive metrics are based on deployment normalization calculations as described in International TechneGroup Inc.'s paper entitled “Deployment Normalization” by Dilworth Lyman and Robert Hales, the content of which is incorporated herein by reference. While such calculations may be known, techniques described in this paper make it available in a modified, user friendly computer based format and incorporates novel methods of sorting and dividing the acquired data. Research must be complete with results quantified and loaded into the proper application data base memory locations before delivery to the ultimate user. The following description explains the research and methodology for a given application.

### I. ESTABLISHING AND QUANTIFYING DESIRED OUTCOMES

Initially, a finite set of customer desired outcomes for a given application are identified. Specifically, for each specific application, or mission, identified for evaluation and optimization, qualitative research is conducted and information is gathered and quantified.

A. Primary Customer Sets

A commercial example of the process is structured around understanding the desired outcomes of typically two primary customer sets: (1) the external customer; and (2) the internal customer. External customers comprise individuals or groups that will benefit from the evolution of a given process, and may include end users, purchasers, retailers, or any other suitable customer group. Internal customers comprise individuals or groups involved in the business of evolving the process, and may include manufacturers, investors, management, or any other suitable group.

In the commercial example, the internal and external customer environments are analyzed, utilizing statistically valid research techniques, to determine and quantify what the external customers value. This research involves gathering customer desired outcomes from a sample of individuals that represent the potential target market for various market segments. The following description will refer to a typical commercial example whereby the application relates to the development of a “commercial product.”

1. External Customers

The external customer sets for a specific commercial product are identified and qualitative research is conducted, typically through interviews (e.g. customers in the U.S. market, customers in the European market, etc.). In this manner, external customer desired outcomes are determined for each external customer set. Quantitative market research then establishes what specific desired outcomes are important to each specific customer set as customers in the United States may value particular benefits or desired outcomes differently than customers in Europe, Canada, etc.

The quantitative market research is conducted through interviews with a representative sample of the target market. The external customers are often “end users” and individuals responsible for making the decision to purchase the organization's products or services. This statistically valid research is conducted by data collection experts using telephone, personal interviews or any other suitable techniques.

The research is completed across a geographic area of interest and the organization is not identified as the sponsor of the study. The most advanced, proven collection and scaling techniques are used to ensure data validity and strong discrimination. Furthermore, as discussed above, each market may be further segmented geographically (e.g. customers in the U.S., the southern U.S., Florida, South Florida, etc.) or by any suitable means including the use of advanced cluster analysis techniques where the basis for segmentation is the customers desired outcomes. The market may be segmented by what different customers value. Using customer desired outcomes as the basis for segmentation enables an organization to assess market opportunity with precision, and design products and services that address unique market needs. The results of the segmentation analysis often reveal the existence of segments that cut across traditional classification schemes. Each of these segments represents a new market opportunity. The computer program using the instant process will then utilize this information to allow the user to identify the most attractive segments to target.

An example of actual desired outcomes is shown in FIG. 19 (left hand column) for the internal customer of management set in connection with the mission of the process of doing business.

For each market segment for which research data is obtained, that data is quantified and prioritized. For example, the desired outcomes identified for a particular market segment are ranked in terms of those desired outcomes that are important yet unsatisfied being assigned a high rank, while those desired outcomes that are non-important and/or satisfied being assigned a low rank.

An example of desired outcomes ranked in terms of importance and satisfaction shown in FIG. wherein the desired outcomes shown in FIG. 19 have been ranked in terms of importance and satisfaction as described above.

2. Internal Customers

In the commercial embodiment, the internal customer environment is also analyzed for use. The internal customer may comprise stakeholders (e.g. investors), management, production, etc. An internal customer is an individual or group involved in the business of evolving a process.

For example, a stakeholder may include a manager, non-manager, designer, sales person, board member, or investor. The stakeholder environment is analyzed to uncover and evaluate stakeholder desired outcomes in connection with a product or service. The stakeholder's outcomes may be strategic in nature or involve cost, quality or timing issues. The objective is to ensure that the selected product or service delivers value to the stakeholder as well as the external customer. As with the external customer, the stakeholder environment may also be segmented.

First, representatives from each function within the organization are interviewed to uncover their desired outcomes utilizing NLP techniques. These outcomes are captured and prepared for quantification. The desired outcomes are then prioritized for importance by representatives of each functional organization as previously described in accordance with satisfaction and importance levels.

Likewise, internal customers such as production may be included in the research. Production is analyzed to insure the resulting product or service can be manufactured or delivered. Using NLP, desired outcomes are captured from the individuals responsible for the delivery of the resulting product or service. The objective of this analysis is to ensure that production and delivery is considered in the planning phase of the project, and that the solution will be free from production or delivery issues. The desired outcomes obtained are prioritized for importance by representatives of the production or delivery organization.

Production desired outcomes are considered in conjunction with external customer desired outcomes, however, external customer outcomes are often given more weight. A goal is to create a concept that delivers value to the customer and also satisfies stakeholder and production desired outcomes.

Production environment research may be as specific as the application requires; for instance, the production environment may be segmented between manufacturers in the U.S., China, etc., and further segmented to specific manufacturing facilities in each country.

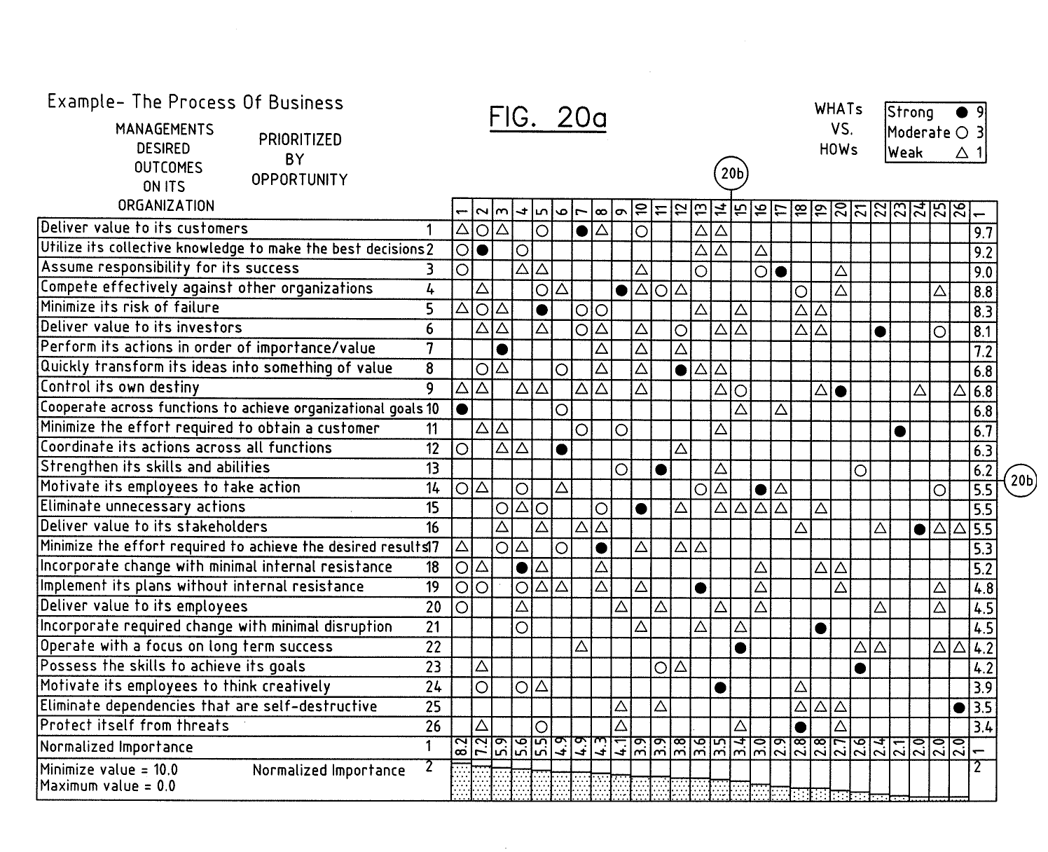

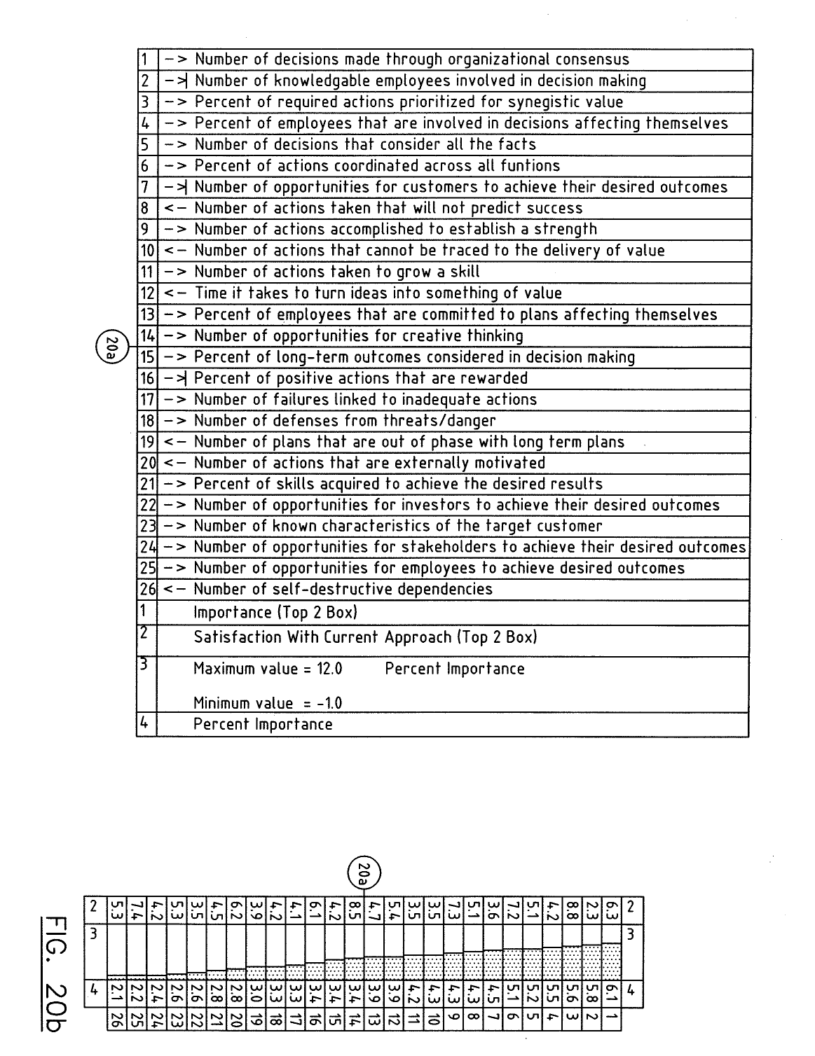

The desired outcomes from the above-referenced customer sets are quantified to establish importance ratings of the desired outcomes whereby those desired outcomes which are important yet unsatisfied are assigned a high rank, while those desired outcomes which are not important and/or satisfied are assigned a low rank. Once the desired outcomes are established and ranked, they are organized into a computer database which is pre-loaded into the computer memory, or stored on a data storage means before delivery to the user. See FIGS. 19 and 20.

### II. PREDICTIVE METRICS

A finite set of predictive metrics for a given application are established. Predictive metrics are measurable parameters that predict a desired outcome will occur. A single predictive metric is defined for each desired outcome; however, as each metric may predict, to some extent, the satisfaction of more than one desired outcome, each metric is assigned a predictive relationship value for each desired outcome depending upon the degree with which that metric predicts satisfaction of that particular desired outcome. Accordingly, each predictive metric is also assigned a cumulative predictive value which represents the strength of the predictive metric with respect to the degree to which the predictive metric predicts satisfaction of all of the prioritized desired outcomes.

The predictive metrics are formulated by market or industry research, and, once formulated, are organized into a computer database. Once collected and organized, the data is loaded into the software prior to delivery to the user. FIG. 19 illustrates actual data wherein desired outcomes are listed down the left hand column (nos. 1-26) and corresponding predictive metrics are listed from left to right across the top (nos. 1-26). This data was obtained for an internal customer set (management) in connection with a mission involving the process of business. Note as seen in FIG. 19 for each desired outcome there is a corresponding predictive metric established which strongly predicts (strength of prediction indicated by solid circle) delivery of the desired outcome. In addition each metric is assigned a predictive value relative to each desired outcome. In the data shown in FIG. 19 the ability of each predictive metric to predict the success of each desired outcome is indicated by strong, moderate, and weak indicators which are graphically represented by a solid circle, a circle, and a triangle respectively, which correspond to numerical values (9, 3, and 1, respectively). Turning now to FIG. 20, the prioritizing of desired outcomes in terms of importance and satisfaction results in the realignment of predictive metrics in terms of normalized importance. Accordingly, those desired outcomes which are important and unsatisfied are highly ranked, while those desired outcomes that are unimportant and/or currently satisfied are ranked low; and, predictive metrics are realigned such that those metrics which strongly predict the delivery of one or more highly ranked desired outcomes are found to the left hand side of FIG. (high normalized importance), while those predictive metrics which predict delivery of relatively low ranked desired outcomes are found to the right hand side of FIG. (low normalized importance).

With reference to FIG. 14, the basic system is shown. The basic system level logic for the creation and optimization of solutions and strategies comprises a user interface, a computer interface or input device 102, a data storage device 104 with software program, memory and CPU 106 to present and process data, and a visual display 108. The user is to access the software using established computer technologies. The data in the software has the properties of digital information in that it can be stored, transferred, updated, modified, presented and applied using existing and future digital, computer and networking technologies. A more detailed system is shown in FIG. 15. Referring to FIG. 15, the data storage device stores the software and data as generally shown in the attached blocks 1-18. The mechanism blocks 127-138 shown are essentially the subroutines which manipulate the stored data in accordance with user inputs. The data is stored in locations represented by blocks 121-126.

Turning now to FIGS. 1-14, and by way of the following example, based on an example directed toward business strategies, operation of the system 100 shall be described.

A. Engine Operation

Functionality of the system 100 can be carried out by one or more engines. As used in this paper, an engine includes a dedicated or shared processor and, hardware, firmware, or software modules that are executed by the processor. Depending upon implementation-specific or other considerations, an engine can be centralized or its functionality distributed. An engine can include special purpose hardware, firmware, or software embodied in a computer-readable medium for execution by the processor.

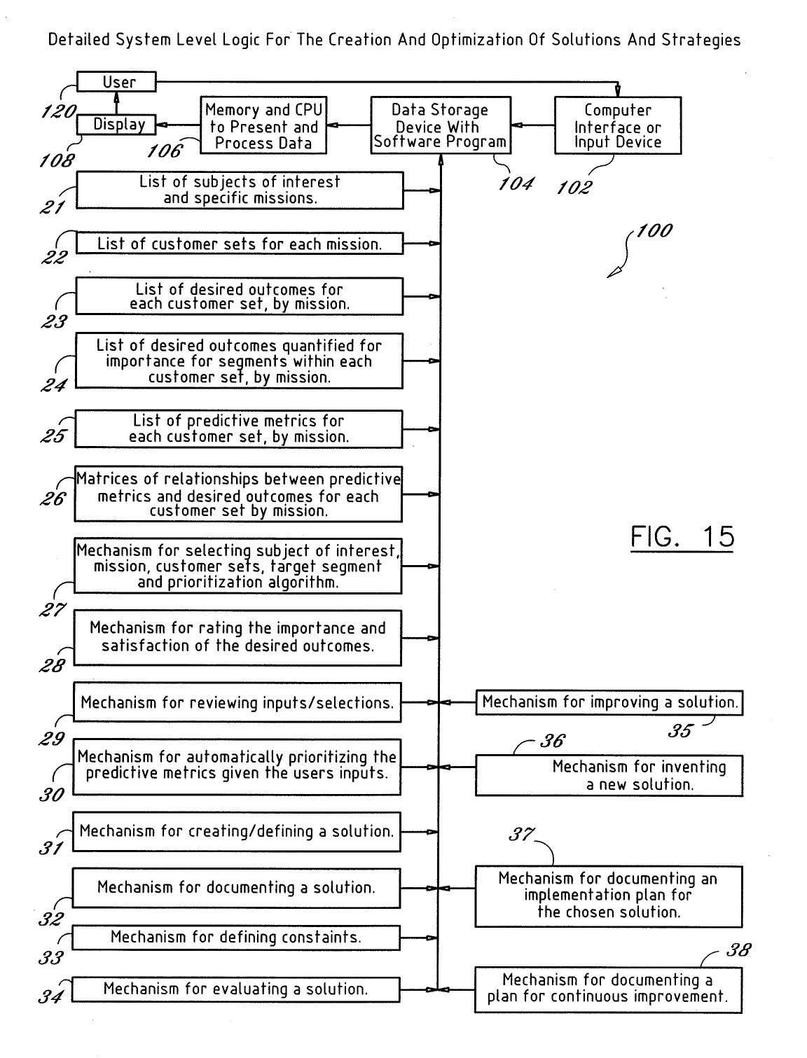

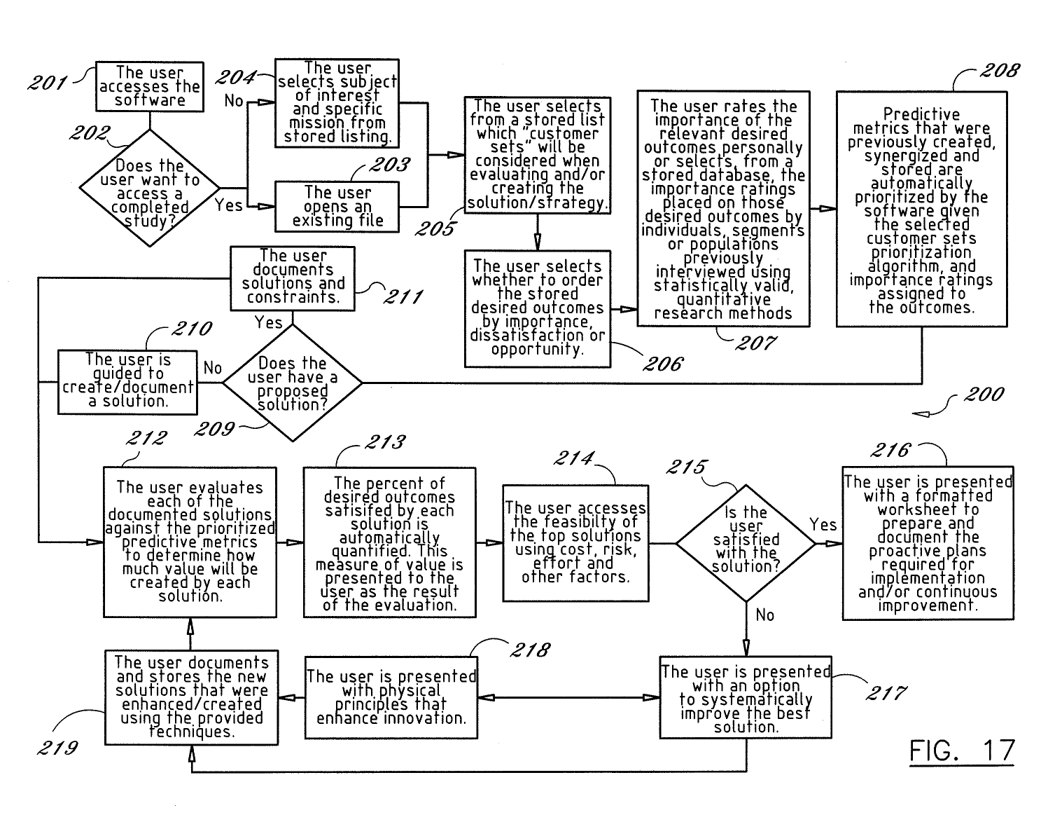

Referring to FIG. 16, the basic code level for the creation and optimization of solutions and strategies is shown. The detailed system logic is illustrated in FIG. 17. The objective of the code level logic is to present the user with the data that is required to create and quantify the value of a proposed solution in advance of its actual implementation, and to insure that the chosen solution is not only competitive, but that it does not violate any constraints imposed by the user or others.

The logic is to set up an equation that can be solved to find the optimal solution for any point in time. With reference to FIG. 16, the constraints, desired outcomes, and target values are treated as constants in this equation and the universe of solutions is treated as a variable as new solutions are made available over time with the introduction of new ideas, technologies, and alternatives.

Given that hundreds of possible solutions, ideas, and alternatives exist for any strategic situation, the user is guided to find, define, create, or invent the solution that will best satisfy the desired outcomes of those involved in that situation. The optimal solution is the one that will deliver the most value given the effort, risk, and cost that the user is willing to expend.

As depicted in FIG. 1, Screen 1: The first screen display allows the user to select among a number of specific subjects and specific missions or applications to be analyzed. For example, developing a new or improved product, such as a two-way portable radio concept. The user selects the desired subject of interest and a mission from the subset of specific missions for which research data exists by using an input selection means such as a computer mouse, or keyboard. The computer program allows for a plurality of independent subjects and missions to be stored. The database of stored subjects and missions, thus, may be expanded and expansion is only limited by data storage capabilities. Furthermore, as will soon be apparent the computer program allows the user to store the results of various studies, accordingly, the user can maintain a library of studies, each giving emphasis to specific goals, and each predicting that a particular device will best satisfy the goals identified and selectively weighted by the user, as further discussed below. In this example, the development of an improved two-way portable radio concept is selected.

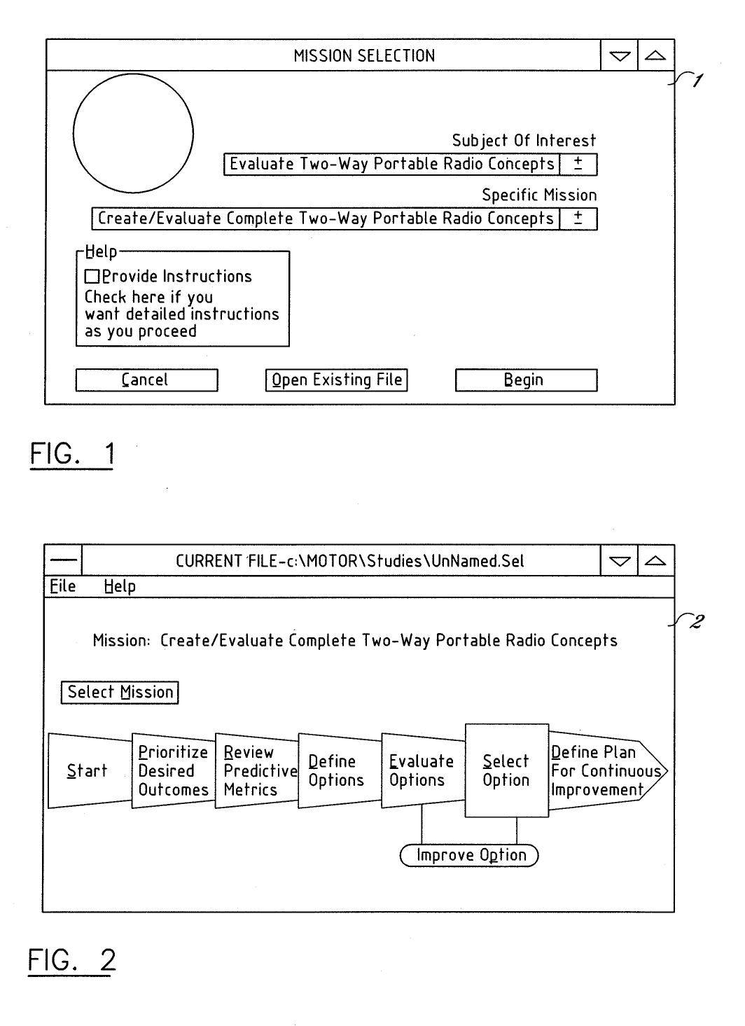

Referring to FIG. 2, Screen 2: The second screen display 2 indicates the particular mission that the user has selected (e.g. Create/Evaluate Complete Two-Way Portable Radio). Each study may be named using alpha-numeric indicia (e.g. study 1, study 2, or device with feature A, features A and C, etc.), and a detailed description of this study may be input and stored. A flow-chart “roadmap” of the process, as it applies to the specific application, highlights the user's progress and may be incorporated into one or more of the display screens. The flow chart is illustrated in FIG. 2. A more detailed flow diagram is depicted in FIG. 17.

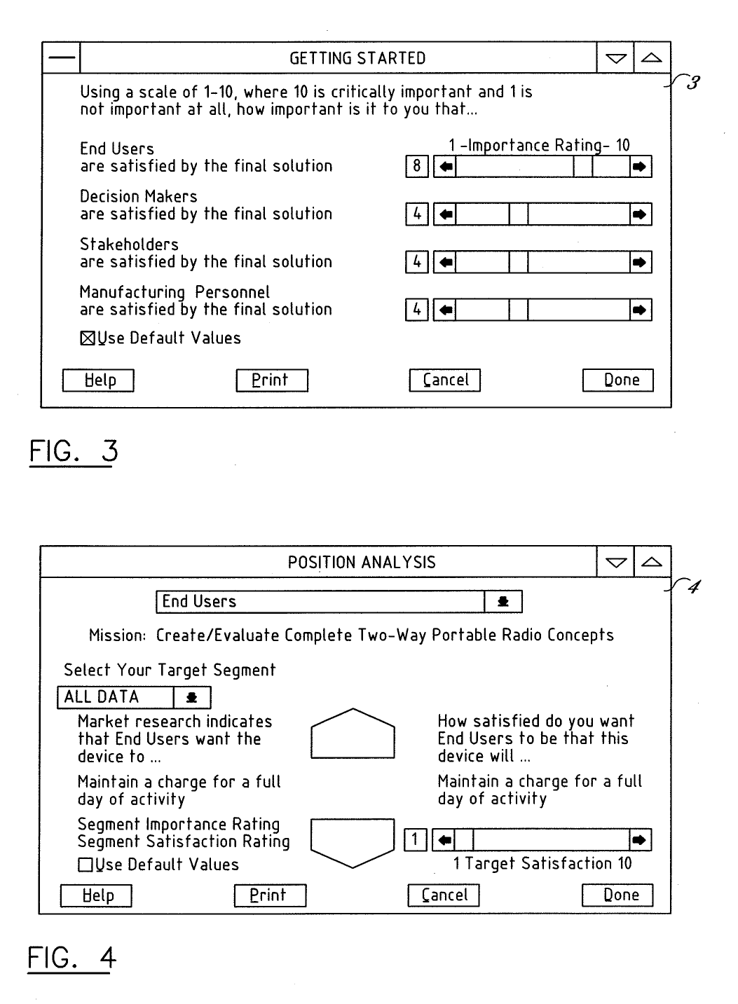

Referring to FIG. 3, Screen 3, the third screen display 3 lists Internal and External customer sets for user selection and importance weighing. For example:

External Customers:
(1) Canadian End Users;
(2) Canadian Purchasing Agents;
(3) U.S. End Users;
(4) U.S. Purchasing Agents; etc.

Internal Customers

Stakeholders:
(1) Long Term Investors
(2) Short Term Investors
(3) Management
(4) Bond Holders; etc.

Production:
(1) U.S. Manufacturing Facilities
(2) U.S. Manufacturing Facility No. 1
(3) U.S. Manufacturing Facility No. 2
(4) Korean Manufacturers
(5) Korean Manufacturing Facility No. 1; etc.

As previously discussed, the user may now select between segments of each customer set. For example, the user may desire to analyze the development of the improved product in connection with the following customer set or market segments:

| CUSTOMER SET | SEGMENT |
|---|---|
| EXTERNAL CUSTOMER SET: | CANADIAN END USERS |
| INTERNAL CUSTOMER SET: | LONG TERM INVESTORS |
| INTERNAL CUSTOMER SET: | U.S. MANUFACTURING |
| | FACILITY NO. 1 |

In the alternative, the user may select to analyze the development of the improved product in connection with the following customer segments:

| CUSTOMER SET | SEGMENT |
|---|---|
| EXTERNAL CUSTOMER SET: | CANADIAN END USERS |
| INTERNAL CUSTOMER SET: | MANAGEMENT |
| INTERNAL CUSTOMER SET: | KOREAN MANUFACTURERS |

As previously discussed, for each customer segment above, qualitative and quantitative research has established and prioritized desired outcomes, which data is stored in a computer database. Furthermore, for each customer set, predictive metrics have been formulated corresponding to the desired outcomes, which data may also be stored in a computer database, or any other suitable data storage means.

As further depicted in FIG. 3, once the user has selected the particular customer set for analysis, an importance rating is assigned to each customer set to weigh the analysis in favor of, or against, one or more customer sets. In one implementation, importance ratings for each customer set are scaled (e.g. from 0 to 10, or 0 to 100) such that the sum total for all customer sets equals the range maximum (i.e. or 100). Thus, with all else being equal, increasing the importance rating for a given customer set requires decreasing the importance rating for one or more other customer sets. The user assigns said customer set importance ratings by appropriate commands through a suitable input device (e.g. mouse, keyboard, etc.). The computer program may also include default values for the importance ratings. Thus, for example the user may elect to assign importance ratings as follows:

| CUSTOMER SET IMPORTANCE | SEGMENT | |
|---|---|---|
| EXTERNAL CUSTOMER SET: | CANADIAN END USERS | 6 |
| INTERNAL CUSTOMER SET: | MANAGEMENT | 1 |
| INTERNAL CUSTOMER SET: | KOREAN MANUFACTURERS | 3 |

In an example, importance ratings are assigned by the user by adjustment of displayed sliding scales which are responsive to keyboard commands, or the commands of a computer mouse, or any other suitable input means. Accordingly, each customer set is weighted according to relative emphasis, and the user is able to increase/decrease the consideration importance, or weight, by adjusting slider displays by way of input commands. Customer sets assigned a value greater than zero are evaluated further, while customer sets assigned a zero value are not utilized in further process calculations. The sliders may each have a corresponding range from 0 to 10, and calculation routines automatically determine and display the relative rank of each customer set based on the weight selected by the user.

Furthermore, secondary screens (not shown) may be displayed which provide more detailed information concerning a particular customer set such as the exact make [symbol] up or other information that may be of interest to the user. Once the ratings are established the user continues the process by selecting a “done” button whereby the flowchart disclosed in FIG. 2 may be displayed indicating the stage of the process completed.

Referring to FIG. 4, Screen 4, the fourth screen 4 allows the user to review the subset of desired outcomes associated with each selected market segment of each customer set that has been assigned a positive or importance rating on screen 3. This screen provides a display comprising a sorted list of the desired outcomes prioritized using the following formula:

PRIORITY=(IMPORTANCE−SATISFACTION)+IMPORTANCE

While the formula disclosed directly above is contemplated, it may be desirable, in certain applications to prioritize desired outcomes based on pure importance or dissatisfaction, or in accordance with some other metric.

It is important to note that, as to the desired outcomes, Importance and Satisfaction ratings result from the qualitative and quantitative market research. Accordingly, priority ranking is automatic. (See, e.g. FIG. 20 wherein desired outcomes are ranked down the left hand column). The above referenced formula results in increasing the priority of those desired outcomes which the customer segment considered unsatisfied, while decreasing the priority of those desired outcomes the customer segment considers satisfied or non-important. A print option allows the user to obtain a hard copy printout for review and evaluation. The user may advance to the next screen by signaling a “done” input. Upon completion of this screen the main window of screen 2 is displayed indicating the stage of the process completed.

In an alternate embodiment directed to personal strategies it may be desirable to enable the user to input importance and satisfaction ratings as they relate specifically to the user. For example, in connection with a personal growth category there may be as a Desired Outcome—“Understand Yourself Relative to Others.” The user then selects the importance of “Understanding himself relative to others” and the current level of satisfaction by use of adjustable slider displays as previously discussed. As the user selects and adjusts the importance of each desired outcome, the software automatically calculates, updates, ranks, and displays the most important and least satisfied personal desired outcomes. Thus, the user is able to prioritize his/her desired outcomes consistently. The user advances between desired outcomes using next desired outcome/previous desired outcome input options. Upon completion of this screen the flowchart screen is displayed indicating the stage of the process attained.

In the commercial embodiment it is not always desirable to allow the user to adjust the importance/satisfaction ratings assigned to desired outcomes as these values are the result of quantitative market research, and, hence, what is important to the software user is of no significance.

Referring to FIG. 5, Screen 5, the fifth screen displays the desired outcomes (identified as requirements in FIG. 5) for all of the selected customer sets in sorted order of importance of consideration taking into account the weighing assigned to each customer set.

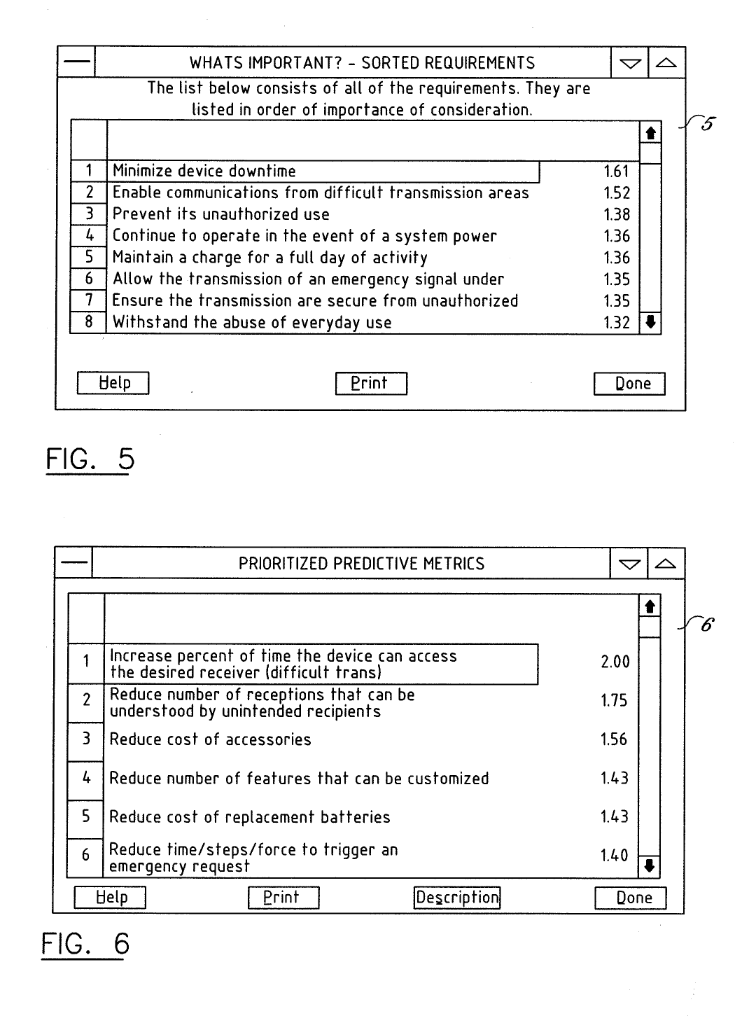

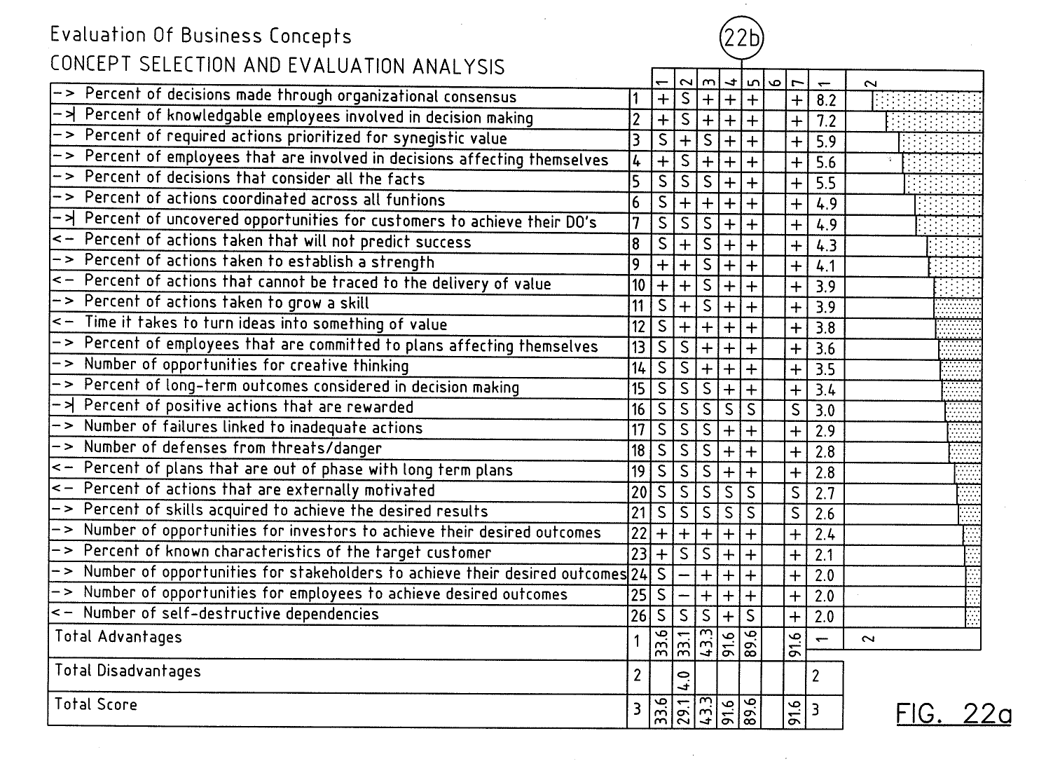

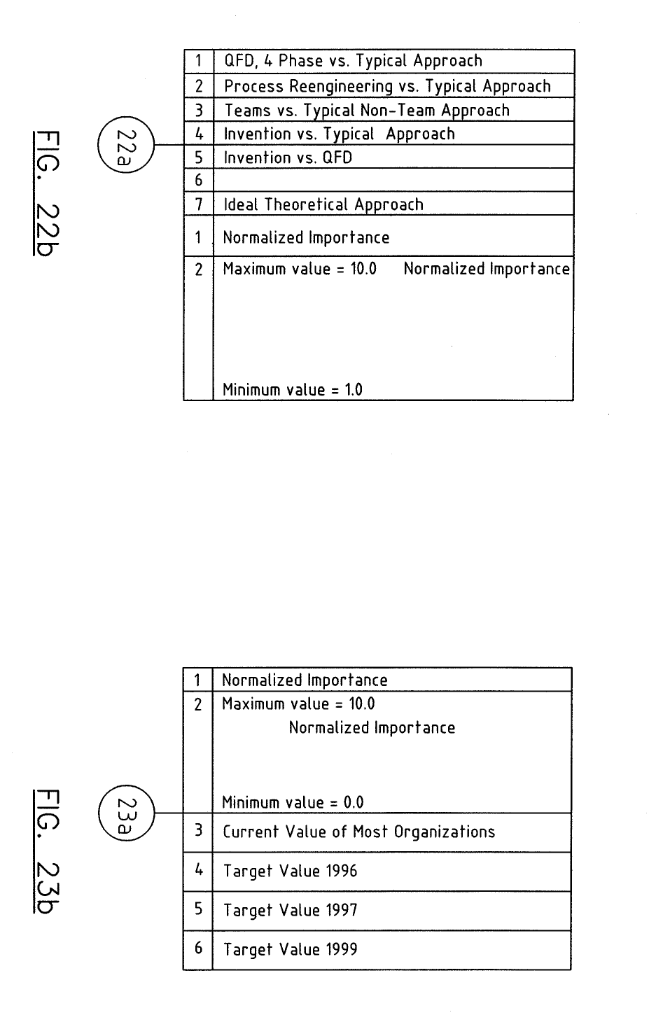

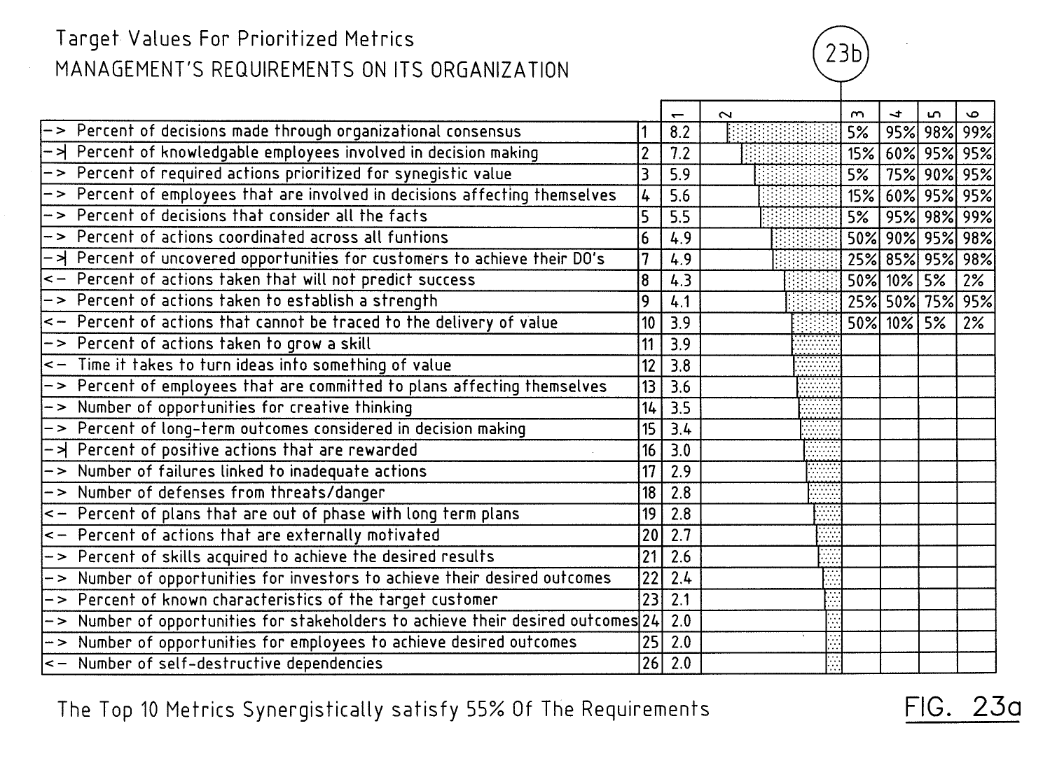

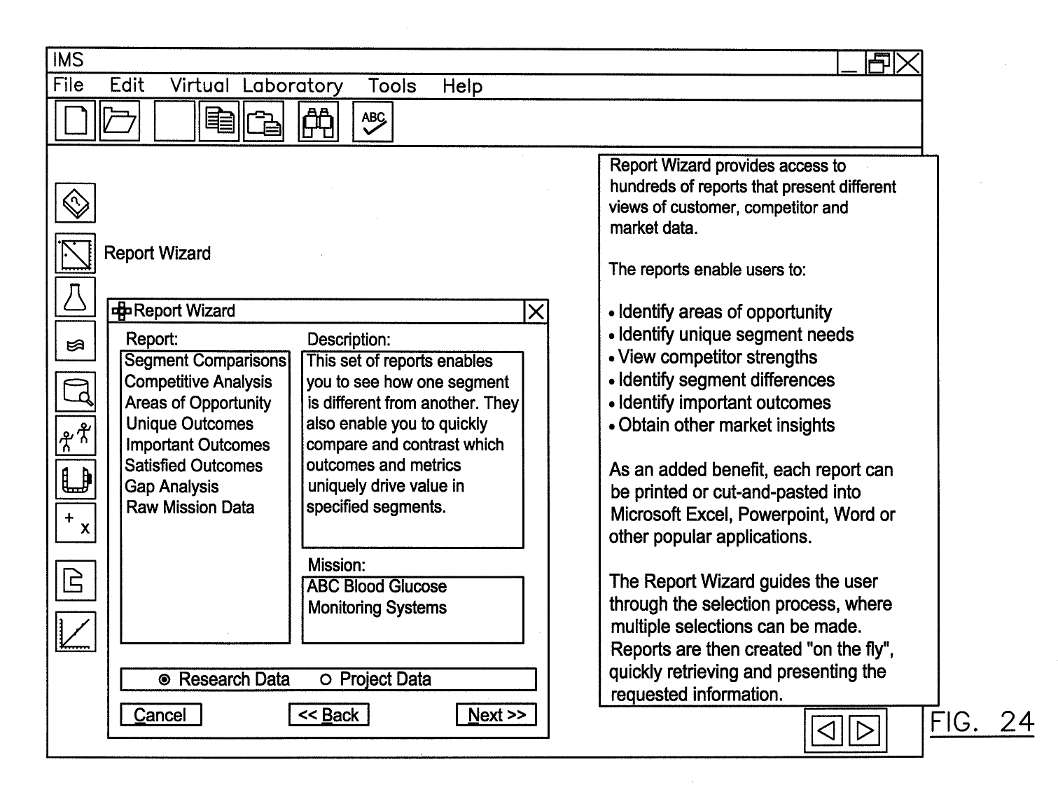

Referring to FIG. 6, the sixth screen 6 relates to the specific metrics that predict satisfaction of the user's desired outcomes ranked in order of normalized importance. The metrics list is displayed in prioritized and sorted order. The prioritization is calculated using the proportional distribution method NORMTI using the calculated importance of the desired outcomes. Accordingly, the predictive metrics are listed in order of importance of consideration for evaluating options taking into account the calculated importance of desired outcomes. In essence, those metrics which yield a disproportionate share of customer desired outcomes (i.e. those metrics which satisfy important customer desired outcomes) are assigned a high priority, while those metrics which yield a relatively low share of customer satisfaction (i.e. those metrics which only partially satisfy one or more customer desired outcomes of little importance) are assigned a low priority. (See, also FIGS. 20 through 23).

This screen includes options that allow the user to review a detailed description of each of the metrics, however, the user does not have the ability to adjust the ranking of the metrics directly as the metrics are prioritized depending upon the desired outcomes prioritization. Upon completion of this screen the flowchart screen may be displayed indicating the stage of the process completed.

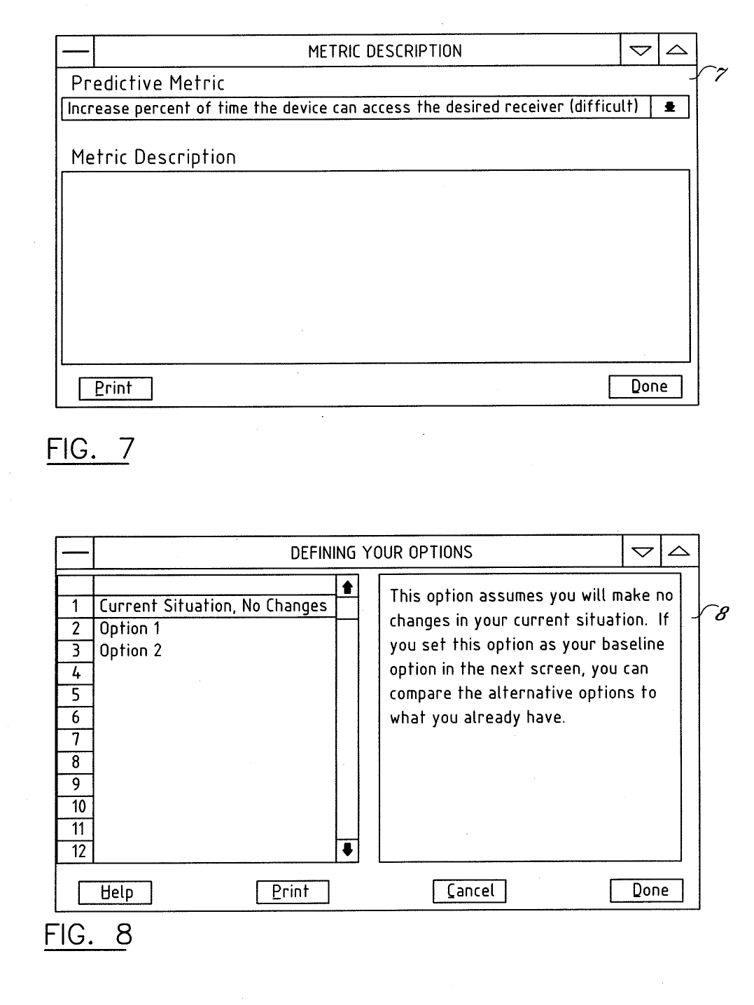

Referring to FIG. 7, Screen 7 is a secondary screen displayed if the user desires more detailed information about one or more metrics. The detailed information normally would appear in the box identified as “metric description.” Screen 7 is optional and is reached only when the option is selected from screen 6. The user has the ability to select any and all of the metrics for such detailed review. When the user has finished reviewing detailed metric descriptions, the program returns to screen 6.

Referring to FIG. 8, Screen 8 is identified as an options screen. In this screen, the user defines one or more options that are available. The screen allows for each option to be defined or otherwise described in detail and identified by a short option title. A spell check feature assists the user in producing error free option descriptions. Upon completion of this screen the flowchart may be displayed indicating the stage of the process attained.

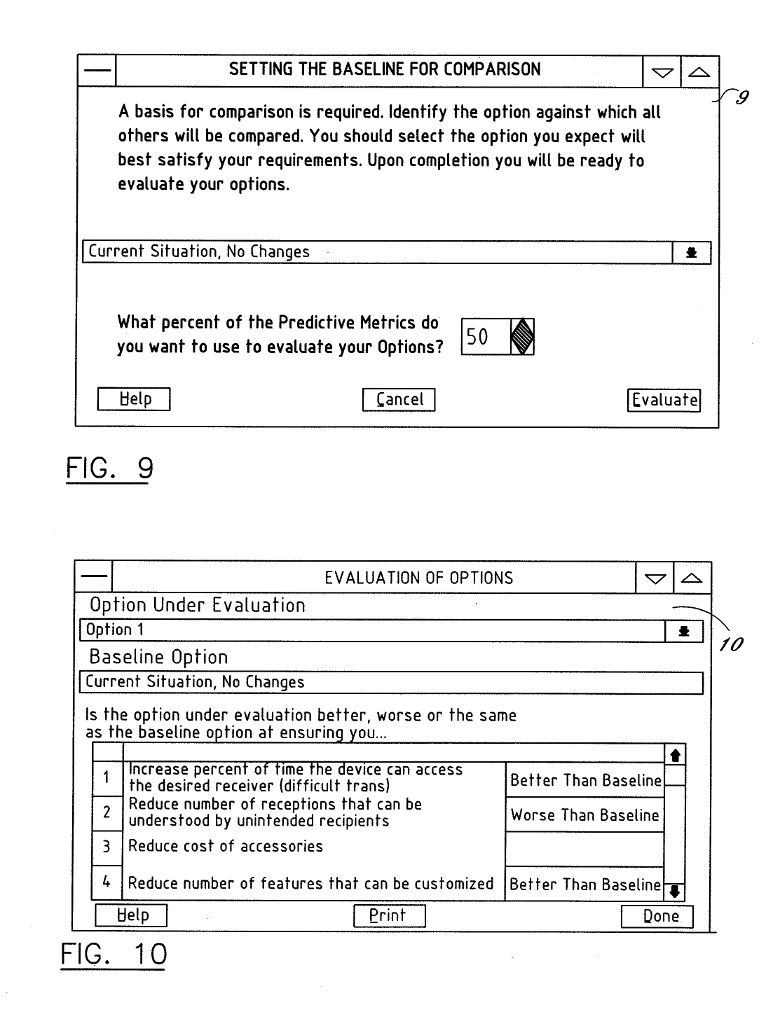

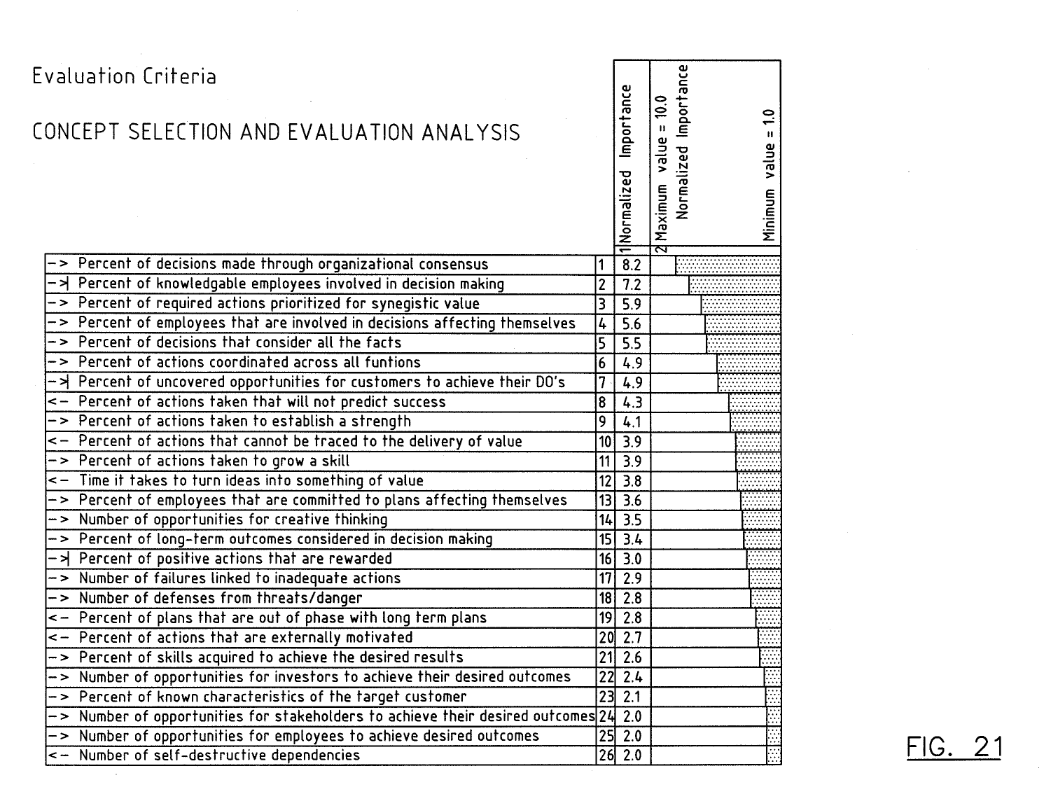

Referring to FIG. 9, Screen 9 allows the user to compare all of the options previously defined in order to determine which would best satisfy the user's desired outcomes. The user selects what is considered to be the best option available as a baseline option against which all others will be compared. This screen also includes an option for allowing the user to evaluate options using a percentage of the predictive metrics. This is desirable as a relatively small percentage of the predictive metrics predict the satisfaction of most desired outcomes. (See, e.g. FIG. 21, wherein the top nine of the twenty-six metrics predict satisfaction of over half of the desired outcomes based on normalized importance).

Referring to FIG. 10, Screen 10 allows the user to select each option analyzed in turn, and then, compare a selected option to the baseline option to determine which option is best. The scale is: Better than baseline, Worse than baseline, or equal to baseline. Thus, for each option, the user compares each option to the predictive metrics from the prioritized predictive metric list for the purpose of evaluating how the option under evaluation compares to the base option. For example, if the option under evaluation (option 1) increases the percent of time the device can access the desired receiver (prioritized predictive metric 1) better than the baseline option, the user enters that indication using a suitable input device in the option rating column. Upon completion, the flowchart screen may be displayed for informing the user of the stage of the process attained.

Referring to FIG. 11, Screen 11 displays the results indicating the relative ratings of the various options. The options are sorted based upon the sum of their ratings against each of the metrics and biased by the relative importance of each metric. A positive rating indicates that a particular option is better than the baseline option selected. The user is encouraged to re-evaluate using different baseline options and to refine options by either adding new options or modifying the options currently defined as shown in screen 12 below.

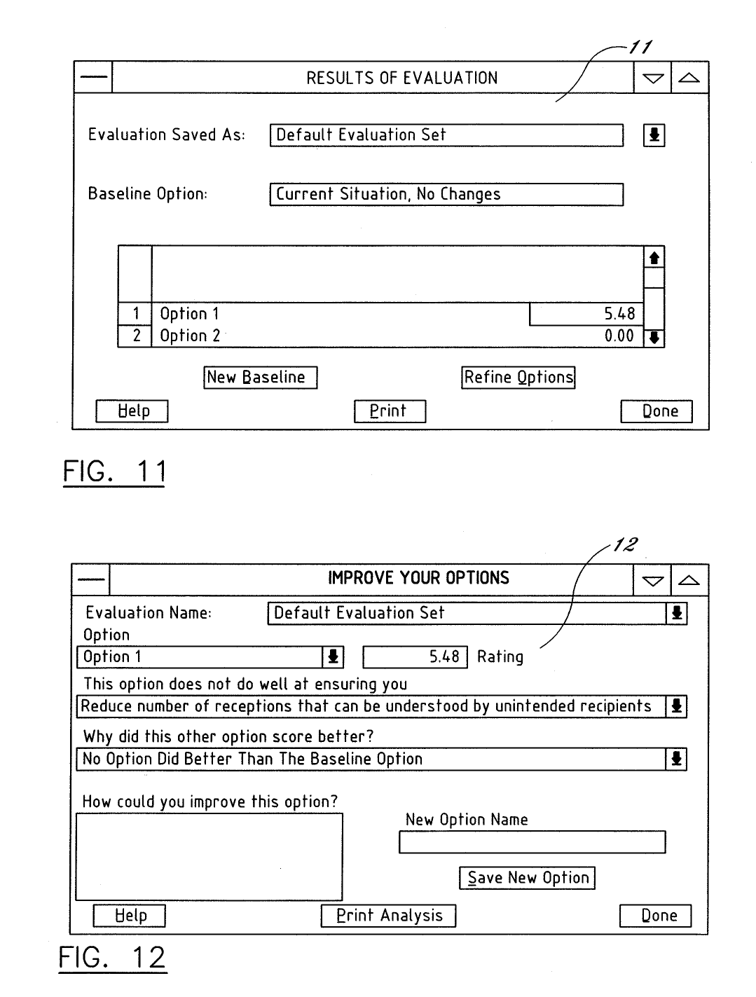

In FIG. 12, Screen 12 displays a selected option and a summary of that options strengths and weaknesses. This screen allows the user to critically review all options thereby identifying specific strengths and weaknesses and create new options by combining strengths found in other options and eliminating identified weaknesses.

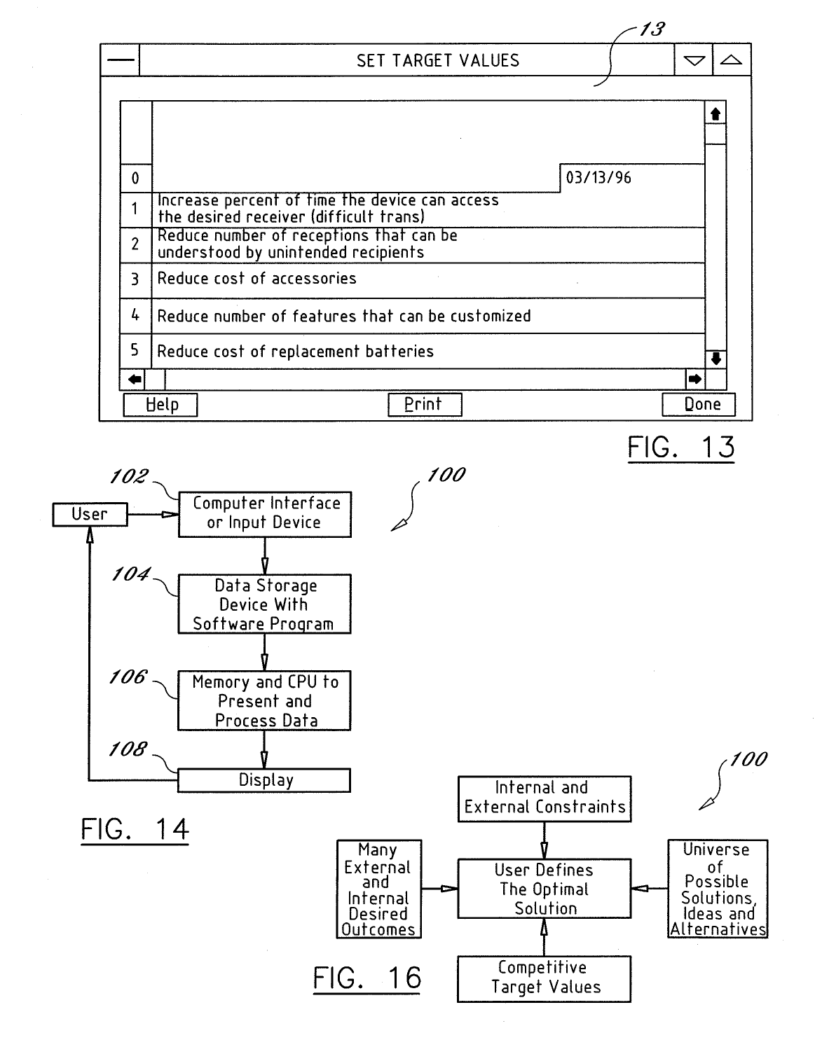

Referring to FIG. 13, Screen 13 allows the user to define the actions necessary to implement the decision that has been recommended. For each action, the user is able to set a target date for completion.

As is now apparent, techniques in this paper describe optimizing strategic decisions by evaluating as many factors as exists desired outcomes and predictive metric data. Use of the instant method enables customer driven decisions, and accounts for many more factors than can possibly be considered by the human mind. Use of the instant method harnesses the power of the computer to analyze these factors to provide statistically valid strategy optimization.

Additional screens (not shown) provide a means for inputting desired outcomes and predictive metrics using the database input loader portion of the computer program.

For example, an additional screen (not shown) controls the database input loader (“loader”) for expanding the number and type of studies evaluated by the functional shell. This screen allows for the selection of several input fields including: studies, customer sets, desired outcomes, and predictive metrics.

Selecting the “input studies” option allows the user to input study names and corresponding categories in outline form. The categories entered form the titles of the lists on Screen 1. After all the desired studies have been defined the user selects the “done” button.

Selecting the “input customer sets” option allows the user to input data relating to new internal and external customer sets (e.g. South American End Users, South American Manufacturing, etc.) for prioritizing. After the new customer sets have been defined the user selects the “done” button.

Selecting the “input desired outcomes” option allows the user to input desired outcomes which correspond to each of the categories defined. After all the desired outcomes have been defined the user selects the “done” button.

Selecting the “input predictive metrics” option allows the user to input all of the metrics used to predict satisfaction of all of the desired outcomes previously input. In addition, a detailed description of each metric may also be entered. After all the metrics have been defined the user selects the “done” button.

Additionally, an embodiment directed to optimization of “personal,” as opposed to “business,” strategies is contemplated wherein the user identifies and ranks desired outcomes as to those outcomes that are important to him/her personally. This embodiment may combine desired outcomes and predictive metric factors obtained through market research and through the individual user's input. Accordingly, the software may be customized by the individual user to optimize personal strategies by factoring in outcomes and metrics established and ranked by the individual as well as outcomes and metrics established by statistically valid research.

With reference to FIG. 17, a summary of the software logic and steps the user goes through is shown. These steps may be generally characterized by the reference numeral 200. First, the user accesses the software 201. The user is then asked if the user wants to access a completed study 202. If the user wants to access a completed study, the user opens an existing file 203. If not, the user selects a subject of interest and a specific mission from stored listing 204. Next, the user selects from a stored list which “customer sets” will be considered when evaluating and/or creating the solutions/strategy 205, after which, the user selects whether to order the stored desired outcomes by importance, dissatisfaction, or opportunity 206. In block 207, the user rates the importance of the relevant desired outcomes personally or selects, from a stored database, the importance ratings placed on those desired outcomes by individuals, segments, or populations previously interviewed using statistically valid, quantitative research methods 207. As shown in block 208, predictive metrics that were previously created, synergized, and stored are automatically prioritized by the software given the selected customer sets, prioritization algorithm, and importance ratings assigned to the outcomes. The user is then asked if he/she has a proposed solution (block 209). If not, the user is guided to create/document a solution (block 210). If the user has a proposed solution, then he/she documents solutions and constraints. As a next step, the user evaluates each of the documented solutions against the prioritized predictive metrics to determine how much value will be created by each solution (block 212). The percent of desired outcomes satisfied by each solution is automatically quantified. This measure of value is presented to the user as the result of the evaluation (block 213). Next, the user assesses the feasibility of the top solutions using cost, risk, effort, and other factors (block 214). If the user is satisfied with the solution, the user is presented with a formatted worksheet to prepare and document the proactive plans required for implementation and/or continuous improvement. Otherwise, the user is presented with an option to systematically improve the best solution (block 217). The user is presented with physical principles that enhance innovation (block 218). The user documents and stores the new solutions that were enhanced/created using the provided techniques (block 219). The user then repeats the steps from block 212.

### III. OUTCOME BASED SEGMENTATION

Desired outcomes can also be the basis for segmentation. As stated above, the desired outcomes can be used by the customers to describe what they want to achieve when using a specific product or service. Some customers place a greater importance on certain outcomes than what other customers do, which establishes clear differences in what customers value. Thus, customers can be innately segmented by what outcomes they value. Accordingly, outcome based segmentation groups together individuals that value the same outcomes.

By adopting outcome-based segmentation a foundation is provided for discovering and sizing high-potential growth markets before they emerge, devising valued product and service portfolios, discovering market entry points for disruptive technology and creating strong outcome based brands.

Outcome-based segmentation can be applied, for example, by the following four steps: (1) collect the needed data, (2) choose the segmentation variables, (3) create and select a solution, and (4) profile the selection. Using a two-way radio product for an example, application of the foregoing steps will be demonstrated for uncovering and targeting untapped market segments. As will be shown, used of outcome-based segmentation enabled the discovery of three unique and unknown segments: (1) outcomes associated with privacy and the ability to communicate discreetly or covertly, (2) outcomes associated with clear and uninterrupted communications in dangerous situations, and (3) outcomes associated with coordinating activities and performing administrative tasks. By identifying these segments, new products can be devised which are optimized for each segment. For example, new features addressing important and unsatisfied outcomes can be added and features that addressed outcomes of little or no importance can be eliminated.

A. Collecting the Required Data

The data required for segmentation can be collected in two stages: (1) customer desired outcomes are captured and (2) the importance and level of satisfaction for the outcomes are quantified. The desired outcomes can be collected or captured by interviewing a diverse cross-section of radio users. Other applicable collection techniques can also be used. Once the outcomes were captured, a survey, questionnaire, etc. can be used to capture the importance the users placed on each outcome and the degree to which each outcome was currently satisfied.

The results can be used to begin selecting the outcomes to use to generate a segmentation scheme.

B. Selecting the Segmentation Attributes

In an implementation, only outcomes that explain differences in what customer's value are included in the clustering process. For example, segments can be created by clustering only with outcomes that are important to some user and unimportant to others. Identifying these outcomes can be achieved by using a statistical analysis in which outcomes are analyzed for variance and kurtosis. Variance is a measure of dispersion around the mean. Outcomes with a high variance, indicate responses were obtained on both the high and low ends of the scale. A low kurtosis (i.e. less than zero) indicates little grouping which means a significant number of customers have responded differently. In one implementation, an engine could select only the outcomes with a high variance and low kurtosis for use in generating the segmentation scheme, though in other implementations some other selection could be made.

C. Creating and Selecting a Solution

The clustering process begins using the selected outcomes as the basis for segmenting. A common clustering algorithm is used which focuses on the ratings given to the selected outcomes and places the respondents into a predetermined number of segments based on their responses. For example, where a three segment solution is desired, the respondents are placed into one of three segments (e.g. first segment found outcomes a, b and g important and unsatisfied, second segment found outcomes c, e and h important and unsatisfied, and third segment found outcomes d, f, l and j important and unsatisfied). Their placement is based, for example, on the importance and satisfaction ratings given to each of the selected outcomes. Accordingly, users or respondents who rated the outcomes similarly were placed in the same segment. The clustering algorithm determines the grouping which does the best job of explaining the differences in the way the respondents valued the segmentation attributes (selected outcomes).

When performing cluster analysis, it is not known in advance which solution will work best so multiple solution can be run and analyzed. A meaningful segmentation scheme has a significant numbers of respondents falling into each of the segments, though, such is not considered limiting.

Additionally, the outcome based segments can also be considered segments of opportunity. The numerical value used to segment the respondents is not necessarily the importance they placed on each outcome. Rather it was a calculated “opportunity score” based on both the outcome's importance and satisfaction rating. The formula can be stated as follows: opportunity score=[importance+(importance−satisfaction)]. This formula quantifies which outcomes are most important and least satisfied. The result of this algorithm can be used as the segmentation variable, so that the segments created are comprised of outcomes representing significant opportunity for improvement. This also improves the effectiveness of the market strategy built around the outcome based segments.

D. Profiling the Solution

To better understand the segments, the segments can be profiled by, for example, applying descriptors to them. Descriptors can include, but is not limited to, demographic information, respondents ages, job titles, industry classifications, frequency of use of the product or service, geographic location, etc. This information can be obtained by seeking such information in the survey, questionnaire, etc. given to the respondents. Thus, certain similar descriptors may be found to be common among the respondents of a specific segment.

Using the two-way radio as an Example, Segment 1 (valued privacy and security related outcomes)—from the descriptors it was learned that the respondents conducted covert operations from inside a vehicle, had representation across several traditional industry classifications, consisted of younger users and had a higher concentration of users around urban areas. Segment 2 (relied on their radios when involved in life-threatening situation)-descriptors showed that respondents were mainly firefighters, police and security personnel that leave their vehicles to perform assignments, but must maintain vehicle contact at all times. Segment 3 revealed that the respondents were comprised of coast guard personnel, locomotive engineers and other users that rely on radio communication throughout the day to carry out their job functions.

1. Applying the Results

In addition to providing new market insights outcome-based segmentation can also provide a company or individual with information they need to discover and size emerging markets, build product portfolios, identify market entry points for disruptive technology and create outcome based-brands.

a. Identifying High-Potential Growth Markets

Outcome-based segmentation permits one to identify and size a market from a non-financial perspective. Traditional financial measures show when a new market has emerged. However, outcome-based segmentation shows that a potential growth market exists and will emerge once a viable product or service is brought to market. Outcome-based segmentation shows that products have not yet been created to satisfy the important, unsatisfied outcomes of the users within each of these segments. Thus, each segment represents a high-potential growth market.

b. Building a Valued Product Portfolio

When building a product or service portfolio, it is beneficial to a company to know which outcomes are valued across the market and which are valued uniquely with specific segments of the market. With this knowledge, which is provided by outcome-based segmentation, a company is able to create a product “platform” that includes features and functions with universal appeal. From there the company is able to build upon this platform to create products that include additional features uniquely valued by users in each of the targeted segments. Thus, the company is able to create products that deliver significant value and reduce time to market, as they include only valued features. Users received, use and pay for only those features they value. Thus, from the customer's standpoint, the product is more attractive, easier to use and less expensive, which contributes to higher levels of satisfaction.

Accordingly, outcome-based segmentation provides knowledge of what customers value and what made them different, which permits a company to prioritize which outcomes offer the greatest opportunities across the market and within each segment. With this information, a company can devise and deliver products that satisfy important customer outcomes. Thus, the company can align their thinking and resources with the customer's perception of value to devise a radically different and effective market and product strategy.

c. Discovering Market Entry Points for Disruptive Technology

A technology can be considered disruptive when it has a dramatic impact on the satisfaction of outcomes that are uniquely valued by a specific segment of the population but fails to satisfy outcomes that are important to the mainstream. A disruptive technology can often enter a market in a non-threatening manner, gaining little initial acceptance and outright rejection in the mainstream. As the technology improves, it begins to better satisfy the outcomes that are important to the mainstream and gains acceptance in a larger population, which disrupts the market as a whole. A technology successfully disrupts a market where a sizable segment of the population values the outcomes initially improved by the technology. Where the segment does not exist, the technology will struggle to mature because its development will be difficult to financially sustain.

Outcome-based segmentation allows a company to determine if market entry points exist for new and disruptive technologies and allows informs a company where to disrupt and if the company itself can be disrupted by others. Outcome-based segmentation enables a company to identify what outcomes are uniquely valued by various segments of the market, determine the size of the segments and quantify the importance of each outcome in the mainstream market.

d. Creating Outcome-Based Brands

An outcome-based brand is a product or product line that has successfully satisfied a number of important and previously unsatisfied outcomes and bares a name that signifies this achievement. Brands founded as such can posses a strength that cannot be matched. Outcome-based segmentation helps companies discover opportunities for outcome-based branding, as it uncovers segments of users that share the need to satisfy certain outcomes. Positioning statements and brand names can be established to reflect a company's understanding of a market and the intent of its product.

### IV. DEFINING THE DESIRED COMPETITIVE POSITION

A desired competitive position is a unique and valued position a company desires to achieve relative to its competitors. The desired competitive position can be unique from other competitors and valued by the affected customers. To define a competitive position, target values can be set for each of the high priority predictive metrics. The predictive metrics can be directly related to what customer's value and predict the delivery of value. The target values define the level of value that at least should be generated by any proposed strategy or solution. Competitors can also be benchmarked to determine the level of value they generate for each predictive metric. With this information a unique competitive position may be defined. The objective is to define target values that will force the creation of more value in the areas that are most important to the company's customer.

As mentioned above, the predictive metrics can be prioritized based upon the importance and satisfaction values that were chosen or inputted for each of the desired outcomes, as well as from the relationships that exist between the predictive metrics and desired outcomes. In an implementation, matrix analysis is used to prioritize the metrics in the order that best predicts the achievement of the desired outcomes. The prioritization process can be executed automatically, using, for example, a Normalized Importance algorithm that is part of or integral to the software. Thus, the prioritized metrics define the order in which value can be created most efficiently. As also mentioned above, often the top 30% of the metrics often predict that up to 70% of the desired outcomes will be satisfied to some degree. The discovery of the top metrics directs a company where to focus it time, money and other resources for the satisfaction of its important desired outcomes.

The desired competitive position can be defined before alternative strategies and solutions are created and evaluated. A proposed solution should be eliminated or modified if it does not allow a company to achieve its desired competitive position. A desired competitive position is achieved by inputting, perhaps with the company's assistance, a target value for each of the top metrics. A target value can be determined by conducting competitive analysis by benchmarking their current solutions and their competitors' current solutions. A worksheet can be used to document the values achieved by the company and its competitors. With this information, to ensure the chosen concept will be better than a competitive concept along a specific metric, the target values are set to exceed those that have been achieved by competitive concepts. Concepts can be created that meet or exceed the target values. The ultimate target value denotes a target value that will deliver tremendous value to the company. This value can be later used to evaluate the potential of different concepts.

Some advantages: (1) a method for defining the desired competitive position prior to defining the strategy or solution that is required to achieve it; (2) a method for systematically determining, in a measurable and predictable way, how to achieve a competitive position that is both unique and valued; and (3) a method for systematically defining the strategy or solution that will enable a company to achieve a desired competitive position that it seeks to occupy.

### V. DEFINING FEATURES

As mentioned above, the metrics that predict the delivery of value can be known and can be listed in priority order on a screen, for example, in a spreadsheet format. Features can be defined for each of the high priority metrics. The defining of the features increases the probability that a solution created from the combination of the features will enable the achievement of the stated mission. Thus, the features become the initial components that are combined and modified to form the final solution. The features can be combined in various ways to create alternative solutions and ultimately the optimal solution.

The features can be mutually exclusive. In an implementation, only one mutually exclusive feature is included in a solution, rather than multiple features that are stated for one metric. However, a feature can consist of a combination of other features. Exclusivity helps in prioritizing the features in a later chosen concept. Thus, a method for defining features that can be considered when formulating a strategy or solution is provided. The features can be focused on the creation of value. For example, the features can be defined for metrics that are prioritized in the order in which they most efficiently predict the creation and delivery of value.

### VI. CREATING CONCEPTS

Often a company does not have a concept in mind or may want to create new or detailed concepts. To create a concept, the predictive metrics can be presented, for example one at a time and in priority order, so that the company, user, individual, etc. (collectively referred to as “company” throughout the disclosure) can define or select the features that they would like to include in a specific concept to address the metric. Thus, the company can create a strategy or solution by combining the features that are likely to create value and score well in a concept evaluation exercise. Thus, the concepts are created around the metrics that predict the delivery of value.

The software can also be used to generate a list of potentially optimal concepts. Where appropriate data for defining the features has been entered the list can be generated. Available optimizations can include definition of a concept whose features best deliver: (1) Ultimate Performance—combination of Features that come closest to delivering the Ultimate Target Value specified for each Metric; (2) Desired Performance—combination of Features that come closest to delivering the Desired Target Value specified for each Metric; (3) Minimize Cost—combination of Features that results in the lowest total concept cost; (4) Minimize Effort—combination of Features that result in the concept that is least expensive to develop; (5) Minimize Risk—combination of Features that result in the concept that involves the least technical risk; (6) Ultimate or Desired Performance, Minimize Cost, Effort, or Risk—combination of Features that result in a concept that maximizes the appropriate type of performance while minimizing either Cost, Effort or Risk; and (7) Maximize Ultimate or Desired Performance Within Specified Limits—allows the automatic generation of multiple (e.g., 5 or so) different concepts that will deliver the best possible Ultimate or Desired performance within the Cost, Effort, and Risk limitations that are specified.

At this point, the target values are known that must be achieved for each metric in order to create a valued solution and the features are selected or defined that will enable the known target values to be achieved. Prior to evaluation, it may be desirable to document multiple concepts (e.g., 3).

In an implementation, the user enters the name of each concept to be evaluated at the designated location on the screen. A detailed description for the concept can also be entered. If specific features are not going to be selected from the feature list, a brief description for the concept becomes more important. The aspects or features of the concept that will contribute value should also be entered.

The concepts can also be created from the list of features that have been previously defined. Again, the concept is first given a name. The features to be included are then selected. In an implementation, starting with the highest priority metric, the desired feature defined for such metric to be included for the concept is selected. A feature not included in the list can also be included by entering such feature at the designated location on the screen and/or selecting such added feature once entered. The process is repeated for the next highest priority metric and so on. Features can be selected that address the top metrics, rather than features that address the metrics with a low normalized importance (NI) value. Thus, features can be defined for metrics who's cumulative NI is between approximately 50 and 60. A NI counter, which can also appear on the screen, can be used to determine the number of metrics to address.

It may be desirable to include only mutually exclusive features (i.e. competing features not permitted). In one implementation, only one feature per metric is selected. However, a feature for a metric can consist of a combination of other features. It may also be desirable to validate that the features and concepts that are defined honor the stated constraints and that the basis functions of the solution are in control and capable.

The software commands (software algorithms) build the Concepts using performance, cost, effort, and risk ratings specified for each Feature. Ultimate Performance is calculated by adding up the Ultimate Performance rating of each Feature included in the Concept. The Concept with the best Ultimate Performance is then created. This approach can also be used for developing the best Desired Performance, Minimum Cost and Minimum Effort Concepts. To develop the Minimum Risk Concept, the Risk rating for such Concept is the worst Risk rating of any Feature included in the Concept, since it is the “weak link” in the Concept.

The Ultimate Performance, Minimum Cost Concept can be similarly generated by identifying the Feature for each Predictive Metric that delivers the most Ultimate Performance for the least Cost. These Features can then be combined into the Concept. This same approach can be used for each of the similar commands. When generating Optimal Concept within specified Cost, Effort or Risk Limits, the software examines feasible combinations of Features and picks several (e.g., 5) that yield the maximum performance without violating any specified Cost, Effort or Risk limits. If no Concepts are feasible within the specified limits, the software can indicate as much. Accordingly, a method for automatically defining the strategy or solution that will deliver the most value in a specific situation, given any combination of cost, effort and risk is provided.

### VII. SELECT EVALUATION METHOD

At least two different concept evaluation methods can be available: (1) evaluating concepts against other concepts and (2) evaluating concepts against a standard. With method (1), alternative solutions can be evaluated by comparing all potential solutions against a “baseline” concept. The baseline concept assists in determining the strengths and weaknesses of each concept. Other potential concepts can be compared against the baseline concept. The baseline concept can also be change for future evaluations, which helps to obtain a better discrimination between similar concepts. In an implementation, as the baseline is changed for additional evaluations, they can be automatically saved by the software as separate evaluation files for review on a screen such as a “Review Evaluation Results” screen. Evaluation method (1) can be used when there are a fixed number of alternatives, when other alternatives cannot be created or when the concepts are not well detailed.

With method (2), alternative solutions can be evaluated by determining the degree to which each solution drives each metric toward its ultimate target value. Method (2) determines the value of each concept relative to a theoretically perfect concept. Method (2) can be used when the concepts are well detailed or when attempting to determine the degree to which the concepts create value. Method (2) also determines where improvements should be made to an existing concept.

For each evaluation method the number of predictive metrics that are included in the analysis can be changed. It is not necessary to include all of the predictive metrics in the analysis and the low priority metrics can be perhaps excluded. A default can be set at 50% of the desired outcomes, which would select the number of metrics necessary to predict satisfaction of 50% of the desired outcomes. Other applicable desired outcome values and/or default values (above and below 50%) can be selected.

To begin evaluation, one of the evaluation methods is chosen on the screen. Where method (1) is selected, a baseline concept must also be selected or entered. The baseline concept may be the concept that is believed to best meet the target values established for each of the top predictive metrics. With either method, the percentage of desired outcomes whose satisfaction will be predicted is then selected or entered. Once the selections have been made, evaluation can be initiated by selecting the appropriate button or section on the screen.

### VIII. EVALUATE CONCEPTS AGAINST A BASELINE

This method determines if each concept under evaluation is better, worse or the same as the baseline concept at driving each predictive metric toward its direction of improvement. The rating can be, for example, under an objective standard to provide more accurate results and also provide the opportunity to create better concepts. Each concept should also honor any documented constraints and deliver basic functions. If a concept does not, than the concept should be modified, the constraint modified or the concept excluded as an option. It may be desirable to select a small team of individuals representing different areas of a company for the evaluation process. Each predictive metric, the concept is evaluated for a better, worse or same rating as compared to the baseline concept. Thus, a method is provided for manually evaluating a potential strategy or solution, quantifying its ability to drive the metrics that predict the creation and delivery of value.

### IX. EVALUATE CONCEPTS AGAINST A STANDARD

This method determines the degree to which each concept will drive each predictive metric toward its ultimate target value. Each proposed concept should preferably drive each metric toward its ultimate target value to some degree. Also, each concept should also honor any documented constraints and deliver basic functions. If a concept does not, than the concept should be modified, the constraint modified or the concept excluded as an option. It may be desirable to select a small team of individuals representing different areas of a company for the evaluation process. Each predictive metric the concept is evaluated for its ability to drive each predictive metric toward its ultimate target value. Documented concepts can be evaluated against each metric. A scale (e.g. 1 to 10), can be used. Thus, another method is provided for manually evaluating a potential strategy or solution, quantifying its ability to drive the metrics that predict the creation and delivery of value.

### X. REVIEW EVALUATION RESULTS

A. Evaluating Against A Baseline

The results of the evaluation can be presented in the form of four numerical scores: (1) positive score, (2) negative score, (3) concept score and (4) projected score. The positive score represents the percent of desired outcomes that are better satisfied by a concept versus the baseline concept. The negative score represents the percent of desired outcomes that are better satisfied by the baseline concept. The concept score is the difference between the positive score and the negative score. A concept score of “X” can means that “X”% of the desired outcomes (in total) are better satisfied by the concept than by the baseline concept. Negative concept scores are also possible. For example, if only “X” % (e.g. 30%) of the metrics are included in the evaluation, then the concept score cannot exceed “X” (e.g. 30).

The Projected Score restates the concept score as a percent of the metrics that are used in the evaluation. Where a concept score is 24 and 30% of the metrics are used in the evaluation, the projected score is 80 ((24×100)/30). This score is useful in approximating what the concept score would be if all of the metrics were used in the evaluation.

With this information, to create the desired optimal strategy or solution, the negative elements can be eliminated from the best concept to further improve the concept. An “Improve Concept” section/feature can be provided in the software for this purpose.

The same concepts can also be re-evaluated using a different baseline or different evaluation method. In an implementation, evaluation results can be retained and can be accessed from the screen, such as an Evaluate Concepts screen. New concepts can be added and evaluated as the baseline concept is changed.

B. Evaluating Against A Standard

The results of the evaluation can be presented in the form of two numerical scores: (1) concept score and (2) score against selected metrics. The concept score can be interpreted as the degree to which a concept drives the predictive metrics toward their ultimate target values or the degree to which the concept under evaluation approaches the theoretically perfect solution. The scores can range from, for example, 0 to 100. A concept score of “X”, means that the proposed solution evolves the product, service, process or subject of interest to “X”% of its fully evolved position. A concept score of 100 means that the concept drives every metric to its ultimate target value.

Similar to the above, a Projected Score restates the concept score as percent of the metrics that are used in the evaluation. Also similar to the above, weaknesses in the best concept can be eliminated to improve the concept. The same concepts can also be re-evaluated as required. New concepts can be added and evaluated as required.

Accordingly, both evaluations techniques provide a method for reviewing the results of evaluations that are made between alternative strategies and solutions.

### XI. DETAILED EVALUATION RESULTS

When viewing the detailed results of an evaluation completed against a baseline, the metrics used in the evaluation can be presented and how the NI value affected the score for each metric can also be presented. When a concept is better than the baseline concept for a specific metric, then the NI value for that metric can be shown as being a positive value and is added to that concept's score. When the concepts are the same, for example, a zero is shown and the score is not affected. When the concept is worse than the baseline concept for the specific metric, the NI value for that metric is shown as being negative and is subtracted from that concept's score.

When viewing the detailed results of an evaluation completed against a standard, the metrics used in the evaluation can be presented, the ratings given to each metric for each concept can be presented and the NI value for each metric can be presented. The rating that is shown for each metric can be calculated by taking the rating value given to the concept for a metric, dividing it by “10” and multiplying it by the NI value for that metric. The number “10” is chosen, as it represents the highest rating value obtainable. If a different number is chosen for the highest rating value, then such different number would be the number used for the division. This calculation can be automatically executed for all of the metrics by the software. The Concept Score is the sum of these calculations. A concept score of 100 represents a fully evolved solution.

To review the detailed results, a screen can be accessed, such as by clicking a “Detail” button on the Review Evaluation Results screen. Alternatively or additionally, the screen could be accessed by double clicking on the concept for which more detail is desired. Thus, a method for reviewing the results of evaluations that are made between alternative strategies and solutions is provided.

### XII. PRIORITIZE FEATURES

Once a concept has been chosen for implementation, it can be beneficial to determine which features within the chosen concept are contributing the most value. The analysis uncovers the features that contribute the least amount of incremental value while consuming a disproportionate share of resource, time and/or money. Conversely, it identifies the features that contribute the most value for the least cost, risk and effort.

The analysis begins by selecting the desired concept. Each feature is evaluated against each of the top predictive metrics in order to determine if the feature will impact the predictive metric and the degree to which the metric will be driven toward its direction of improvement. A team of individuals, such as several employees of the company, can be organized for the analysis.

In an implementation, the analysis begins with the first feature and first metric. It is determined whether the feature impacts the metric. If not, the next feature is analyzed and so on. Where a feature does predict that a metric will be driven toward its target value, a numerical answer (score), such as from a scale of 1 to 9, is given. Thus, the following questions can be asked in the analysis: (1) Does this feature impact this metric? and (2) To what degree does this feature predict that this metric will be driven toward its target value?

After, each feature has been analyzed for the first metric, the features are then analyzed for the next metric. The analysis can be continued, for example, until all features are evaluated against all metrics. Once this portion of the evaluation is complete, it will be known which features are generating the most value. The second part of the analysis evaluates how much cost, risk and effort is associated with each feature.

To begin this part, a relative cost value is assigned to each feature, for example using a numerical scale (e.g. 1 to 2, with 0.1 increments). In an implementation, the process continues until all features have been assigned an appropriate cost value. A similar rating process can be used for assigning a relative “risk” value to each feature. Likewise, a similar rating process can be used for assigning a relative “effort” value to each feature.

A Feasibility Score for a feature can be calculated by using the NI algorithm dividing that score by each of the values that were inputted or entered for cost, risk and effort for the feature. The Feasibility Score indicates which features will deliver the most value for the least cost, risk and effort. Again, some features can (e.g. ones having the lowest Feasibility Score) can be eliminated from the concept at this point. Thus, the value that each feature in a strategy or solution is contributing to the overall strategy is prioritized.

### XIII. DEPLOY FEATURES

Once the concept is defined, the valued features must be created, designed, tested and/or integrated into the overall concept. The features can be assigned to the individuals who are responsible for implementation of the concept. A screen, such as a Deploy Features screen in a spreadsheet format, can be provided to assist in deployment of the feature(s) and initiate project management activities. Required actions, target dates for completion and other pertinent items can be entered and the information can be used to track progress of the implementation. Thus, the features can be deployed in a strategy to the individuals responsible for implementing and managing the implementation of the strategy.

### XIV. DEPLOY METRICS

The actions that are taken to implement the chosen strategy or solution can be tied directly to the creation of value. As mentioned above, a prioritized list of the predictive metrics can define the most efficient approach to the creation of value. Thus, the metrics can be used as the basis for deploying or implementing the chosen strategy or solution. Deployment of the metrics is particularly useful over deployment of features when a concept's features are not defined or when the mission is dealing with a non-physical entity.

A screen, such as a Deploy Metrics screen set up in a spreadsheet format, can be provided to assist in the assignment of specific activities that aid in the effective implementation of the chosen strategy or solution. High priority predictive metrics can be assigned, for example, to specific individuals, who may be held responsible for the evolution of the metrics to their ultimate target values. Target values, actions and completion dates can be entered and used by the company (i.e. company's management) to drive the effective implementation of the chosen strategy or solution. Thus, work activities can be deployed so that employee rewards can be tied directly to the creation of customer value.

### XV. RE-INVENTING INNOVATION

Innovation is defined as the process of creating new and significant customer value. The process begins when a market is targeted or a problem is defined. The process is completed when a solution or concept is devised that will deliver significant additional value. Thus the innovation process can consist of the following three steps: (1) define the criteria customers use to judge value; (2) define ideas and solutions that will potentially meet these criteria; and (3) determine which ideas and solutions deliver the most value. Executing this process requires that combinations of ideas and solutions be defined and evaluated for their ability to meet the numerous criteria customers use to judge value.

A. Measures of Value

Customers typically evaluate a product or service from multiple perspectives. (i.e. performance, cost, appearance, usability, ease of installation, packaging, etc.). Unfortunately, not all customers use the same criteria. However, customers collectively use a finite and manageable number of criteria to judge value in any given market. Often, customers or other individuals (i.e. internal stakeholders) (collectively referred to throughout as “customers”) use between approximately 80 to 100 criteria to judge value of a specific product or service. However, this number is not considered limiting. Once the criteria are captured, they represent all the measures of value for the market. The criteria use are real, obtainable and inherently describe a measure of value. This same criteria can also be used to judge value over a period of years, to give a company a long-term roadmap against which to focus its thinking, strategy and actions.

The criteria used to judge value are not tied to a particular technology or solution. Rather, they are tied to what a solution will enable customers to achieve. What the customers desire often remains constant over time. What does change over time is the degree to which each of the criteria is satisfied by new, more advanced devices or services.

New technologies and solutions are created over time in an attempt to better satisfy the collective set of criteria customers use to judge value, with the ultimate goal being the complete satisfaction of each criteria. Accordingly, it is important to capture the collective set of criteria.

B. Prioritizing the Measures of Value

Certain criteria are more important to some customers than others. Similarly, not all customers judge a product's value exactly the same way. Thus, even though they may use the same criteria, their judgments are based on what criteria they believe to be most important and their level of satisfaction. Each customer orders the criteria differently and judges the value of a product or service accordingly. However, there are “segments” of customers which are groups of customers that judge value in a similar fashion. For any given market, customer groups may fit nicely into a set number of segments (i.e. 3 segments, segments, etc.). Each segment can include a homogeneous population that, for example, judge value in the same way. As mentioned above, the segments can be uncovered using the measures of value as the basis for segmenting the market.

To determine the order of the criteria for each segment, the importance of the criteria and the degree to which it is currently satisfied must be obtained and quantified through market research. An opportunity algorithm (importance+[importance−satisfaction]) can be used to prioritize the criteria. The calculation accurately orders the criteria and identifies which criteria are most important and least satisfied (i.e. points out where the customer is looking for improvements). The order of these criteria represents opportunities for improvement at a point in time. As new products and technologies are introduced into the market, new areas of opportunity emerge, as the opportunity for creating new value migrates from one criterion to another. Thus, as one important criterion becomes more satisfied, other unsatisfied criteria of equal importance become the greatest opportunities for improvement and the new targets for value creation. Accordingly, the opportunities for improvement represent a roadmap along which a product or service is to evolve.

C. Quantifying the Value of a Concept

When a company captures all of the measures of value, it becomes possible to measure the value generated by an overall product or service. A concept's value is determined by the degree to which it satisfies all the criteria customers used to judge it's worth. If a solution satisfies all the criteria to the greatest possible degree, it delivers 100% of the value desired by customers and its numerical value can be denoted as “100”. If a solution fails to satisfy any criteria to any degree, it delivers 0% of the desired value.

A calculation is performed to quantify the amount of value delivered by the solution. The calculation involves two factors: (1) the weighting of the criterion and (2) position along the continuum. These factors signify the degree to which the solution satisfies the criteria. The weighting is simply the opportunity score for each criteria weighted into a column totaling 100%, which denotes that all measures of value are included. The concept rating is the degree to which the solution satisfies the criteria (i.e. its position along the continuum), which can be stated on a scale. The scale can range from 1 to with meaning the criteria is fully satisfied (i.e. fully evolved along the continuum). Other applicable numerical values could be used for the scale. In one embodiment, the ratings can be provided by a small team of individuals who are intimately familiar with the concept and who are able to give the rating objectively. However, other applicable individual(s) or groups can be used.

The amount of value delivered along each criterion is calculated by multiplying the weighting of each criterion by the concept satisfaction rating. The results calculated for each criterion are summed up to obtain an overall concept score, which can indicate the percentage amount a evaluated concept delivers of all the value desired by customers in the particular segment of a market. The ability to quantify value on an absolute scale makes it possible to determine the value of any solution and to identify the winners and losers. This includes products and services already in development, those being sold by a company and its competitors and those that are in the conceptualization stage.

Applying the ability to quantify value to products and services already in development, permits a company to determine how much incremental value its new products will deliver over those already on the market. When applied to products and services already being served by a company and its competitors, a company is able to accurately identify and quantify its competitive position. It is also able to determine the strengths and weaknesses of each competing solution. When applied to a proposed product, technology or solution, a company can effectively predict the likely success or failure of an idea or proposed initiative at the conceptual stage and perhaps well before the first dollar is spent of development. Thus, the company is provided with the information to permit it to pursue only those concepts that deliver significant incremental value and avoid those that do not (i.e. dramatically reducing the risk of failure).

D. Generating Valued Concepts

By focusing creativity where needed and measuring the value of a proposed solution, companies can systematically create product and service solutions that deliver significant value. With a high percentage (i.e. 96%, though not considered limiting) of the criteria used to judge vale listed in priority order, a solution can be created that satisfies the most important criteria to the greatest degree. This approach consistently produces the best results.

E. Generating Valuable Intellectual Property

Understanding how value is defined and measured in a market and formulating ideas that address these measures of value can be keys to successful generation of valuable Intellectual Property (IP). With knowledge of the key areas of opportunity in a market, a company is able to focus its creative efforts and generate IP of significant market value. A focus at the outcome level can give a company broader protection and insight into dimensions of the market that competitors are unlikely to have addressed.

Focusing on the top areas of opportunity, ideas can be generated and prioritized based on their quantified value contribution. Once the initial set of ideas is generated, literature searches can be conducted to identify redundant ideas and related patents currently issued to other companies. This knowledge, causes some ideas to be eliminated and new ideas to be generated. The ideas that survive the filtering process can be ranked for their ability to deliver value. The amount of value they generate can be quantified using the methods discussed above. With this information, patents were only filed on ideas which clearly quantified the market value of the IP.

Accordingly, creativity is a specific important aspect of the innovation process. The ability to focus creativity on important, unsatisfied criteria presents new opportunities to those who leverage such knowledge, resulting in a long-term competitive advantage in the market place.

F. Automating the Process of Innovation

As shown above, the innovation process involves evaluating combinations of defined ideas for their ability to meet the numerous criteria customers use to judge value. Companies are attempting to find which combination of features best satisfies the criteria, given the order in which they are prioritized. Three pieces of information are needed for solving this equation: (1) the criteria customers use to judge value, (2) ideas that contribute to the satisfaction of those criteria, and (3) a quantification of the degree to which each idea satisfies each criterion. With this information the optimal solution can be found by systematically determining which combination of features satisfy the prioritized criteria to the greatest degree. A set of algorithms can be provided, in the form of computer software, to make this determination. Thus a company can generate the best solution for any given market segment, eliminating guesswork and time consuming research.

In this outcome-based paradigm, companies can be provided with the criteria customers use to judge value in priority order so they can qualify the value of any solution. Segments of the customer population can also prioritize the criteria so that segment-specific concepts can be created. The algorithms can identify which combination of features deliver the most value in each segment. Features that are common to many, if not all, segments, can be used for defining a platform for the product or service.

Features unique to each segment can also be identified. With this information, a company can devise a market and product strategy that focuses first on the development of features that are valued across the market to effectively improve their competitive position in each segment. Next the company can target the segment that requires the least number of additional features to gain a valued competitive position in that segment as well. A targeting strategy can also be defined for the other segments using this same method.

Each feature within each segment can be given a rating for cost, effort and risk to determine which features deliver the most value for the least cost. This helps a company not exceed a desired price point for a product or service. Where the price point is exceeded, a company can eliminate the costly features that deliver the least value. A company can also use the information to determine which features create the most value for the least effort so they can decide which features to drop from the product or service in the event that resources were constrained. The information also tells a company which features create the most value in a given segment, so that the company knows with certainty which features to pursue and where to make trade-offs. Accordingly, with the capability to quickly test new concepts, companies are encouraged to test dozens of concepts and determine which will ultimately fail. As the determination is made prior to implementation of the concept the company does not incur the cost of the failure, nor does it waste time in pursuit of the concept. Accordingly, outcome-based paradigm permits the innovation process to be not only faster but also enables a company to control the outputs and transform innovation into a manageable and predictable discipline.

Summarizing the above, described techniques provide methodologies that capture customer input focusing on outcomes, not solutions. The methodology gathers data in a way that reveals what the customer is trying to achieve in using a product or service.

G. Implementing an Outcome-Based Solution

The following steps can be implemented for execution of the methodology for providing outcome-based solutions: (1) develop a different style of customer interview, (2) conduct the interviews, (3) organize the data, (4) rate the outcomes, and (5) use the information to spur innovation.

1. Planning Outcome-Based Customer Interviews

A successful outcome-based customer interview must deconstruct, step by step, the underlying process or activity associated with the product or service. Once the process is defined, the customers who will participate should be selected. Interviewees can be narrowed to specific groups of people directly involved with the product or service.

Though not considered limiting, interviewees can include customers who can judge the value of the product from a user standpoint and/or from a cost perspective. It may be desirable to select the most diverse set of individuals within each customer type. The more diverse the group, the more complete the set of unique outcomes that are captured.

2. Capturing Desired Outcomes

Capturing desired outcomes can be performed by a moderator who can distinguish between outcomes and solutions and who can filter out or eliminate vague statements, anecdotes, and other irrelevant comments. The moderator can also clarify and validate statements made by customers and also confirm that the participants considered every aspect of the process or activity they go through when using a product or service. When a participant a “solution”-type response, the moderator can redirect the original question to force the participant to consider the underlying process.

The interview process often begins with the participants providing statements or adjectives (“statement” or “statements”) in the form of loosely stated ideas or solutions. These statements can offer a starting point for capturing outcomes. After capturing some of these statements and/or adjectives, the moderator can translate each one into a desired outcome. A well-formatted outcome can contain both the type of improvement (e.g. minimize, increase, etc.) and a unit of measure (e.g. time, number, frequency, etc.) so that the outcome statement can be used later in benchmarking, competitive analysis, and concept evaluation. In an implementation, the moderator addresses one statement at a time, rephrasing it to be free from solutions (i.e. words that inherently describe specifications or constraints) and/or free from ambiguities (e.g. words such as easy, reliable, comfortable, etc.). The moderator can confirm the translations with the participants to eliminate guesswork after the interview ends. More than one session with the participants may be necessary to capture the desired or certain percentage of the desired outcomes.

3. Organizing the Outcomes

Once the interviews are complete, a comprehensive list of the collected outcomes can be made, which removes duplicates and categorizes the outcomes into groups that correspond to each step in the process. This list also begins to inform a company on how its customers measure value.

4. Rating Outcomes for Importance and Satisfaction

Once the categorized list of outcomes has been created, a quantitative survey can be conduct where desired outcomes are rated by different types of customers. Survey participants can be asked to rate each outcome in terms of its importance and the degree to which the outcome is currently satisfied. Survey participants can rate each outcome in terms of its importance and the degree to which the outcome is currently satisfied. The ratings can be fed into a mathematical formula or algorithm, for example provided in the form of computer software, which reveals the relative attractiveness of each opportunity.

The best opportunities for the company can be determined from those desired outcomes that are important to customers but are not satisfied by existing products and/or services. The formula used is “opportunity=importance+(importance−satisfaction)”. As mentioned above, customers can quantify on a scale (e.g. 1 to 10) the importance of each desired outcome and the degree to which it is currently satisfied. The rankings can be inserted into the formula, resulting in an overall opportunity score. The amount in parentheses for the formula can be made such that it is never less than zero. Thus, high level of satisfaction do not detract from importance and helps to maintain integrity for the formula. Often, users in different segments of the market rate outcomes with varying levels of importance and satisfaction, resulting in a different opportunity prioritization for each segment. These differences can form an important foundation for product or service strategy. A company can identify and prioritize opportunities across a total market and within various segments. The outcomes can receive a unique opportunity score in each segment and allow a company to focus its research and development efforts on the opportunities with the highest opportunities scores in each segment.

The desired outcomes can be shown in priority order of weighted importance. As mentioned above, the weighted importance is calculated as a percent of each outcome's value as it relates to the sum of the values of all the outcomes. This calculation is based on the importance and satisfaction value given to each desired outcome, the prioritization calculation that was selected on a Select Target Segment screen, the weighting of the customer type and the number of desired outcomes that are associated with each customer type. The resulting number may also be referred to as percent importance.

The desired outcomes presented can be universal to all individuals having an interest in a specific mission. What differs from individual to individual is the importance they place on each desired outcome and the degree to which they perceive each outcome to be satisfied. The optimal strategies can differ from situation to situation given the importance and satisfaction levels that are given to each desired outcome in that specific situation.

5. Using the Outcomes to Jump-Start Innovation

The data obtained is used to uncover opportunity areas for product or service development, market segmentation, and better competitive analysis. The data can also be used to formulate concepts and to evaluate the potential of alternative concepts. The outcomes that customers deem the most important and that were least satisfied typically represent the greatest opportunity areas. Those of lesser important and that were reasonably well satisfied by existing products and/or services are often not worth pursuing. The information may also allow a company to understand a “natural order” of segmentation in the relevant market. The interview data can also be used to define the company's desired competitive position. Target values for areas of opportunity can also be defined from the information to give a company a competitive position that is unique from its competitors and valued by its customers. With the target values in place, a framework for concept generation is provided. The company can evaluate numerous product or service concepts to determine the degree to which each satisfies each outcome.

Accordingly, understanding what customers value is preferable as compared than merely asking them to submit their own solutions. The process of innovation begins with identifying the outcomes customers want to achieve and ends in the creation of items or services they will purchase. When desired outcomes become the focus of customer research, innovation can be a manageable, predictable discipline.

### XVI. REPORT GENERATOR

As seen in FIG. 24, a report generator, referred to as a Report Wizard in FIG. 24, can be provided. The Report Wizard makes it convenient to analyze customer, competitive and market data and can also provide numerous reports for evaluations that have been made and stored. Thus, access to hundreds of reports or more can be provided that present different view of customer, competitor and market data. The reports can enable users to: (1) identify areas of opportunity; (2) identify unique segment needs; (3) view competitor strengths; (4) identify segment differences; (5) identify important outcomes; and (6) obtain other market insights. Each report can be printed or pasted (copied) into various applications, including, but not limited to, Microsoft Excel, PowerPoint, Word, etc. The Report Wizard can also guide the user through the selection process, where multiple selections can be made.

Based on the known importance and satisfaction level of each outcome, the software determines which outcomes are most important and least satisfied, prioritizing the areas of opportunity. The prioritized information can be provided in the form of a report. The Report Wizard can also provide access to dozens of additional reports that show the results of concept evaluations stored within a database or library by the software. With one or more evaluations completed, the Report Wizard allows a user to review concept definitions, evaluation criteria and evaluation results. With the Features Database activated or engaged, the software permits the user to optimize concepts at specific price points and perform other functions.

Reports in the software can be grouped into two separate categories: (1) Research Data and (2) Project Data. Research Data reports present information that is directly related to a mission. This data is packaged with a mission and can be delivered following the completion of a study. Project Data reports present information that is specifically related to a particular project. This data may only be available once individual projects have been created.

Research Data reports can include, but are not limited to, the following: (1) segment comparisons, (2) competitive analysis, (3) areas of opportunity, (4) unique outcomes, (5) important outcomes, (6) satisfied outcomes, (7) gap analysis, and (8) raw research data. Project data reports can include, but are not limited to, the following: (1) project properties, (2) basic function, (3) constraints, (4) competitive position, (5) features database, (6) concept definitions, (7) customer evaluation criteria, (8) evaluation results, (9) feature prioritization, and (10) synergy (prioritized).

The Project Properties report can provide basic information for a particular project such as its base mission, prioritization method, actual and default customer set weighting, and selected target segments. The Basic Functions report can generate a list of all basic functions and their associated descriptions for each customer set of a project. The Constraints report can generate a list of all constraints and their associated descriptions for a project. The Competitive Position report can present the desired competitive position for all Predictive Metrics across all Customer Sets in a project. This data can be sorted by the Normalized Importance of each Metric, and can include Ultimate Target Value, Target Value, and Competitors' values. The Concept Definitions report can provide the name, description, concept statistics, and included features by metric for a particular concept of a project. The Concept Weaknesses report can be a comprehensive list of all concepts within a project, with their respective descriptions, scores and weakness analyses. The Desired Outcomes report can generate a list of the desired outcomes and their corresponding descriptions for selected Customer Sets. The Metrics Report can generate a list of the predictive metrics and their corresponding descriptions for selected Customer Sets.

The Unprioritized Synergy report can describe the synergistic relationship between the Desired Outcomes and Predictive Metrics for selected Customer Sets. This report can consist of a matrix, with all the Desired Outcomes presented in rows, and the Predictive Metrics presented in columns. The synergy that an Outcome has to its corresponding Metric can be represented as a 9, whereas the remaining Outcome-Metric relationships can have other numeric (or null) relationships as defined by the mission. The Prioritized Synergy report can describe the synergistic relationship between the Desired Outcomes and Predictive Metrics for selected Customer Sets. This report can consist of a matrix, with all the Desired Outcomes presented in rows, and the Predictive Metrics presented in columns. The synergy that an Outcome has to its corresponding Metric can be represented as a 9, whereas the remaining Outcome-Metric relationships can have other numeric (or null) relationships as defined by the mission. This report can be presented in Prioritized mode, with the Outcomes and Metrics in order of Weighted Importance and Normalized Importance, respectively.

The Target Segments report generates a list of all target segments and their associated descriptions for each customer set of a mission. Two reports can be available from within the Features Database report category: (1) Features by Metric and (2) Features by Metric by Customer Set. The Features by Metric report can generate a list of all Features that have been defined for each Predictive Metric. The Ultimate Target Value Rating, Cost, Effort and Risk can be provided for each Feature. The Features by Metric by Customer Set report can generate a list of all Features for the Predictive Metrics associated with selected Customer Sets. The description and mission-level indicator can be provided for each Feature. The Feature Prioritization Report can generate a list of all Features for a concept in order of the selected Feature Prioritization Method.

The Customer Evaluation Criteria report can generate a list of all Desired Outcomes or Predictive Metrics for a project using a selected prioritization method. Several reports are available from within the Competitive Analysis report category, including, but not limited to: (1) competitor comparison, (2) areas of opportunity (for competitors) and (3) analyze individual competitor. It is often desirable to compare one competitor against another to determine areas where Desired Outcomes are satisfied better by one Competitor versus another, and recognize the reasons for this advantage. It is also often desirable to determine the priority order of the Desired Outcomes for competitors. The Areas of Opportunity report can present the Desired Outcomes with a competitor's Importance and Satisfaction data, prioritized using the Opportunity calculation method (software algorithm) described above. The Individual Competitor report can present a competitor's Desired Outcome satisfaction data for selected customer sets for which data has been collected. This satisfaction data can be compared to satisfaction data for the Total Market segment.

Several types of reports can be available from within the Evaluation Results report category, including, but not limited to: (1) concepts evaluated against a baseline, (2) concepts evaluated against a standard, (3) software and user generated concepts, (4) evaluation rating rationale, and (5) concept weaknesses. The Concepts Evaluated Against a Baseline report can generate Summary and Detailed reports of ratings from an evaluation against a baseline concept. The Concepts Evaluated Against a Standard report can generate Summary and Detailed reports of ratings from evaluations against a standard. The Software and User Generated Concepts report can generate Summary and Detailed reports of all concepts that contain features defined in the Features Database. The Value Achieved, Value Potential, Projected Score, Cost, Effort, Risk and Revised Score can be shown, and can be based on the additive effect of all features contained within each concept. The Evaluation Rating Rationale report can lists the Predictive Metrics, ratings and rationales given for a selected concept within an Evaluation Set.

Several types of reports can be available from within the Raw Research Data report category, including, but not limited to: (1) desired outcomes, (2) predictive metrics, (3) importance and satisfaction, (4) target segments, and (5) synergy (unprioritized). It is often desirable to determine the priority order of the desired outcomes and predictive metrics for various segments. The Areas of Opportunity report can present a segment's outcomes or metrics with the associated Importance and Satisfaction data, prioritized using the Opportunity calculation method (described above).

It is often desirable to determine the priority order of the desired outcomes and predictive metrics for various segments. The Unique Outcomes report can present a segment's outcomes or metrics with the associated Importance and Satisfaction data, prioritized using the Unique calculation method. It is also often desirable to determine the priority order of the desired outcomes and predictive metrics for various segments. The Important Outcomes report can present a segment's outcomes or metrics with the associated Importance and Satisfaction data, prioritized using the Importance calculation method. It is again often desirable to determine the priority order of the desired outcomes for various segments. The Satisfied Outcomes report can present a segment's outcomes with the associated Satisfaction data, prioritized using the Satisfaction calculation method. It is often desirable to determine the priority order of the desired outcomes and predictive metrics for various segments. The Gap Analysis report can present a segment's outcomes or metrics with the associated Importance and Satisfaction data, prioritized using the Gap calculation method. It is also often desirable to determine how the desired outcome importance and satisfaction ratings differ from segment to segment. This information can be used to determine what desired outcomes are more important or satisfied in one segment than another, to understand what makes segments different, or to determine if areas of opportunity in one segment are different than those in another segment. It may also be desirable to determine how the priority order of the predictive metrics differs from segment to segment. This information is useful in determining how different metrics predict the delivery of value in different segments. Segment comparisons can be made for both desired outcomes and predictive metrics using desired outcome importance, satisfaction and opportunity as the basis for the comparison. When comparing Desired Outcomes, comparisons may also be made using Satisfaction and Gap as the basis for comparison.

### XVII. VIRTUAL LABORATORY

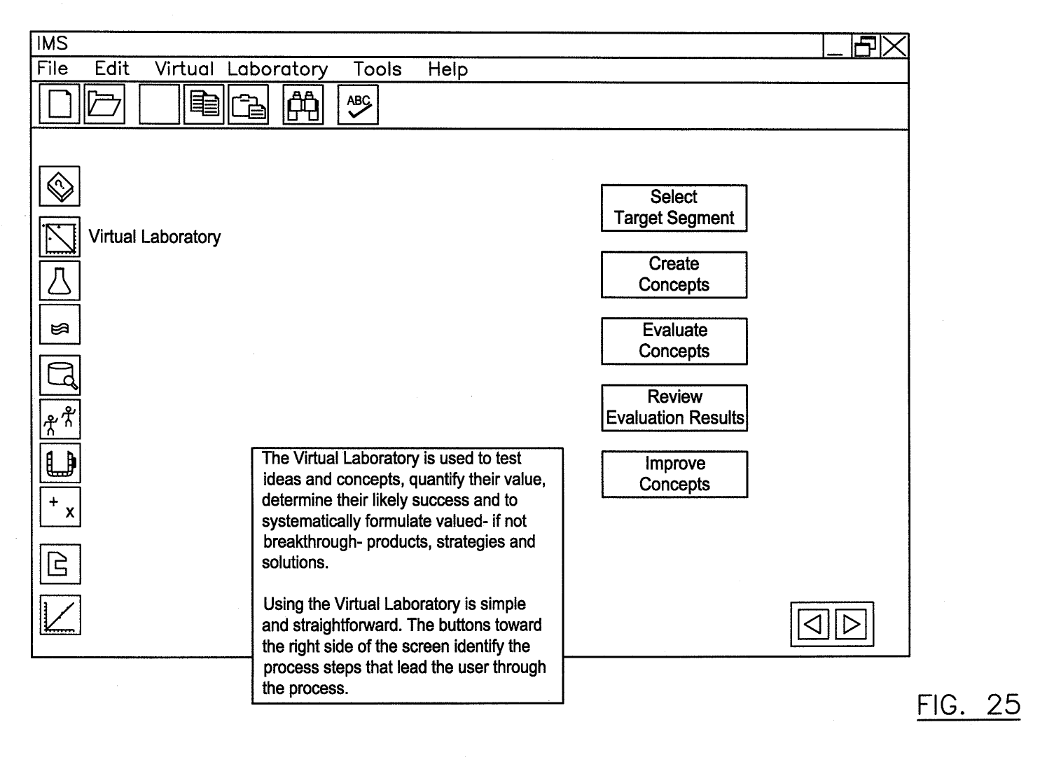

As seen in FIG. 25, the software can also provide screens (Virtual Laboratory) for testing ideas and concepts, quantifying their value, determining their likely success and to systematically formulate valued products, services strategies and solutions. Certain features or steps can include (1) select target segment, (2) create concepts, (3) evaluate concepts, (4) review evaluation results and (5) improve concepts.

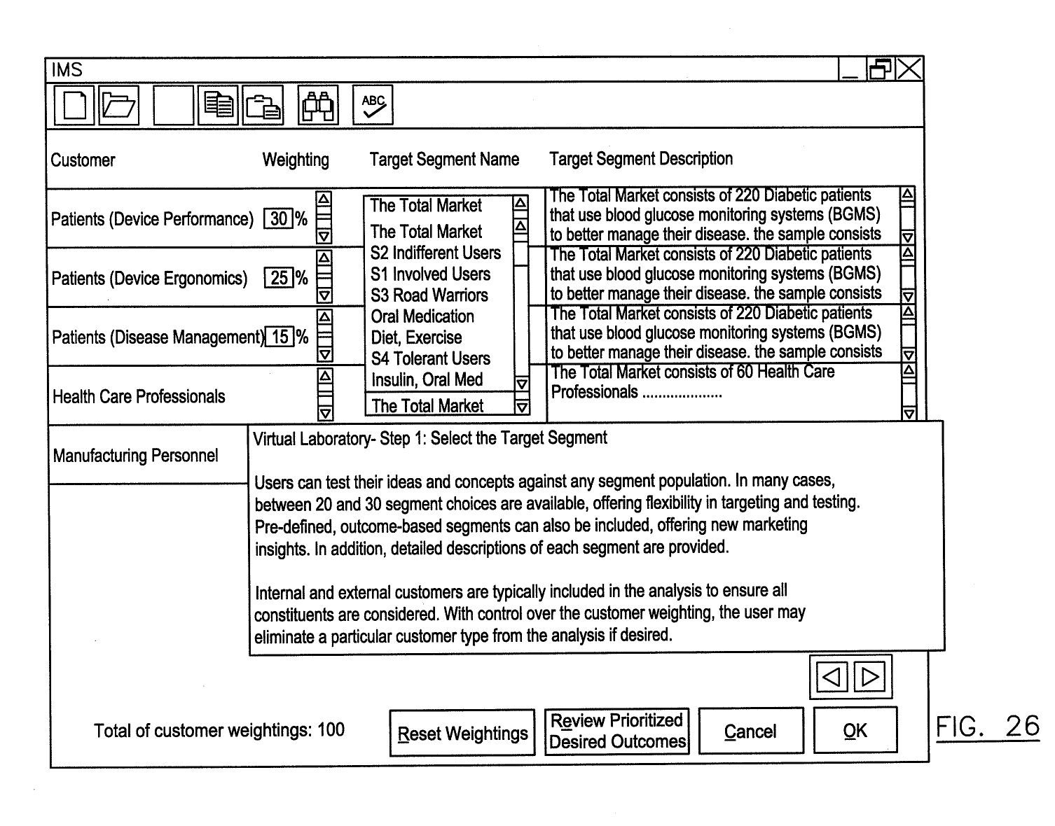

At the screen (FIG. 26) associated with step (1) users can test their ideas and concepts against any segment population. Any number (e.g. to 30) of segment choices can be available, to offer flexibility in targeting and testing. Define, outcome-based segments can also be included to offer new market insights. Detailed descriptions of each segment can also be provided. In an implementation, internal and external customers can be included in the analysis to ensure all constituents are considered. The user is provided with control over the customer weighting and may eliminate a particular customer type from the analysis if desired.

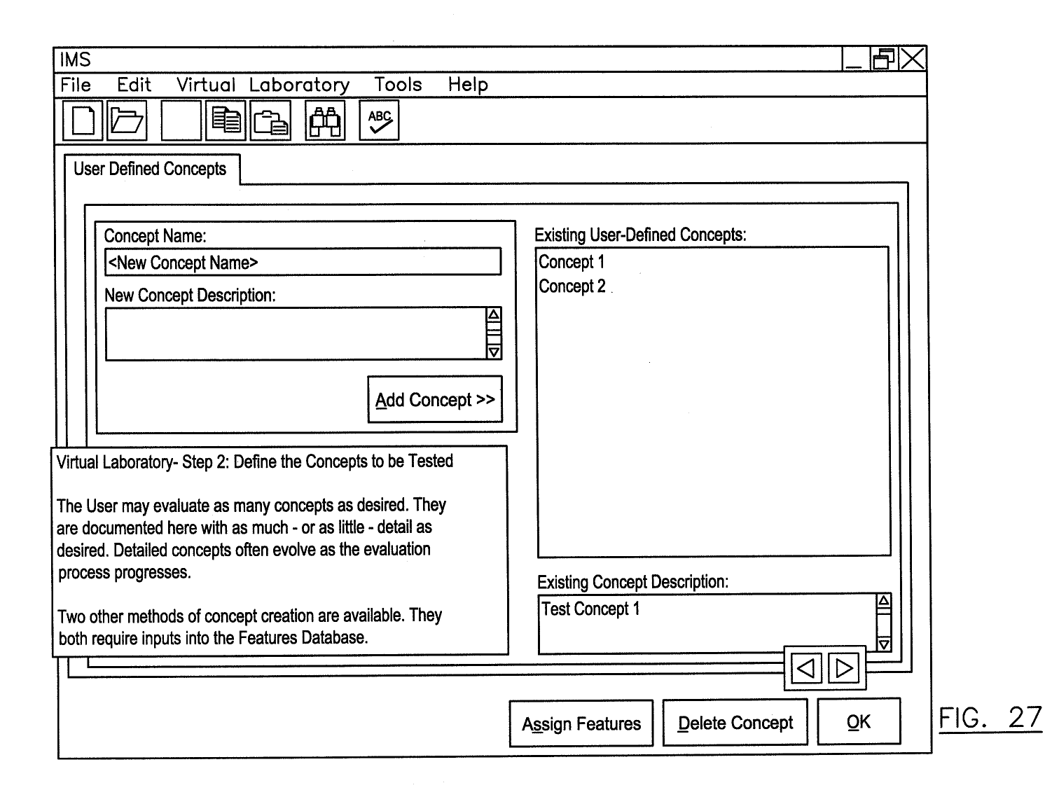

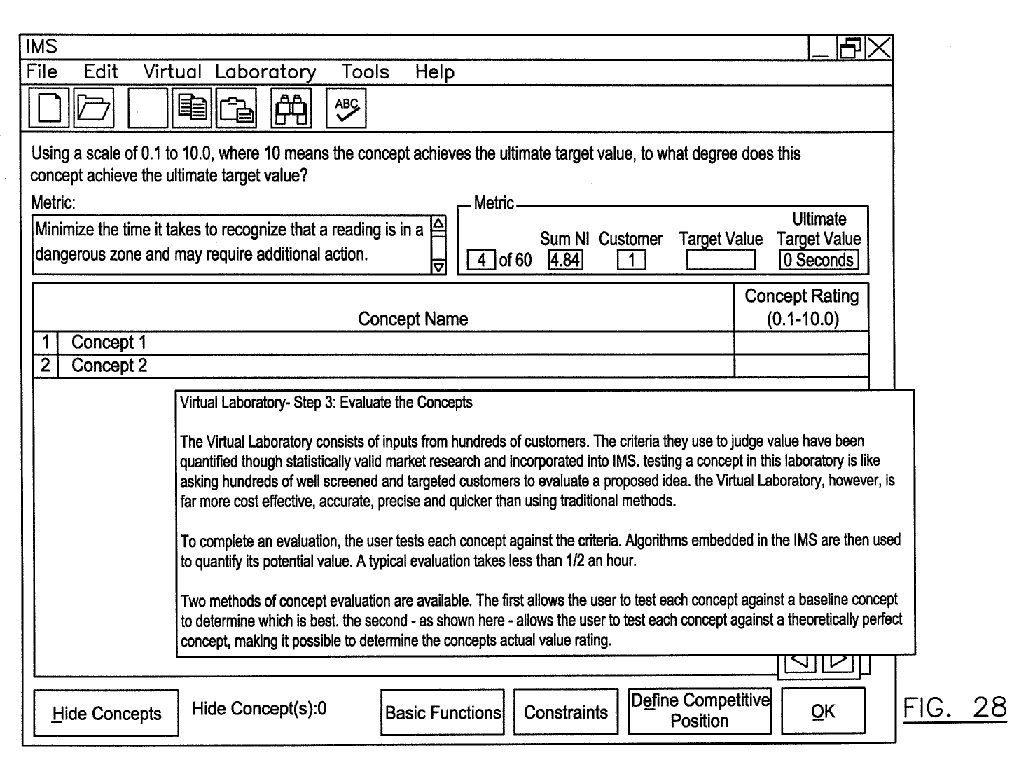

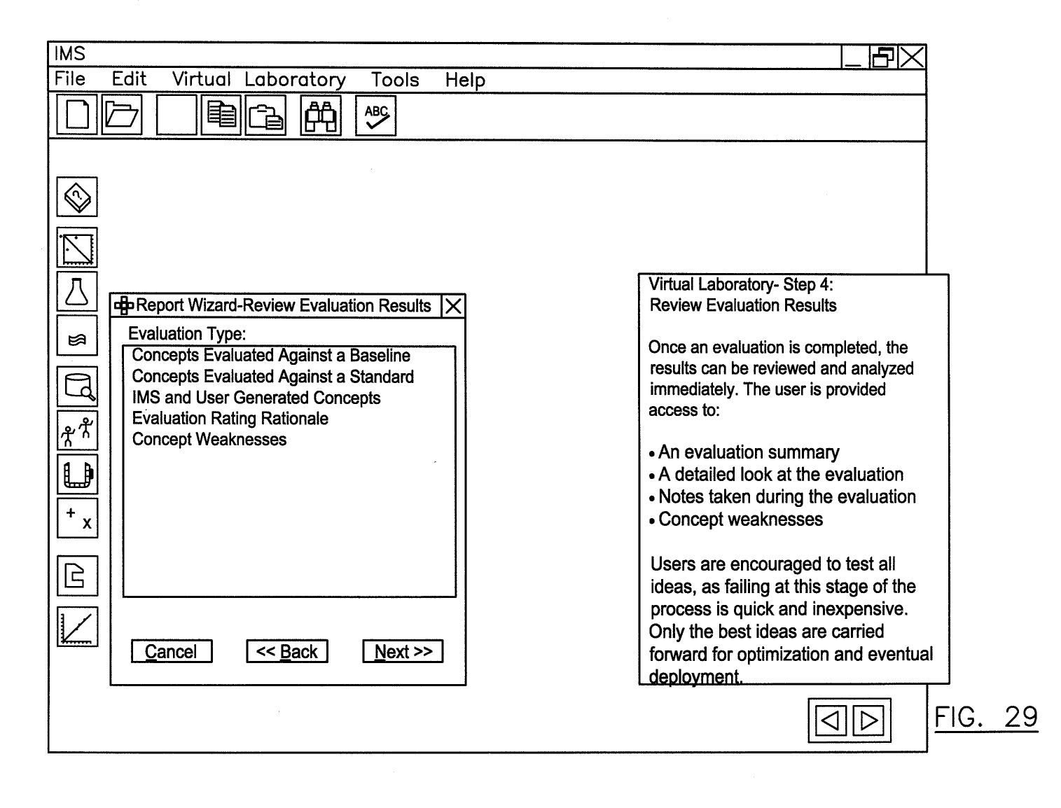

At the screen (FIG. 27) associated with step (2) users may evaluate as many concepts as desired. The concepts can be documents with as much or little detail as desired. The detailed concepts can evolve as the evaluation process progresses.

At the screen (FIG. 28) associated with step (3) the concepts are evaluated. The Virtual Laboratory can consist of inputs from hundreds of customers. The criteria the use to judge value can be quantified through statistically valid market research and incorporated into the software. To complete an evaluation, the user tests each concept against the criteria. Algorithms embedded in the software are used to quantify its potential value. As mentioned above, two methods of concept can be provided: (1) the user test each concept against a baseline concept to determine which is best and (2) the test each concept against a theoretically perfect concept, making it possible to determine the concepts actual value rating.

At the screen (FIG. 29) associated with step (4) the evaluation results can be reviewed. Once an evaluation is completed, the software can permit the results to be reviewed and analyzed immediately by the user. The user can be provided access to an evaluation summary, a detailed look at the evaluation, notes taken during the evaluation and/or concept weaknesses. The user can test ideas and carry forward the best ideas for optimization and possible deployment.

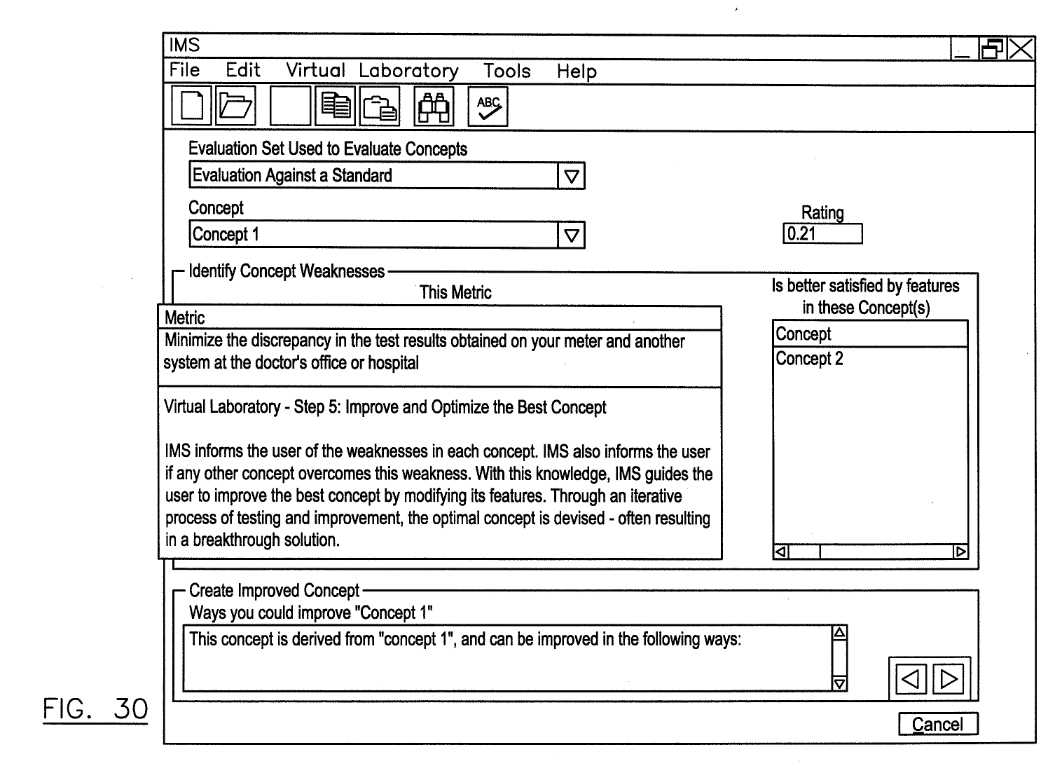

As seen at the screen (FIG. 30) associated with step (5), the software can inform the user of the weaknesses in each concept. The software can also inform the user if any other concept overcomes the weakness. With this knowledge, the software can guide the user to improve the best concept by modifying its features. Thus, through an iterative process of testing and improvement, an optimal concept can be devised, which often results in a breakthrough solution.

The theory behind inventive problem solving can also be included to help users to overcome physical, chemical and mechanical design conflicts. Numerous principles can be provided and listed, for example, in the order in which they are most frequently applied, along with conflict resolution tables and other tools which may be needed to help overcome design conflicts. These principles help in brainstorming breakthrough solutions and are proven in one or more industries and are often applied successfully in others.

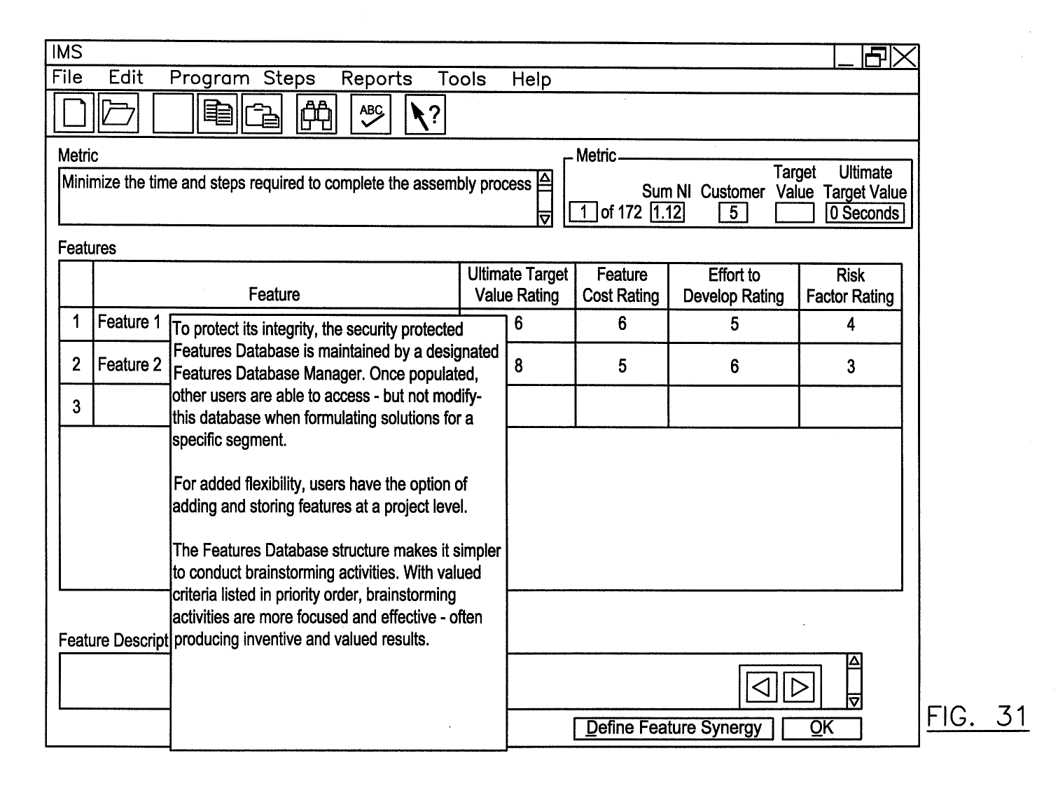

As seen at the screen used for the Features Database (FIG. 31), the database stores, catalogs, and organizes ideas, features and potential solutions gathered from customers, employees and others. The database can be an inventory of ideas gathered and maintained over time. Populating the database makes it possible to automate the concept creation process so the optimal solutions for any segment can be always known. The database can be security protected to protect its integrity and maintained by a designated individual. Once populated, others may access, though they may or may not be able to modify, the database when formulating solutions for a specific segment. For added flexibility, users can be provided with the option of adding and storing features at a project level. Valued criteria can be listed in priority order to provide for more focused and effective brainstorming activities. The database can be structured to help solve what can be referred to as an Innovation Equation.

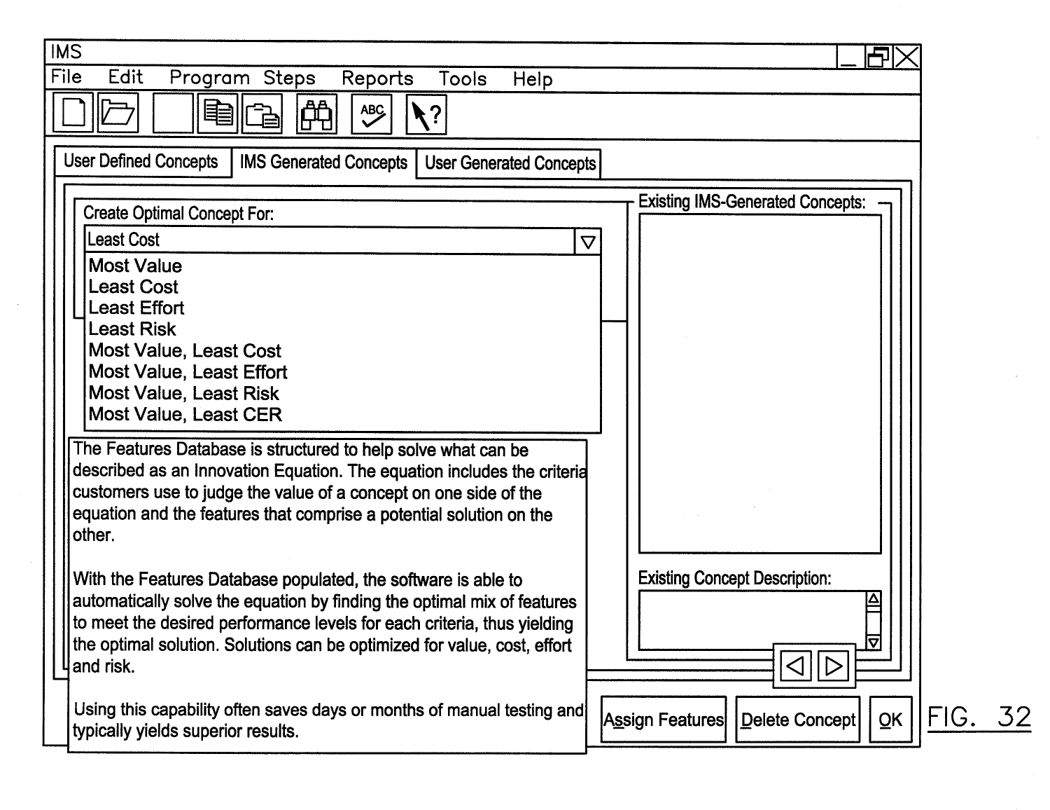

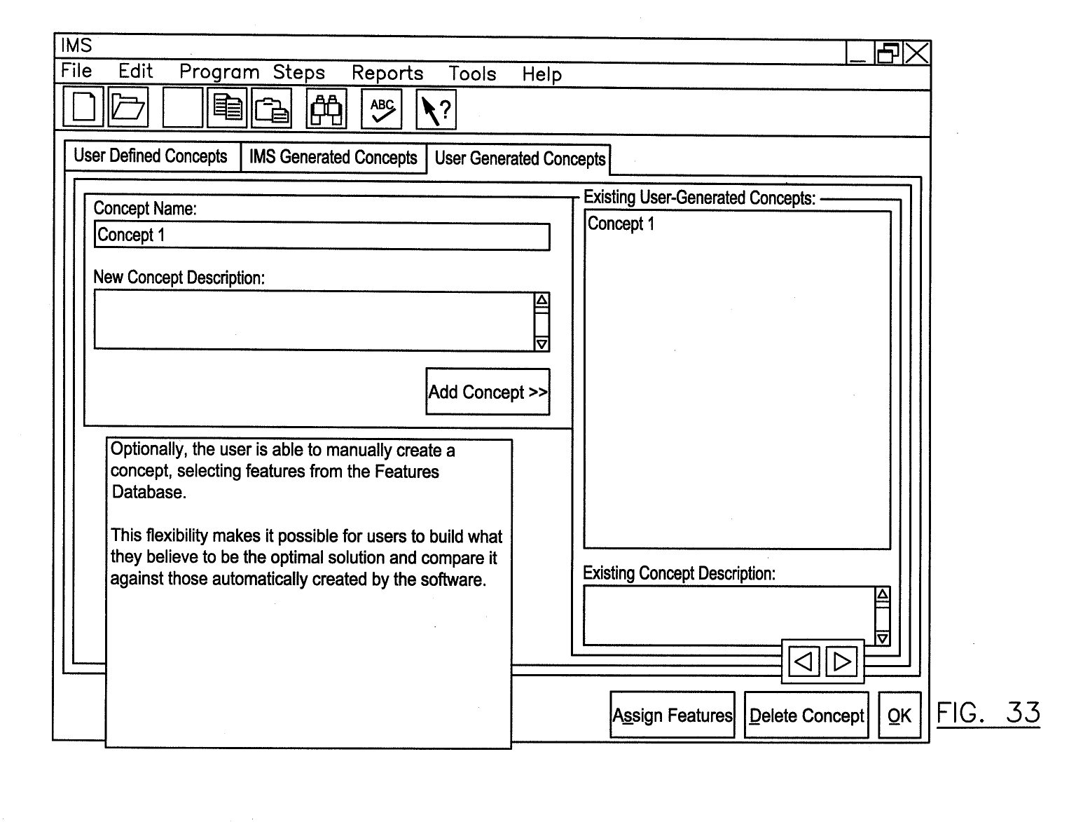

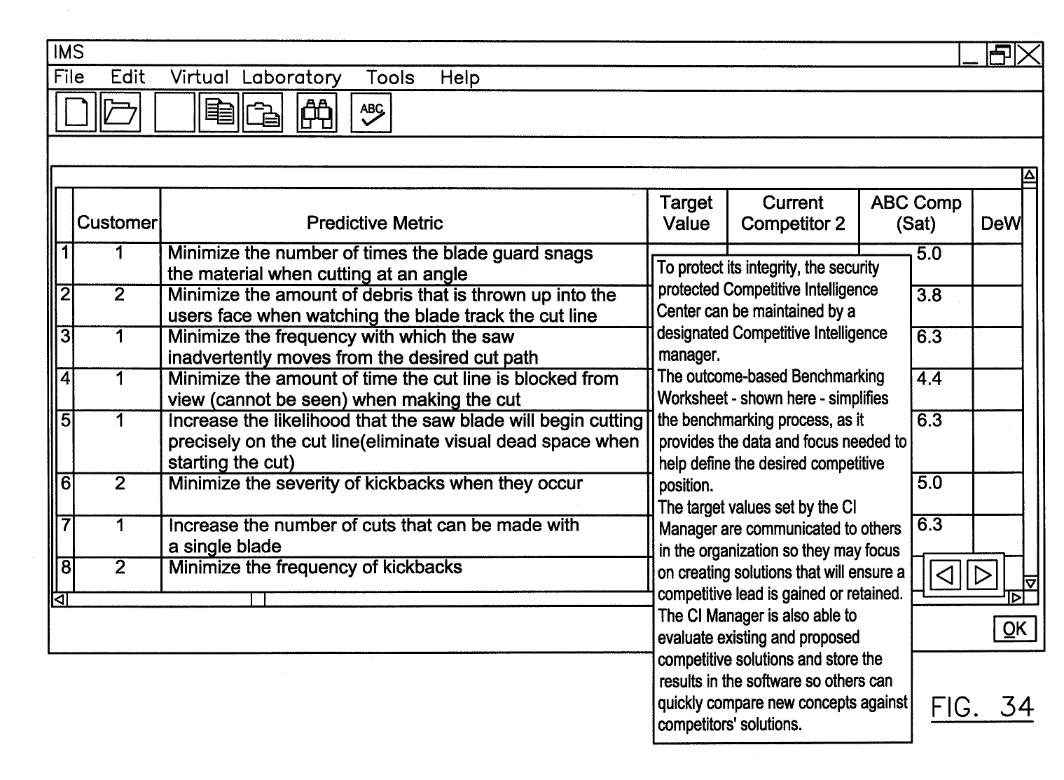

This Equation can include the criteria customers use to judge the value of a concept on one side of the equation and the features that comprise a potential solution on the other. When the Features Database is populated, in an implementation, the software solves the equation automatically by finding the optimal mix of features to meet the desired performance levels for each criteria, thus, yielding the optimal solution. As mentioned above, solutions can be optimized for value, cost, effort, risk, etc. (See FIG. 32). The user can also manually create a concept, selecting features from the Features Database (See FIG. 33). This allows the user to build what they believe to be the optimal solution and compare it against those automatically created by the software.

An area of the software can be devoted for competitive analysis. This area can be referred to as the Competitive Intelligence Center and provides data and tools used to conduct competitive analysis, benchmark competitors, set target values that will yield the desired competitive position and test competitive concepts. The information can also be communicated to others in the organization by the software. This portion of the software can be security protected to protect its integrity and can be maintained by a designated individual. As seen in FIG. 34, an outcome-based benchmarking worksheet (screen) can be provided, which provides the data and focus needed to help define the desired competitive position.

The set target values can be communicated to others in the company so they may focus on creating solutions that will ensure a competitive lead is gained or retained. The designated individual is permitted to evaluate existing and proposed competitive solutions and store the results in the software so others can quickly compare new concepts against competitor's solutions.

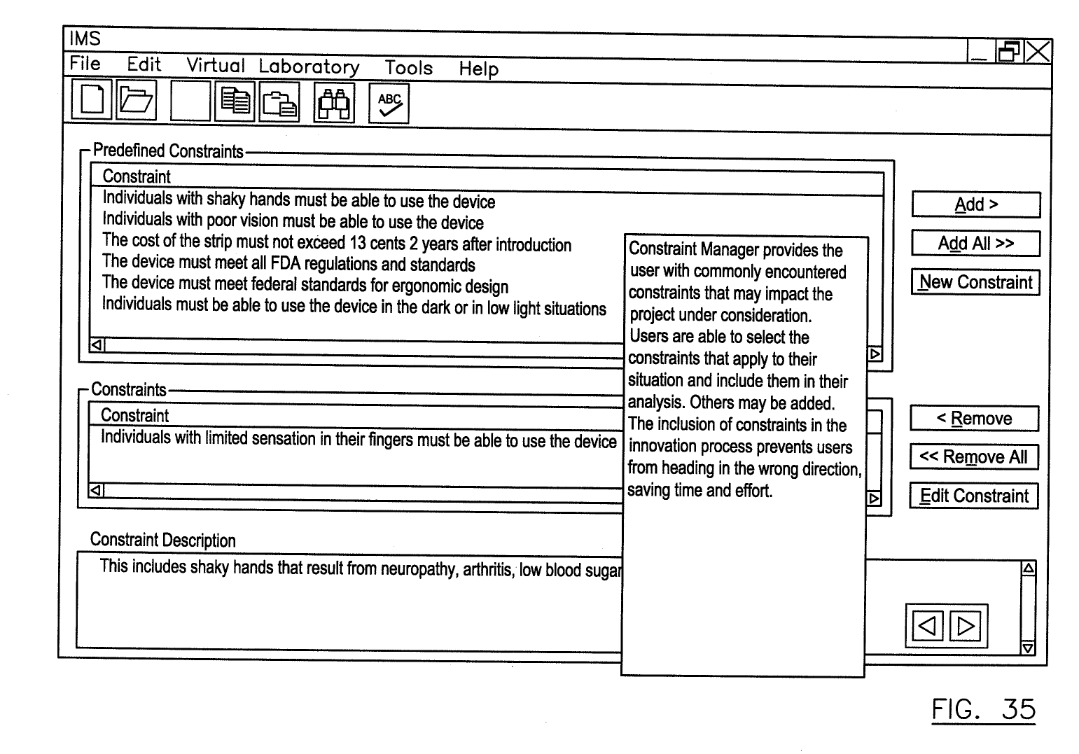

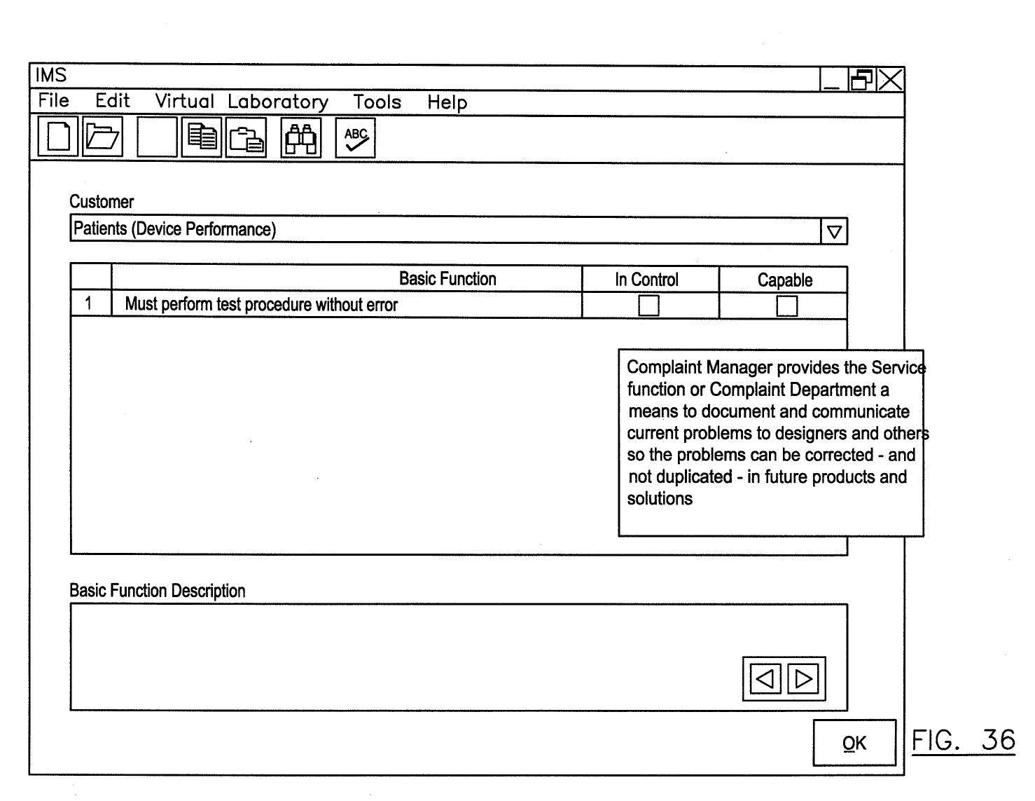

As seen in FIG. 35, a Constraint Manager screen can be provided as a way to capture and communicate internal and external constraints imposed on potential solutions. This information can be integrated into the concept creation process to ensure proposed solutions honor or comply with the stated constraints. The Constraint Manager screen can provide the user with commonly encountered constraints that may impact the project under consideration. Users can select the constraints that apply to their situation and include such constraints in their analysis. Other constraints can be added. The inclusion of constraints in the innovation process helps to prevent users from heading in the wrong direction, thus, saving time and effort.

As seen in FIG. 36, a Complaint Manager screen can be provided as way to capture complaints and overlooked basic functions defined by service personnel and communicate such information to engineers and others for consideration in future concepts. Thus, current problems can be documented and communicated so that such problems can be corrected and not duplicated in future problems and solutions.

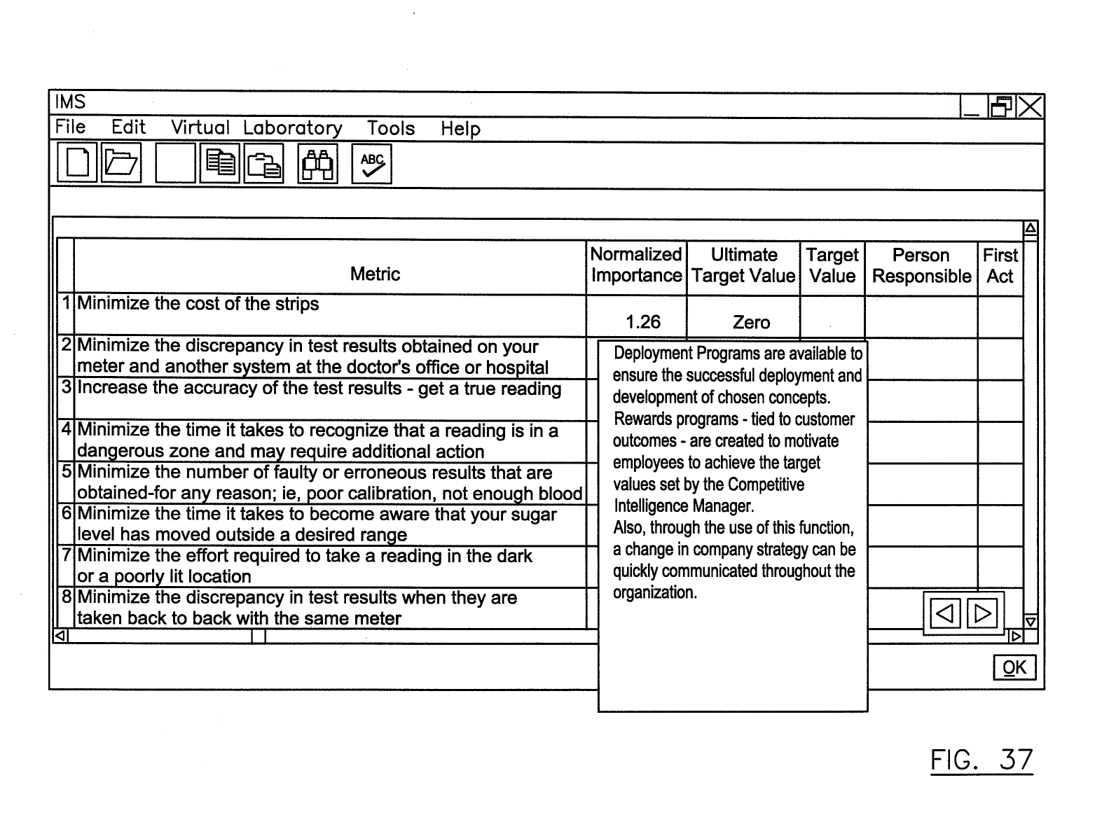

As seen in FIG. 37, Deployment programs can be created for the concepts chosen for deployment. The plans can be created at the concept or metric level. The Deployment Programs help to ensure the successful deployment and development of chosen concepts. Reward programs, perhaps tied to customer outcomes, can also be created to motivate employees to achieve the target values set, for example, by the designated individual overseeing the Competitive Intelligence Center. The Deployment Program portion of the software also permits the company to quickly communicate a change in company strategy throughout the organization.

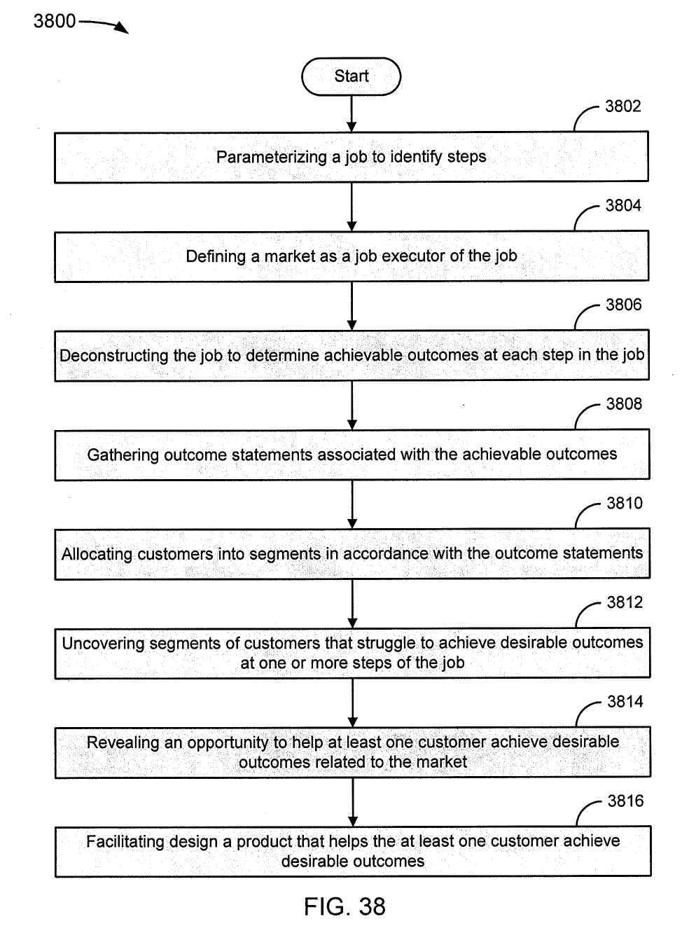

FIG. 38 depicts a flowchart 3800 of an example of a method for obtaining desirable product-specific outcomes. In the example of FIG. 38, the flowchart 3800 starts at module 3802 with parameterizing a job to identify steps. A job is a task that an actor intends to accomplish. Jobs can be associated with importance and satisfaction. An engine, such as an Outcome-Driven Innovation (ODI) engine, can parameterize jobs to identify steps when provided with the relevant data.

In the example of FIG. 38, the flowchart 3800 continues to module 3804 with defining a market as a job executor of the job. Thus, the market can be concretely defined in association with specific jobs.

In the example of FIG. 38, the flowchart 3800 continues to module 3806 with deconstructing the job to determine achievable outcomes at each step in the job. Since the market is defined in association with the jobs, the steps of each job making up the definition of the market are by definition also associated with the market. An ODI engine can deconstruct the jobs when provided with the relevant data.

In the example of FIG. 38, the flowchart 3800 continues to module 3808 with gathering outcome statements associated with the achievable outcomes. Outcome statements could be gathered from individuals involved in, or affected by, a strategy, plan, or decision, describing an important benefit that they would like to receive from the strategy, plan or decision that is being contemplated. Thus, the outcomes could be referred to as “desired” or “desirable” outcomes. Advantageously, outcome statements can be made free from solutions, specifications, and technologies, and free from vague words such as “easy” or “reliable” and are statements that are valid and stable over time.

In the example of FIG. 38, the flowchart 3800 continues to module 3810 with allocating customers into segments in accordance with the outcome statements. Segmentation is a method of finding individuals in a population that value the same desired outcomes. An ODI engine can employ, for example, a statistical technique called cluster analysis to accomplish segmentation.

In the example of FIG. 38, the flowchart 3800 continues to module 3812 with uncovering segments of customers that struggle to achieve desirable outcomes at one or more steps of the job. In this context, struggling is intended to mean that the customers cannot satisfactorily achieve the desirable outcomes, or could be more satisfied. An ODI engine can uncover segments by finding low satisfaction scores for jobs or job steps associated with the market.

In the example of FIG. 38, the flowchart 3800 continues to module 3814 with revealing an opportunity to help at least one customer achieve desirable outcomes related to the market. An ODI engine can reveal opportunities when provided the relevant data.

In the example of FIG. 38, the flowchart 3800 continues to module 3816 with facilitating design of a product that helps the at least one customer achieve desirable outcomes. This could be considered inherent in the other modules of the flowchart 3800. However, some implementations do, in fact, provide additional functionality that facilitates design, such as a virtual laboratory.

### XVIII. IMPLEMENTATION

The techniques are applicable to, but are not limited to the following: (1) to create strategies, solutions or patent portfolios and evaluate concepts; (2) evaluate two or more well-defined concepts against each other to see which is best; (3) evaluate two or more loosely-define concepts against each other, adding detail to the concept definitions as they are evaluated; (4) build a patent portfolio around opportunity metrics in a specific market segment; (5) improve a concept, with the goal of creating a breakthrough solution; (6) manually create and evaluate new concepts, selecting features from the database for key metrics; (7) automatically create and evaluate new concepts, using the database utility to build value-producing concepts; (8) assess concepts for feasibility once they have been evaluated; and (9) define the constraints imposed on a solution by the company and others.

The software can provide access to both mission-level research data, and project specific data. For these purposes, the following three primary areas can be accessible through a introductory screen such as screens referred to as: (1) Report Wizard, (2) New Project and (3) Existing Projects. When no project is open, the Report Wizard can serve to provide access to extensive information related to a mission and, in an implementation, is packaged with the installation of the software. Once a specific mission is selected, the following can be automatically retrieved for use in the strategy formulation process (1) the desired outcomes for each customer in the customer set, (2) the predictive metrics associated with each outcome, (3) the relationships between the metrics and the outcomes, (4) any available desired outcome importance and satisfaction data, and (5) any other pertinent data. After the desired mission is selected, a new window will or screen can offer a list of available reports.

When opening a project, all or various functions of the software can be made available on a screen, such as a Navigation Screen. This screen can be populated with Toolbar Functions and Virtual Lab buttons. The various functions of the software can also be available from an application Menu Functions on the screen. The toolbar buttons can be arranged in groups, based on their areas of utility. As an example, the buttons can access the following functions, though such is not considering limiting: (1) software advisor, (2) Report Wizard, (3) Virtual Laboratory, (4) TRIZ, (5) Features Database, (6) Desired Competitive Position, (7) Constraints, (8) Basic Functions, (9) Deployment, and (10) Quick View Scorecard.

A customer information screen can describe all the customers that are involved in, or affected by, the strategy, plan or decision that is being contemplated. This discipline can ensure that all the appropriate internal and external customers are considered in the strategy formulation process. A failure to include a customer could result in the rejection or failure of a strategy or solution. Where appropriate, desired outcome importance and satisfaction data may have already been gathered in a particular industry, geography, age group or logical segment classification for a specific customer. Data that is captured can be retained in a database file as part of this application. Where data from a desired target segment has been included, the user can select that segment from a drop-down box for use in the analysis rather than collecting and/or inputting new data. When the user selects a target segment, the importance and satisfaction values given to the desired outcomes by individuals in that segment can be automatically retrieved by the software and used in the process.

As mentioned above, the user can weight the importance of the customers included in the “customer set”, as it may be more important to satisfy the desired outcomes of one customer than it is to satisfy the desired outcomes of another. The user may even want to eliminate a customer entirely from the analysis, or test different scenarios. As the weighting of a customer is decreased, the criteria that can be used to evaluate solutions will contain fewer and fewer desired outcomes from that customer.

The method for prioritizing the desired outcomes can be selected from various choices including: (1) opportunity calculation, (2) importance only, and (3) dissatisfaction.

A default setting can be provided to prioritize the desired outcomes based on the respective importance values. The other two choices can also be used as the default setting. Furthermore, the user can choose to use the opportunity calculation to determine which desired outcomes are most important and least satisfied. As mentioned above, the calculation that is used to define opportunity is as follows: Opportunit=Importance Value+(Importance Value−Satisfaction Value). Although this calculation combines numbers that have different units of measure, in the final analysis, the calculation does enable the user to determine where areas of opportunity exist. The calculation determines which desired outcomes are both important and unsatisfied; two significant ingredients in uncovering areas of opportunity. When using the opportunity calculation, the major opportunities in the target segment are automatically determined and presented to the user. Another option is to prioritize the desired outcomes in the order of least satisfied to most satisfied (dissatisfaction option). The opportunity and dissatisfaction calculations may not be used if satisfaction data does not exist.

The user can also input its own importance and satisfaction data for customer sets from any of the missions. The user can also differentiate between customers within any of these customer sets by defining target segments. An objective is to obtain a statistically valid sample of data from each of these target segments. The individuals who represent the customers in the customer set can rate the importance and current satisfaction level of each of the desired outcomes that pertain to that specific customer. When conducting market research, the user can obtain a blank survey and a set of instructions by printing them out for each customer from a Print Reports screen (area) of the software. When conducting quantitative research, statistically valid sample designs and data collection methods can be used.

As stated above, it is also not unusual to have constraints imposed on the potential concept or solution. A constraint is a boundary condition that is placed on the potential solution which restricts freedom of choice. A constraint must be satisfied by the chosen concept, strategy or solution. The user should be concern with perceived constraints, as they may prevent achievement of the desired outcomes. Constraints that are common to a mission can be included on the screen. They are provided to assist in this process and may be added, modified or removed as appropriate. New constraints may also be added. Constraints are not desirable. However, they are mandatory, as they must be honored, and they restrict freedom of choice. As more constraints are imposed on the solution, the universe of possible solutions contracts. As constraints are removed, the universe of possible solutions expands. When adding a constraint, it may be desirable to also state what condition the strategy or solution must honor.

Examples of self imposed constraints on a product include, but are not limited to, “the product must use the existing mechanical packaging”, “the product must use a battery to obtain its power”, “the product must cost less than $49”, etc. Examples of a third party constraint imposed on a product include, but are not limited to, “the product must meet FDA regulations”, “the product must fit on the shelves of the distributor”, etc.

Predictive metrics can be used as the basis for defining the desired competitive position because they predict the delivery of value and are prioritized based upon the importance and satisfaction values that were chosen or input for each of the desired outcomes and the relationships that exist between the metrics and the desired outcomes. Up to 8000 relationship decisions are often processed, using matrix analysis, to prioritize the metrics in the order that best predicts how to achieve the desired outcomes. This prioritization process is executed automatically by the software, using a Normalized Importance algorithm that is integral to the software. As mentioned previously, the prioritized metrics define the order in which value can be created most efficiently.

As also previously mentioned, the top 30% of the metrics often predict that up to 70% of the desired outcomes will be satisfied to some degree. Discovering this “synergy” enables the user to satisfy more of the important desired outcomes by focusing limited time, money and other resources on the high priority predictive metrics. It is not uncommon to discover that some of the top metrics have never been considered in the past when attempting to establish the desired competitive position. The desired competitive position can be defined before alternative strategies and solutions are created and evaluated. A proposed solution can be eliminated or modified if it does not allow a company to achieve its desired competitive position.

To help ensure that the desired competitive position is achieved, a target value can be inputted for each of the top metrics. To determine the appropriate target value, competitive analysis benchmarking the company's current solutions and the company's competitors' current solutions can be conducted. To help ensure the chosen concept will

be better than a competitive concept along a specific metric, the target values can be set to exceed those that have been achieved by competitive concepts, and create concepts that meet or exceed those target values. The ultimate target value can denote a target value that will deliver tremendous value. This value can be later used to evaluate the potential of different concepts.

In an implementation, the metrics that predict the delivery of value are known and listed in priority order on the screen. Features can be defined for each of the high priority metrics. This increases the probability that a solution created from this combination of features will enable the achievement of the stated mission. Defined Features can, for example, address the metrics that most efficiently predict the satisfaction of all the stated desired outcomes.

This can be is an effective approach to the creation of breakthrough strategies and solutions. The features that are included here can become the initial components that are combined and modified to form the final solution. It may be desirable to provide a description for each feature added.

A Features Database can be created and stored within the software. One or more features can be defined for each of the high priority predictive metrics. A “menu” of features for each metric can be provided by the software. The features can later be combined in various ways to create alternative solutions and ultimately the optimal solution. The features can be mutually exclusive (i.e. only one of the features should be included in a solution, rather than multiple features that are stated for one metric). However, a feature can be created that consists of a combination of other features. Maintaining this exclusivity helps when prioritizing the features in the chosen concept later in the process. When defining features for a selected project, an entire set of features from another project that is based on the same mission as the selected project can be imported.

Basic Functions can be provided by the software, which are functions that the desired solution is expected to perform. The basic functions may be an integral part of the concept and the concept cannot be effective without performing that function (e.g. a stove must cook food and do so without harming the people that are cooking the food or eating it. Any stove is expected to perform these basic functions). As part of the CD-MAP process, the basic functions can be addressed for the product, process or strategy that is being considered. The user can determine if its processes are in control and capable of ensuring the basic functions are performed. The provided basic functions can be edited or deleted and new basic functions can be added.

After several concepts have been evaluated, it may be possible to combine the best features from each of those concepts into a new concept. This new concept may outperform the others. This concept improvement activity can be accomplished by replacing the weak features of one concept with features that are strengths in other concepts. Since the data that are required to complete this analysis may have already been generated, a unique opportunity to quickly improve your concepts can be provided without necessarily thinking of new features. Going through several iterations of this concept improvement technique often produces a breakthrough solution.

After completing the evaluation process there may be several concepts that scored well. One of the concepts, however, may cost less or be easier to implement. From a feasibility perspective the optimal solution may be the concept which delivers the most value for the least cost, risk and effort. It is possible that a concept that received a score of 60 may involve more cost, risk and effort than a concept that received a score of 50. If this is the case, the latter concept may be the optimal solution. Thus, the concepts may be assessed against these or other feasibility factors in order to make this determination. However, these factors may have been considered previously in the process through stated constraints or desired outcomes. The Feasibility Score (FS) can be calculated by dividing the Concept Score (from the “Evaluation Results” screen) by each of the values input for the feasibility factors. The feasibility score can give a good indication of which concept will deliver the most value for the least cost, risk and effort or whatever factors chosen as substitutes.

### XIX. DEFINITIONS

Accelerated Growth—the enhanced, systematic evolution of a specific process, product, service, technology or organization.

Basic Function—a function that customers expect in a product, service, process or strategy because is it the reason that the product, service, process of strategy exists in the first place.

Assigned Values—the numerical values assigned to the weighting of a customer set, that weights the importance of that customer set relative to other customer sets. The assigned values can be based on best practices as determined through project experience.

Baseline Concept—the concept against which all other concepts are compared when conducting concept evaluation and testing.

Benchmark—the process of comparing different products, technologies or organizations against a set of metrics in order to determine the relative competitive position of each. This can be accomplished in this process by determining how well the competing items perform against a set of appropriate predictive metrics.

Breakthrough Solution—a solution or strategy that preferably satisfies over 50% of the customers desired outcomes better than an existing strategy or solution. Breakthrough solutions can often deliver up to 10 times more value than commonly implemented solutions and enable an organization to leapfrog their competition. Breakthrough solutions can also often provide an organization with a unique and valued competitive position. A competitive advantage can often arise as a result of a breakthrough solution.

CD-MAP—the Customer-Driven Mission Achievement Process, or CD-MAP, is a technology that enhances the ability of an individual or organization to formulate strategies, develop plans and make complex decisions. This technology can enable organizations to accelerate the evolution of their products, services, processes and strategies.

CD-MAP Facilitator—an individual trained in the CD-MAP process that works with a team within an organization to ensure the integrity of the process.

CD-MAP Team—a group of individuals within an organization that represent the functions required to execute the resulting strategy or solution. Team member selection can be based on specific criteria and team members are empowered to make decisions and take action.

Cluster—a group of individuals that are statistically similar in terms of which desired outcomes they value most. A cluster can be derived through a computer analysis of the data received from appropriately conducted quantitative research.

Cluster Analysis—a multi-variant, statistical analysis technique that finds groups of customers who value the same desired outcomes. This technique can be used in the CD-MAP process to conduct segmentation analysis using the desired outcomes as the basis for segmentation.

Concept—an idea, strategy or potential solution in its conceptual or theoretical stage.

Concept Evaluation or Testing—a method used to evaluate a concept's potential to deliver value to customers in a specified target segment.

Concept Optimization—a method used to systematically create the solution that will deliver the most value to customers in a specified target segment.

Concept Score—a numerical value that quantifies the percent of desired outcomes that are better satisfied by the concept under evaluation than the concept it is being evaluated against.

Constants—elements of the Universal Strategy Formulation Model that are stable within the time period in which the mission must be achieved. The elements can include customer desired outcomes, constraints and the desired competitive position.

Constraint—a boundary condition placed on the potential solution or strategy, which restricts freedom of choice. Constraints can be typically imposed by an individual, the organization or by a third party.

Customer—an individual or group of individuals involved in, or affected by, the strategy, plan or decision that is being contemplated. As an example, if an organization wants to improve the process of surgery, the customers may include surgeons, support staff, hospital administrators, the manufacturer of the product, and the individuals within the organization that are providing the solution.

Customer Set—all of the customer types that are involved in, or affected by, the decision, plan or strategy that is being contemplated. As an example, an end user, decision maker and distributor are customers that combine to form a customer set.

Customer Weighting—the numerical value assigned to each customer that defines their importance as a customer relative to other customers in the customer set.

Desired Competitive Position—a unique and valued position that an individual or organization desires to achieve relative to its competitors. To achieve the desired competitive position, the chosen solution preferably satisfies the most important desired outcomes better than any solution employed or planned by a competitor. The desired competitive position can be established through target values that are defined for the most important predictive metrics.

Desired Outcome—a desired outcome is a statement, made by an individual involved in, or affected by, a strategy, plan or decision, that describes an important benefit that they would like to receive from the strategy, plan or decision that is being contemplated. Desired outcomes are unique in that they can be free from solutions, specifications and technologies, can be free from vague words such as “easy” or “reliable” and are statements that are valid and stable over time.

Desired Outcome Gathering Session—qualitative research which is conducted with individuals that are involved in diverse aspects of a specific process, product, service or organization. A session can involve approximately participants, though such number is not considered limiting, and a desired outcome gathering expert. The participants can be pre-screened to meet the specified target segment criteria.

Direction of Improvement—the direction in which a predictive metric is to be evolved or improved.

Engine—computer-readable media coupled to a processor. The computer-readable media have data, including executable files, which the processor can use to transform the data and create new data. Where reference in this document is made to software achieving some functionality, it is an engine that achieves the functionality in practice.

Executable Plan of Action—a series of actions carried out by individuals that satisfy a set of desired outcomes or execute a process. In an organization, this type of solution can require interaction between individuals.

External Customer—the individual or group of individuals that will receive value from the evolution of the process or the achievement of desired outcomes.

Feature—the components, or attributes, of a concept that individually deliver unique value. Features can be mutually exclusive components of a concept.

Feasibility Factors—factors that must be considered in order to evaluate the feasibility of a specific concept. Feasibility factors can include cost, risk and effort. Implementation—the execution of a plan or strategy.

Importance—the numerical value that an individual places on a desired outcome that reflects that individuals desire to achieve that outcome.

Importance and Satisfaction Data—quantified importance and satisfaction data that is obtained through statistically valid research. The data can represent the importance and satisfaction that an individual places on a specified set of desired outcomes.

Internal Customer—an individual or organization engaged in the business of evolving a process or enabling the achievement of a set of desired outcomes.

Lateral Thinking—a method of thinking in which an individual searches across multiple disciplines, industries or cultures in an attempt to uncover the optimal solution.

Matrix Analysis—a tool that assists in identifying the relationships that exist between two sets of data. In the CD-MAP process, matrix analysis can be used to identify the relationship between predictive metrics and desired outcomes. It can also be used, in conjunction with the normalized importance software algorithm, to prioritize the predictive metrics based on their predictive value.

Mission—a specific task or project with which an individual or organization is charged. A mission may include improving an individual's ability to conduct the process of surgery, manufacture a product or formulate a strategy. A mission may be large or small in scope. When defining a mission, extending the focus of the mission past the existing boundaries of a stated process will often create new opportunity.

Normalized Importance—an algorithm that prioritizes the predictive metrics in the order of their predictive value. A high priority predictive metric will predict the satisfaction of several important desired outcomes.

Opportunity—desired outcomes that an individual, segment or total population perceive to be very important and unsatisfied.

Optimal Solution—the one solution or strategy that will satisfy the largest number of important desired outcomes given the internal and external constraints imposed on the solution and the competitive position that is desired. The optimal solution can also be the solution which delivers the most value for the least cost, risk and effort. The optimal solution can often be a breakthrough solution.

Outcome-Based Logic—the logic that is used in the CD-MAP process to execute the Universal Strategy Formulation Model. Outcome-Based Logic can be characterized as follows: First, all of the criteria to be used to evaluate any potential solution are defined and prioritized. Second, that criteria is used to drive the actual creation of a variety of potential solutions, and evaluate the potential of each solution. Third, the results of the evaluation are used to assist in improving each solution by replacing its weaknesses with valued attributes from other solutions. After several iterations of improvement, the optimal solution is determined and selected.

Outcome-Based Segmentation—quantitative market research that uses desired outcomes as the basis for segmentation. Cluster analysis can be executed to create the segments. The segments can then be profiled to determine their composition.

Outcome Prioritization Method—the numerical value or calculation that is used to prioritize the desired outcomes. The desired outcomes can often be prioritized by their corresponding importance values, by their corresponding importance and satisfaction values in a calculation that identifies opportunity, or by their corresponding satisfaction values only.

Positioning—the process of comparing different products, technologies or organizations in order to determine the current competitive position of each, and to establish a desired strategic position in the future.

Predictive Logic—predictive logic can be characterized by thinking about what can be done now to ensure, or predict, that a desired outcome will be better satisfied in the future.

Predictive Metric—a parameter that can be measured today to ensure its corresponding desired outcome will be achieved in the future. A predictive metric can be measured and controlled in the design of the solution, and can predict the solution will satisfy one or more desired outcomes. In the CD-MAP process a single, strong predictive metric can be defined for each desired outcome. A predictive metric can also often be referred to as a predictive success factor (“PSF”).

Predictive Value—a numerical value that reflects the degree to which a predictive metric predicts the satisfaction of a specific desired outcome. Predictive values often reflect a non-predictive, weak, moderate or strong predictive relationship with a desired outcome.

Product—a device that is used by an individual or organization to assist in the execution of a process or to achieve a set of desired outcomes. User interaction with the device can be a characteristic of a product.

Process—a series of activities, actions or events that produce a desired result. Examples of processes can include conducting surgery, manufacturing a product, making an acquisition, developing a product and formulating a strategy.

Process Evolution—improving the degree to which the desired outcomes of a process, product, service or organization are satisfied. The evolution can be measured using the target values assigned to the predictive metrics.

Qualitative Research—market research that is conducted in order to obtain desired outcomes on the subject of interest. It is often conducted in the form of a group interview or personal interview. Qualitative research can be conducted as part of the CD-MAP process to uncover desired outcomes.

Quantitative Research—market research that is conducted in order to quantify the importance and perceived satisfaction level of each desired outcome.

Sample—a grid that defines the types of individuals that will be interviewed as part of quantitative market research. The sample can be designed to represent all target segments within the population.

Satisfaction—the numerical value that an individual places on a desired outcome that reflects that individuals perception of how well that desired outcome is currently satisfied.

Scenario—a situation that may currently exist, or potentially exist, that requires consideration.

Screening Criteria—criteria that are used to ensure the customers interviewed for qualitative and quantitative research are representative of the target population.

Segment—a group of individuals that are considered a potential target market. A segment may include an industry, a business size, other convenient statistical classifications or clusters derived through segmentation analysis.

Segmentation—a method of finding individuals in a population that value the same desired outcomes. This can be accomplished using a statistical technique called cluster analysis. In the CD-MAP process, the desired outcomes can be used as the basis for segmentation.

Service—a means by which desired outcomes are satisfied for an individual or organization by a third party. External customer interaction can be common with the service provider as the provider can execute the process of interest for the individual or organization.

Solution—a specific set of features that form the basis of a plan or strategy, and define how the desired outcomes will be achieved. A proposed solution can be referred to as a plan or a strategy. Solutions can be treated as variables in the Universal Strategy Formulation Model.

Solution-Based Logic—the logic pattern that is commonly used to formulate strategies. Solution-Based Logic can be characterized as follows. First, individuals use various methods to think of several different solutions. The methods may include brainstorming, research or other methods. Second, individuals evaluate each of the proposed solutions to determine the best solution. The methods used to accomplish this task may include concept testing, conjoint analysis, quantitative research or other methods. Third, the best solution is selected based on the results of the previous steps.

Stakeholder—an individual or group of individuals that are responsible for the creation of a product service or strategy, or must interact with those involved in a specific process.

Strategy—an executable plan of action that describes how an individual or organization will achieve a stated mission.

Strategy Formulation—the process of creating a strategy.

Synergy Analysis—a method for ensuring that the minimal number of actions will satisfy the maximum number of important customer desired outcomes. This can be accomplished, using matrix analysis, by determining which metrics predict the delivery of a disproportionate share of value. This optimization technique can be used for a variety of purposes in the CD-MAP process.

Target Segment—the individual or group of individuals that the internal customers have chosen to serve.

Target Values—values assigned to predictive metrics to guide the level of satisfaction that must be achieved by any proposed solution. Target values can be set to ensure the final solution will achieve the desired competitive position.

Ultimate Target Value—the target value that will drive a predictive metric to a fully evolved position. As each of the ultimate target values are achieved, the process, product, service or organization will be fully evolved along that stated dimension. When all the ultimate target values are achieved, the process, product, service or organization will be fully evolved.

Universal Strategy Formulation Model (USFM)—describes what individuals and businesses are attempting to do when making complex decisions, defining plans and formulating strategies. The model can be explained as follows: When making a complex decision, defining a plan or formulating a strategy, an individual or organization searches through the universe of possible solutions in an attempt to find the one solution that will satisfy the largest number of important desired outcomes given the internal and external constraints imposed on the solution and the competitive position that is desired. That one solution is the optimal solution.” The USFM can be designed to formulate strategies and plans using a mathematical structure. The model can define desired outcomes, constraints and the desired competitive position as constants in an equation, and the universe of possible solutions as variables. Once the constants are defined, solutions can then be evaluated until the optimal solution is found and the equation is “solved”.

Universe of Possible Solutions—the collection of all solutions that could possibly improve or evolve the process, product, service or organization under consideration when making a complex decision, or creating a plan or strategy there can often exist dozens, or even hundreds, of possible solutions.

User Environments—situations in which individuals desire to execute the process of interest.

Value—the degree to which a solution will satisfy a set of desired outcomes versus the cost of acquiring the solution.

Value Creation—increasing an individuals perceived level of satisfaction on one or more desired outcomes.

Variables—elements of the Universal Strategy Formulation Model that change over time. They can include products, services and the executable plans of action that form the universe of possible solutions. They can change over time as new ideas evolve and new technologies become available. All potential solutions can be treated as variables when executing the USFM.

Weighting—a numerical value that reflects the perceived importance of a specific desired outcome or a customer set.

Weighted Importance—the importance assigned to a desired outcome given its numerical importance rating and the weighting assigned to that particular customer set.

The detailed description discloses examples and techniques, but it will be appreciated by those skilled in the relevant art that modifications, permutations, and equivalents thereof are within the scope of the teachings. It is therefore intended that the following appended claims include all such modifications, permutations, and equivalents. While certain aspects of the invention are presented below in certain claim forms, the applicant contemplates the various aspects of the invention in any number of claim forms. For example, while only one aspect of the invention is recited as a means-plus-function claim under 35 U.S.C sec. 112, sixth paragraph, other aspects may likewise be embodied as a means-plus-function claim, or in other forms, such as being embodied in a computer-readable medium. (Any claims intended to be treated under 35 U.S.C. §112, ¶6 will begin with the words “means for”, but use of the term “for” in any other context is not intended to invoke treatment under 35 U.S.C. §112, 1 ¶6.) Accordingly, the applicant reserves the right to add additional claims after filing the application to pursue such additional claim forms for other aspects of the invention.

What is claimed is:

1. A method comprising:
parameterizing a job to identify steps;
defining a market as a job executor of the job;
deconstructing the job to determine achievable outcomes at each step in the job;
gathering outcome statements associated with the achievable outcomes;
allocating customers into segments in accordance with the outcome statements;
uncovering segments of customers that struggle to achieve desirable outcomes at one or more steps of the job;
revealing an opportunity to help at least one customer achieve desirable outcomes related to the market;
facilitating design of a product that helps the at least one customer achieve desirable outcomes.

2. The method of claim 1, wherein the customers are allocated into segments of customers with different unmet needs, revealing segment of opportunity.

3. A system comprising:
a means for parameterizing a job to identify steps;
a means for defining a market as a job executor of the job;
a means for deconstructing the job to determine achievable outcomes at each step in the job;
a means for gathering outcome statements associated with the achievable outcomes;
a means for allocating customers into segments in accordance with the outcome statements;
a means for uncovering segments of customers that struggle to achieve desirable outcomes at one or more steps of the job;
a means for revealing an opportunity to help at least one customer achieve desirable outcomes related to the market;
a means for facilitating design of a product that helps the at least one customer achieve desirable outcomes.

4. The system of claim 3, wherein the customers are allocated into segments of customers with different unmet needs, revealing segment of opportunity.
